(19) United States
(12) Patent Application Publication
(10) Pub. No.: US 2021/0261865 A1
(43) Pub. Date: Aug. 26, 2021

(54) Additives for liquid-crystal mixtures

(71) Applicant: Merck Patent GmbH, Darmstadt (DE)

(72) Inventors: In-Young CHO, Cheonan-Si, Chungcheongnam-Do (KR); Yong-Jun JI, Gyeonggi-Do (KR); Eun-Kyu LEE, Gyeonggi-Do (KR); Hye-Ryung PARK, Gyeonggi-Do (KR)

(73) Assignee: Merck Patent GmbH, Darmstadt (DE)

(21) Appl. No.: 16/972,036

(22) PCT Filed: Jun. 4, 2019
(86) PCT No.: PCT/EP2019/064414

§ 371 Date: Dec. 4, 2020

(30) Foreign Application Priority Data
Jun. 7, 2018 (EP) 18176471.3

(51) Int. Cl. C09K 19/56; C09K 19/06

(52) U.S. Cl. CPC C09K 19/56; C09K 2019/3004; C09K 19/06

(57) ABSTRACT

The invention relates to liquid-crystal mixtures which comprise polyfluorinated additives, and to liquid-crystal displays based on these mixtures.

The invention relates to liquid-crystal mixtures which comprise polyfluorinated additives, and to liquid-crystal displays based on these mixtures.

Liquid crystals have found a broad range of applications since the first commercially usable liquid-crystalline compounds were found about 40 years ago. Known areas of application today are simple digital displays, displays of portable and desktop computers, navigation systems and not least television sets. For video-capable displays in particular, high demands are made of the response times and contrast of the images.

The spatial arrangement of the molecules in a liquid crystal has the effect that many of its properties are direction-dependent. Of particular importance for use in liquid-crystal displays are the optical, dielectric and elasto-mechanical anisotropies. Depending on whether the molecules are oriented with their longitudinal axes perpendicular or parallel to the two plates of a capacitor, the latter has a different capacitance; in other words, the dielectric constant E of the liquid-crystalline medium has different values for the two orientations. Substances whose dielectric constant is larger when the longitudinal axes of the molecules are oriented perpendicular to the capacitor plates than when they are oriented parallel are referred to as dielectrically positive. In other words, if the dielectric constant ε_{∥} parallel to the longitudinal axes of the molecules is larger than the dielectric constant ε_{⊥} perpendicular to the longitudinal axes of the molecules, the dielectric anisotropy Δε=ε_{∥}−ε_{⊥} is greater than zero. Most liquid crystals used in conventional displays fall into this group.

Both the polarisability of the molecule and the permanent dipole moment play a role for the dielectric anisotropy. On application of a voltage to the display, the longitudinal axis of the molecules orients itself in such a way that the larger of the dielectric constants becomes effective. The strength of the interaction with the electric field depends on the difference between the two constants. In the case of small differences, higher switching voltages are necessary than in the case of large differences. The introduction of suitable polar groups, such as, for example, nitrile groups or fluorine, into the liquid-crystal molecules enables a broad range of working voltages to be achieved.

By means of liquid crystals in which the larger dipole moment is oriented parallel to the longitudinal axis of the molecule, very high-performance displays have already been developed. In most cases here, mixtures of from 5 to 20 components are used in order to achieve a sufficiently broad temperature range of the mesophase and short response times and low threshold voltages. However, difficulties are still caused by the strong viewing-angle dependence in liquid-crystal displays as are used, for example, for laptops. The best imaging quality can be achieved if the surface of the display is perpendicular to the viewing direction of the observer. If the display is tilted relative to the observation direction, the imaging quality deteriorates drastically under certain circumstances. For greater comfort, attempts are being made to maximise the angle through which the display can be tilted from the viewing direction of an observer without significantly reducing the imaging quality. Attempts have recently been made to improve the viewing-angle dependence using liquid-crystalline compounds whose dipole moment perpendicular to the longitudinal axis of the molecule is larger than that parallel to the longitudinal axis of the molecule. The dielectric anisotropy Δε is negative in this case. In the field-free state, these molecules should be oriented with their longitudinal axis perpendicular to the glass surface of the display. Application of an electric field causes them to orient themselves more or less parallel to the glass surfaces. In this way, it has been possible to achieve an improvement in the viewing-angle dependence. Displays of this type are known as VA-TFT (“vertically aligned”) displays or simply VA displays.

Furthermore, so-called PS-VA displays are known, which are based on VA displays. In these a polymerizable component is used in the LC medium for adjustment of a permanent pretilt upon polymerization of the polymerizable constituents. Fast switching combined with high contrast can be achieved by suitable adjusting the size and direction of the pretilt.

For switching individual pixels, the majority of high-resolution displays are addressed by non-linear electronic elements, for example by thin-film transistors (“TFTs”). Such displays are also referred to below as active-matrix displays (TFT displays).

The typical LCD device itself comprises two substrates with electrodes and a layer of the liquid crystal located in the space enclosed by the substrates. The display of an image is achieved by changing the alignment of the liquid crystals with the aid of an electric voltage applied to the electrodes.

An LCD display is typically produced by adhesively bonding a first substrate having a pixel electrode, a thin-film transistor (TFT) and other components to a second substrate which contains a common electrode, using a sealant. The space enclosed by the substrates is conventionally filled with the liquid crystal via a fill opening by means of capillary force or vacuum; the fill opening is subsequently sealed using a sealant.

With the increase in the size of liquid-crystal displays in recent years, the so-called “one drop filling” process (ODF process) has been proposed as a process for the mass production of liquid-crystal displays (see, for example, JPS63-179323 and JPH10-239694) in order to shorten the cycle times during production. This is a process for the production of a liquid-crystal display in which a drop of the liquid crystal is applied to the substrate, which is fitted with electrodes. The second substrate fitted with electrodes and/or colour filters and a sealant round the edges is subsequently mounted in vacuo, and the sealant is cured by UV irradiation and heat treatment.

The filling of active-matrix liquid-crystal devices by the ODF method is currently the preferred method for large-format displays. Suitable metering devices for filling a crystal display by the ODF method are familiar to the person skilled in the art. A prerequisite for the success of the ODF method is that the liquid-crystal medium distributes itself after application to form a uniform film between the substrates. Problems can be caused by an inadequate flow behaviour or occurrence of concentration gradients. On use of conventional liquid-crystal mixtures, a known problem is the occurrence of so-called “ODF mura” or “ODF drop mura”, characterised by, for example, periodic ring-shaped irregularities of the display surface along the droplet boundaries. Due to the different flow conditions during droplet deposition and coalescence of the droplets when the substrates are joined together, the ODF mura occur to different extents, which is essentially evident through uneven distribution of the brightness of the display. In the case of liquid-crystal devices of the VA type, and also of the MVA, PVA and PS-VA types, outlines of the droplets are a typical problem. In addition, brightness differences of this type are fixed in the case of polymer-stabilised displays (for example PSA and PS-VA). Conventional preventative measures, such as a reduction in the polymer concentration, are generally associated with other disadvantages, such as lower stability of the tilt angle, etc. It is therefore desirable to provide liquid-crystal mixtures which achieve good wetting of the substrate (spreading), have good flow properties and substantially avoid the phenomenon of ODF mura.

The effort for the production of a polyimide layer, treatment of the layer and improvement with bumps or polymer layers is relatively great. A simplifying technology which on the one hand reduces production costs and on the other hand helps to optimise the image quality (viewing-angle dependence, contrast, response times) would therefore be desirable.

Recently a modified kind of displays of the VA type was developed, which is free of the conventional polyimide alignment films by using a so-called self-alignment additive for vertical alignment (WO 2012/038026; WO 2013/004372, US 2015/252265, WO 2017/041893). These displays are also addressed as SA-VA displays. The spreading behaviour of mixtures containing such alignment additives for vertical alignment can lead to a non-continuous concentration of the additive. In such event, areas of very low concentration of alignment additive may show incomplete vertical alignment in edge regions of a display cell or in certain parts of the drop area of the ODF process. A solution for more even distribution of the self alignment additive could improve the performance of such SA-VA displays and enable even lower concentrations of the additives.

It is therefore an object of the invention specifically to improve the wetting behaviour, evenly spreading and flow properties of liquid-crystalline media for SA-VA type displays. The electro-optical and chemical properties of the mixtures, which have been optimised in a wide variety of ways, must not be adversely affected in the process. A further object of the present invention is to provide mixtures and a process for the production of such liquid crystal displays in which the above-described phenomenon of ODF mura and incomplete vertical alignment does not occur or only occurs to a tolerable extent.

There is therefore still a great demand for TFT displays having very high specific resistance at the same time as a large working-temperature range, short response times even at low temperatures and low threshold voltage which do not have these disadvantages, or only do so to a reduced extent. Liquid-crystalline mixtures having a reduced tendency towards the formation of ODF mura and incomplete alignment have caught little attention in publications up to date. The specification KR 2011-0068303 proposes a polysiloxane as an additive for reducing drop mura.

An object of the present invention consists in providing a liquid-crystalline medium having improved properties for processing and application providing the additives having advantageous properties for use in liquid-crystalline media.

This is achieved by providing a liquid-crystalline medium comprising a liquid-crystalline component, which is characterised in that it comprises one or more self-alignment additives for vertical alignment and one or more polyfluorinated spreading additives of the following formula I:

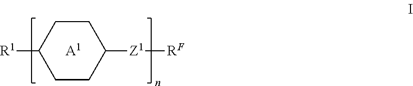

in which
R¹ denotes a straight-chain or branched alkyl group having 1 to 20 C atoms, or H, where, in addition, one or more CH₂ groups in this radical may each be replaced, independently of one another, by —C≡C—, —CH═CH—,

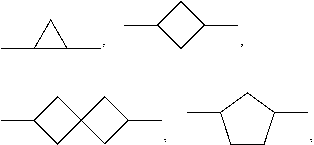

—O—, —S—, —CO—O— or —O—CO— in such a way that O/S atoms are not linked directly to one another,
R^{F} denotes a polyfluorinated alkyl group with 4 to 25 carbon atoms having at least 9 fluorine atoms, preferably a group selected from the formulae
   R²,

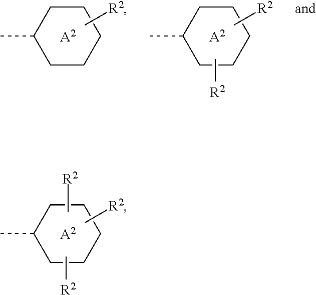

R² in each case independently denotes

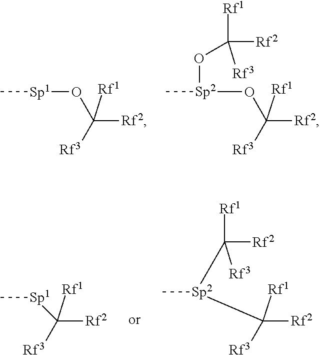

Rf¹, Rf³ independently denote H, F, —CF₃, —CF₂CF₃, —CF₂CF₂CF₃ or CF(CF₃)₂, preferably —CF₃, —CF₂CF₃, —CF₂CF₂CF₃ or CF(CF₃)₂, particularly preferably —CF₃,
Rf² independently denotes an unbranched, branched or cyclic fluoroalkyl group having 3 to 15 fluorine atoms and 1 to 10 C atoms, in which one or more non-adjacent CH₂ groups may be replaced by —O— and/or —S—, in particular —CF₃, —CF₂CF₃, —CF₂CF₂CF₃, —CH₂CF₂CF₂CF₃, —CH₂CF₂CF₃, —CF(CF₃)—O—CF₂CF₂CF₃, —S—CF₂CHF—O—CF₂CF₂CF₃ or CF(CF₃)₂,
preferably —CF₃, —CF₂CF₃, —CF₂CF₂CF₃ or CF(CF₃)₂, particularly preferably —CF₃,
Z¹ in each case independently denotes a single bond, —CH₂CH₂—, —COO—, trans-—CH═CH—, trans-—CF═CF, —CH₂O—, —CF₂O— or —C≡C—, in which asymmetrical bridges may be oriented to both sides, and where two O atoms of adjacent groups are not connected directly,
Sp¹ denotes a single bond or —(CH₂)ₘ—, in which m=1, 2, 3 or 4 and in which one or two CH₂ groups may be replaced by —O— or —S— in such a way that O/S atoms are not linked directly to one another,
Sp² denotes a linear or branched, trivalent spacer, preferably a trivalent alkylene having 1 to 10 C atoms, which is linear or branched, in which one or more non-adjacent CH₂ groups may be replaced by —O—,
particularly preferably one of the moieties

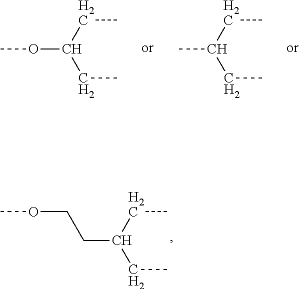

A¹ in each case independently denotes a radical selected from the following groups:
   a) the group consisting of trans-1,4-cyclohexylene and 1,4-cyclohexenylene, in which, in addition, one or more non-adjacent CH₂ groups may be replaced by —O— and/or —S— and in which, in addition, one or more H atoms may be replaced by F or Cl,
   b) 1,4-phenylene, in which, in addition, one or two CH groups may be replaced by N and in which, in addition, one or more H atoms may be replaced by a group L or R², and
   c) the group consisting of 2,6-naphthylene, dibenzofuran-3,7-diyl, dibenzothiophene-3,7-diyl, 9H-fluorene-2,7-diyl, phenanthrene-2,7-diyl, 6H-benzo[c]chromene-3,8-diyl, anthracene-2,6-diyl, tetrahydropyran-2,5-diyl, 1,3-dioxane-2,5-diyl, tetrahydrofuran-2,5-diyl, cyclobutane-1,3-diyl, piperidine-1,4-diyl, thiophene-2,5-diyl and selenophene-2,5-diyl, each of which may also be mono- or polysubstituted by a group L,
A² denotes a 6- or 5-membered saturated, unsaturated or aromatic, carbocyclic or heterocyclic ring system, preferably a cyclohexane ring or a benzene ring, which is in each case optionally additionally substituted by one or two groups L,
L independently denotes F, Cl, —CN, an alkyl group having 1 to 5 C atoms, an alkoxy group having 1-5 C atoms or an alkenyl group having 2 to 5 C atoms,
   and
n denotes 0, 1, 2, 3 or 4, preferably 0, 1, 2 or 3, particularly preferably 1, 2 or 3, very particularly preferably 1 or 2.

The self-alignment additive for vertical alignment is preferably selected of formula

MES-R^{a} II

in which
MES is a calamitic mesogenic group comprising two or more rings, which are connected directly or indirectly to each other or which are condensed to each other, and which mesogenic group is substituted optionally by one or more polymerizable groups, which are connected to MES directly or via a spacer, and
R^{a} is a polar anchor group, residing in a terminal position of the calamitic mesogenic group MES which comprises at least one carbon atom and at least one group selected from —OH, —SH, —COOH, —CHO or primary or secondary amine function, preferably one or two OH groups, and which optionally contains one or two polymerizable groups P.

Preferably the polar anchor group R^{a} is a linear or branched alkyl group with 1 to 12 carbon atoms, wherein any —CH₂— is optionally replaced by —O—, —S—, —CH═CH—, —C≡C—, —NR⁰— or —NH—, and which is substituted with one, two or three polar groups selected from —OH, —SH, —NH₂ or —NR⁰H, wherein R⁰ is alkyl with 1 to 10 carbon atoms. More preferably R² is a group R^{a} as defined below.

More preferably the self-alignment additive for vertical alignment is selected of formula IIa

R¹-[A²-Z²]ₘ-A¹-R^{a} IIa

in which
A¹, A² each, independently of one another, denote an aromatic, heteroaromatic, alicyclic or heterocyclic group, which may also contain fused rings, and which may also be mono- or polysubstituted by a group L or -Sp-P,
L in each case, independently of one another, denotes H, F, Cl, Br, I, —CN, —NO₂, —NCO, —NCS, —OCN, —SCN, —C(═O)N(R⁰)₂, —C(═O)R⁰, optionally substituted silyl, optionally substituted aryl or cycloalkyl having 3 to 20 C atoms, or straight-chain or branched alkyl, alkoxy, alkylcarbonyl, alkoxycarbonyl, alkylcarbonyloxy or alkoxycarbonyloxy having up to 25 C atoms, in which, in addition, one or more H atoms may each be replaced by F or Cl,
P denotes a polymerizable group,
Sp denotes a spacer group or a single bond,
Z² in each case, independently of one another, denotes a single bond, —O—, —S—, —CO—, —CO—O—, —OCO—, —O—CO—O—, —OCH₂—, —CH₂O—, —SCH₂—, —CH₂S—, —CF₂O—, —OCF₂—, —CF₂S—, —SCF₂—, —(CH₂)ₙ₁—, —CF₂CH₂—, —CH₂CF₂—, —(CF₂)ₙ₁—, —CH═CH—, —CF═CF—, —C≡C—, —CH═CH—COO—, —OCO—CH═CH—, —(CR⁰R⁰⁰)ₙ₁—, —CH(-Sp-P)—, —CH₂CH(-Sp-P)—, or —CH(-Sp-P)CH(-Sp-P)—,
n1 denotes 1, 2, 3 or 4,
m denotes 0, 1, 2, 3, 4, 5 or 6,
R⁰ in each case, independently of one another, denotes alkyl having 1 to 12 C atoms,
R⁰⁰ in each case, independently of one another, denotes H or alkyl having 1 to 12 C atoms,
R¹ independently of one another, denotes H, halogen, straight-chain, branched or cyclic alkyl having 1 to 25 C atoms, in which, in addition, one or more non-adjacent CH₂ groups may each be replaced by —O—, —S—, —CO—, —CO—O—, —O—CO—, or —O—CO—O— in such a way that O and/or S atoms are not linked directly to one another and in which, in addition, one or more H atoms may each be replaced by F or Cl, or a group -Sp-P, and
R^{a} is defined as above, preferably denotes a polar anchor group further defined by having at least one group selected from —OH, —NH₂, NHR¹¹, C(O)OH and —CHO, where R¹¹ denotes alkyl having 1 to 12 C atoms.

The anchor group R^{a} of the self-alignment additive is more preferably defined as
R^{a} an anchor group of the formula

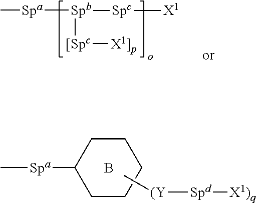

wherein
p denotes 1 or 2,
q denotes 2 or 3,
B denotes a substituted or unsubstituted ring system or condensed ring system, preferably a ring system selected from benzene, pyridine, cyclohexane, dioxane or tetrahydropyran,
Y, independently of one another, denotes —O—, —S—, —C(O)—, —C(O)O—, —OC(O)—, —NR¹¹— or a single bond,
o denotes 0 or 1,
X¹, independently of one another, denotes H, alkyl, fluoroalkyl, OH, NH₂, NHR¹¹, NR¹¹₂, OR¹¹, C(O)OH, or —CHO, where at least one group X¹ denotes a radical selected from —OH, —NH₂, NHR¹¹, C(O)OH and —CHO,
R¹¹ denotes alkyl having 1 to 12 C atoms,
Sp^{a}, Sp^{c}, Sp^{d} each, independently of one another, denote a spacer group or a single bond, and
Sp^{b} denotes a tri- or tetravalent group, preferably CH, N or C.

Formulae II and IIa optionally include polymerizable compounds. Within this disclosure the “medium comprising a compound of formula II/IIa” refers to both, the medium comprising the compound of formula II/IIa and, alternatively, to the medium comprising the compound in its polymerized form.

In the compounds of the formulae IIa, and subformulae thereof, Z¹ and Z² preferably denote a single bond, —C₂H₄—, —CF₂—O or —CH₂—O. In a specifically preferred embodiment Z¹ and Z² each independently denote a single bond.

In the compounds of the formula IIa, the group L, in each case independently, preferably denotes F or alkyl, preferably CH₃, F, C₂H₅ or C₃H₇.

Preferred compounds of the formula II are illustrated by the following sub-formulae II-A to II-D

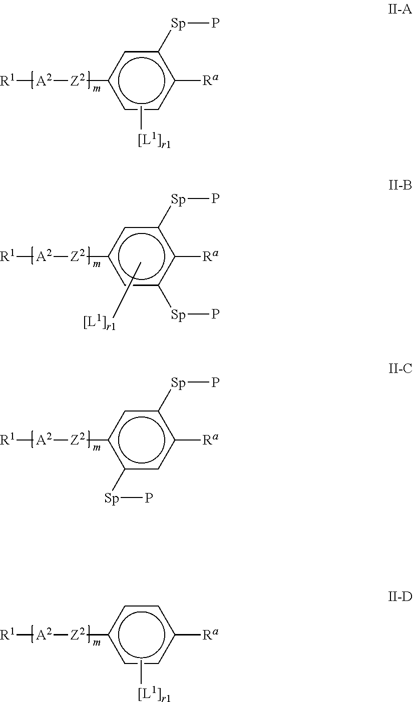

in which R¹, R^{a}, A², Z², Sp, and P have the meanings as defined for formula IIa above,
L¹ is independently defined as L in formula IIa above,
m independently is 1, 2, 3 or 4, and
r1 independently is 0, 1, 2, 3, or 4, preferably 0, 1 or 2.

In the compounds of the formulae II-A to II-D, L¹ preferably denotes F or alkyl, preferably CH₃, F, C₂H₅ or C₃H₇.

In a preferred embodiment, r2 denotes 1 and/or r1 denotes 0.

The polymerizable group P of formulae II, IIa, II-A to II-D preferably is methacrylate, acrylate or another substituted acrylate, most preferably methacrylate.

In the above and below formulae IIa or II-A to II-D and their subformulae Z¹ preferably independently denotes a single bond or —CH₂CH₂—, and very particularly a single bond.

R^{a} denotes preferably

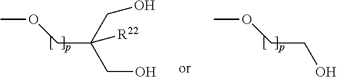

wherein p=1, 2, 3, 4, 5 or 6, and
R²² is H, methyl, ethyl, n-propyl, i-propyl, n-butyl, tert-butyl, n-pentyl, or —CH₂CH₂-tert-butyl
in particular

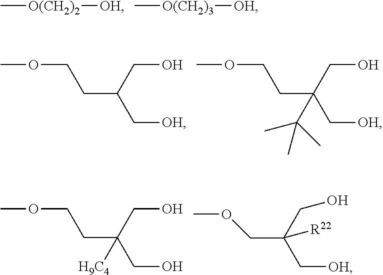

wherein R²² is H, methyl, ethyl, n-propyl, n-butyl or n-pentyl,
or

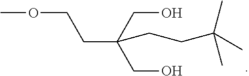

In the formula IIa and in the sub-formulae of the formula IIa R¹ preferably denotes a straight-chain alkyl or branched alkyl radical having 1-8 C atoms, preferably a straight-chain alkyl radical. In the compounds of the formulae IIa or II-A to II-D R¹ more preferably denotes CH₃, C₂H₅, n-C₃H₇, n-C₄H₉, n-C₅H₁₁, n-C₆H₁₃ or CH₂CH(C₂H₅)C₄H₉. R¹ furthermore may denote alkenyloxy, in particular OCH₂CH═CH₂, OCH₂CH═CHCH₃, OCH₂CH═CHC₂H₅, or alkoxy, in particular OC₂H₅, OC₃H₇, OC₄H₉, OC₅H₁₁ and OC₆H₁₃. Particularly preferable R¹ denotes a straight chain alkyl residue, preferably C₅H₁₁.

In the formula IIa and in the sub-formulae of the formula IIa the number m is preferably 1, 2, 3 or 4, more preferably 2, 3 or 4. For m=0 the ring A¹ is preferably a ring element with two or more rings, i.e. a condensed ring system like, for example, 1,1′-biphenyl or dibenzofuran-3,7-diyl.

In particular preferred compounds of the formula IIa are selected from the compounds of the sub-formulae II-1-II-47,

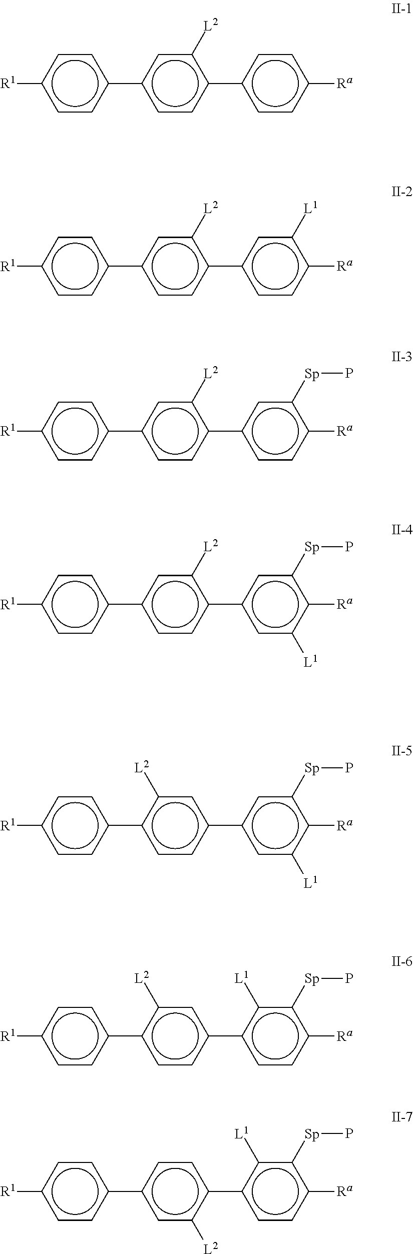

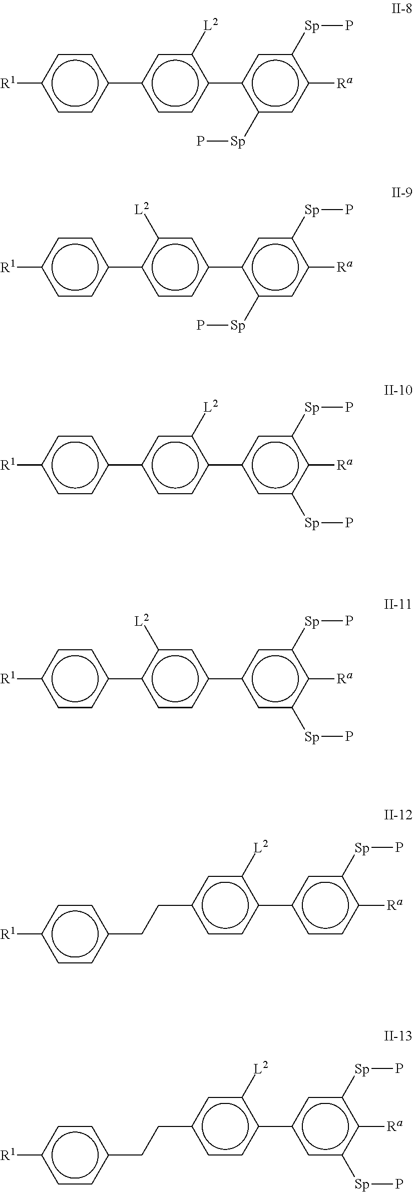

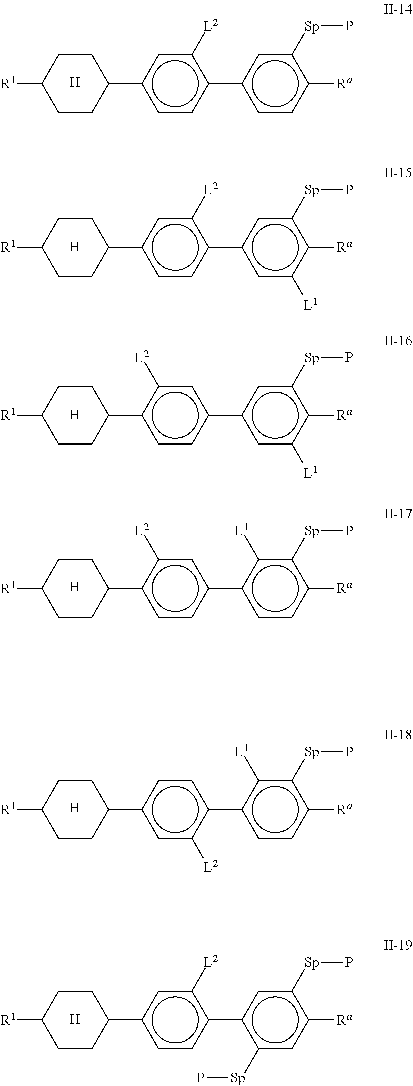

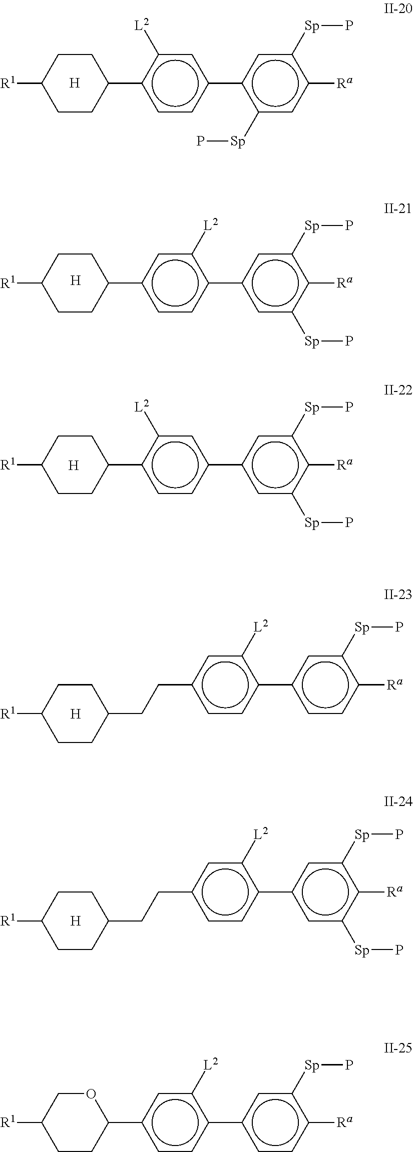

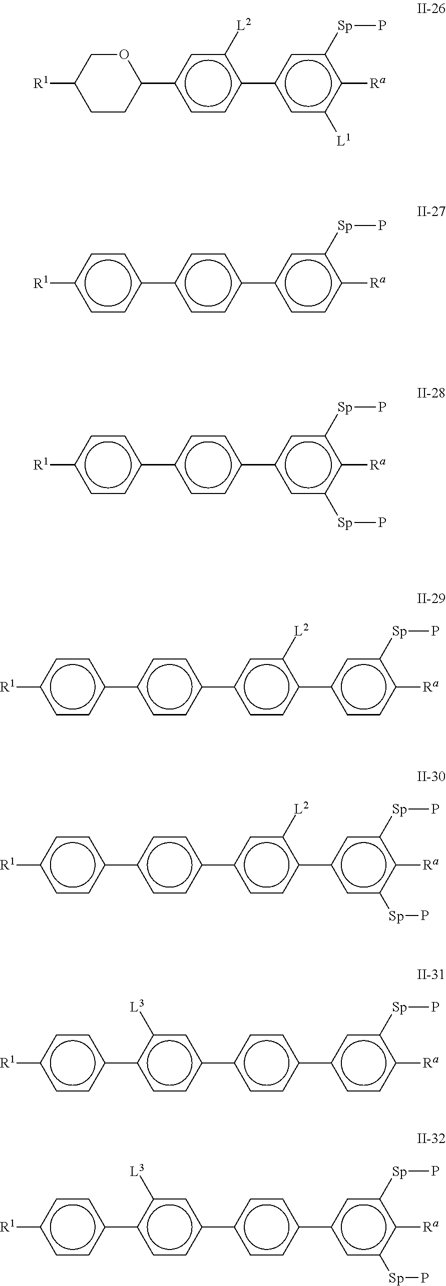

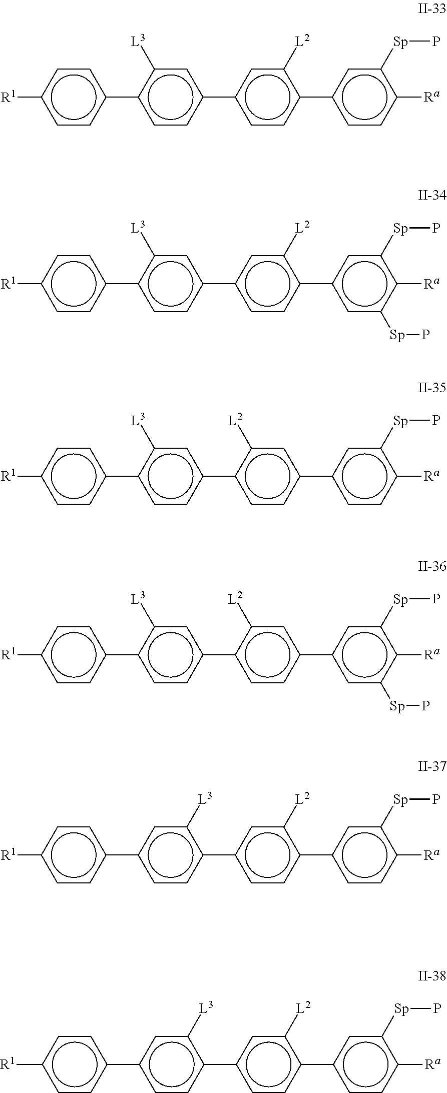

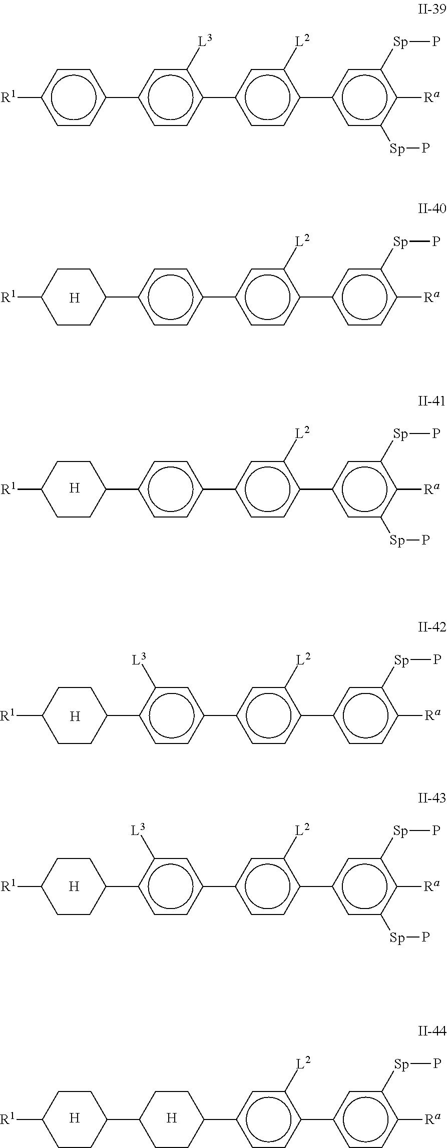

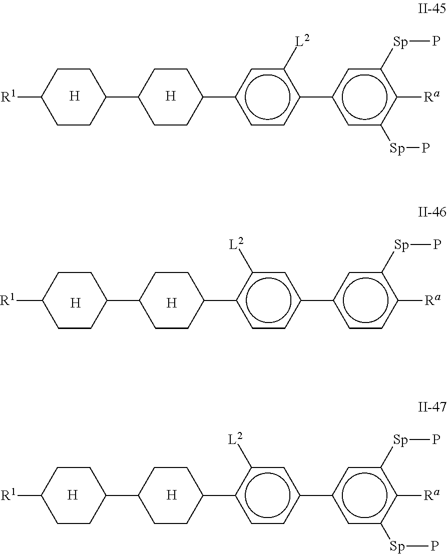

in which R¹, L¹, L², Sp, P and R^{a} have the meanings as given above for formula II or IIa, and L³ is defined as L². R¹ has the meanings given in formula IIa, preferably denotes a straight-chain alkyl radical having 1 to 8 carbon atoms, preferably C₂H₅, n-C₃H₇, n-C₄H₉, n-C₅H₁₁, n-C₆H₁₃ or n-C₇H₁₅, most preferably n-C₅H₁₁.

Preferred LC mixtures according to the present invention contain at least one compound of the formulae II, IIa or their preferred subformulae.

In the following preferred embodiments of the polyfluorinated additive are presented. Preference is given to compounds of the formula I in which R¹ denotes a straight-chain, unbranched alkyl group having 1 to 20 C atoms, where in each case, in addition, one or more CH₂ groups, in each case independently of one another, may be replaced by —CH═CH— or —C≡C—.

The ring A¹ in the formula I preferably denotes, in each case independently, also in the case of multiple occurrence, a group selected from sub-groups a) and b), which, in addition, may be mono- or polysubstituted by a group L. The group A¹ particularly preferably denotes a cyclohexane ring, a cyclohexene ring or a benzene ring, which is optionally additionally substituted by one or two groups L.

The group L preferably independently denotes F, Cl, —CF₃ or an alkyl or alkoxy group having 1, 2 or 3 carbon atoms, particularly preferably F, Cl, methyl or ethyl.

The group Z¹ preferably denotes a single bond.

The compounds of the formula I are preferably selected from the compounds of the formulae

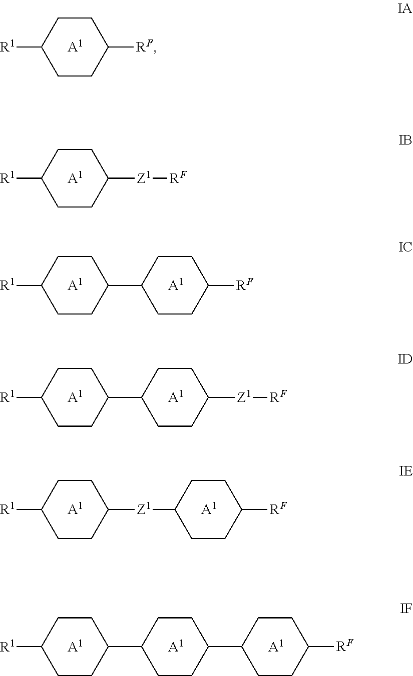

Of these, preference is given to the structures of the formulae IA, IB, IC, ID and IF, particularly of the formulae IA, IC and IF.

The radical R^{F} is preferably an element selected from the formulae

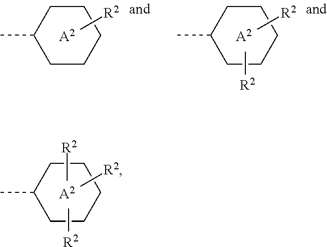

in particular

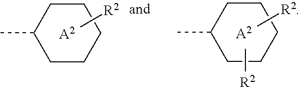

The following part-formulae are particularly preferred for R^{F}:

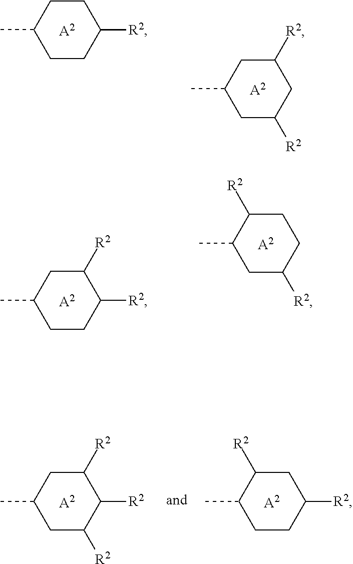

very particularly preferably the formulae:

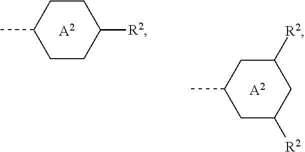

in which the ring A² denotes a six-membered ring, preferably a benzene ring or a cyclohexane ring.

R² is particularly preferably a radical of the formula

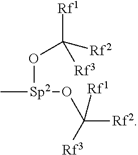

The groups

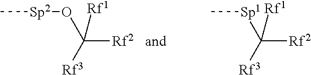

preferably denote the following groups

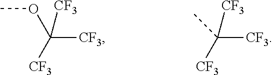

The radical

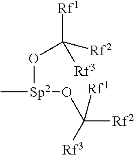

preferably denotes

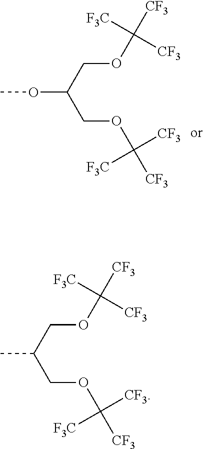

The radical R^{F} contains in total at least 9 fluorine atoms, particularly preferably at least 12 fluorine atoms, furthermore 18 or more, 28 or more and very particularly preferably 36 or more fluorine atoms. The preferred number of fluorine atoms in the groups R² accordingly arises depending on the number of groups R². The total number of fluorine atoms is preferably 60 or less.

Preference is given to compounds of the formula I and liquid-crystalline media comprising an additive of the formula I in which the radicals of the formula I have one of the preferred meanings indicated.

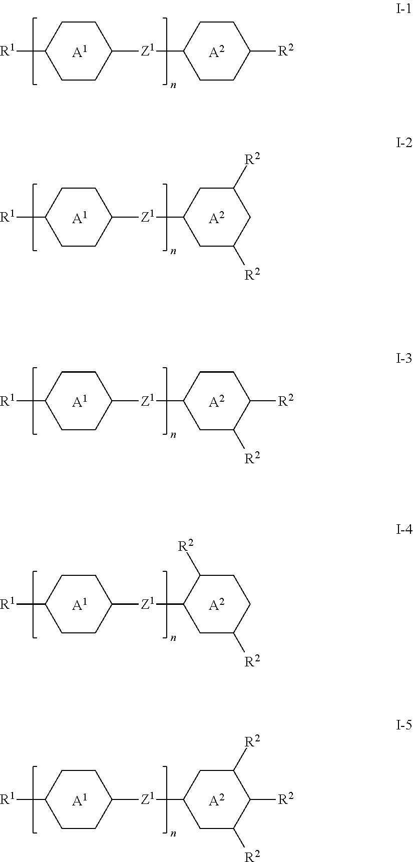

Of these, particular preference is given to the structures of the formulae I-1 and I-2, very particularly of the formula I-2.

In the formulae I and I-1 to I-5, the moiety

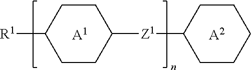

preferably denotes a moiety selected from the following formulae:

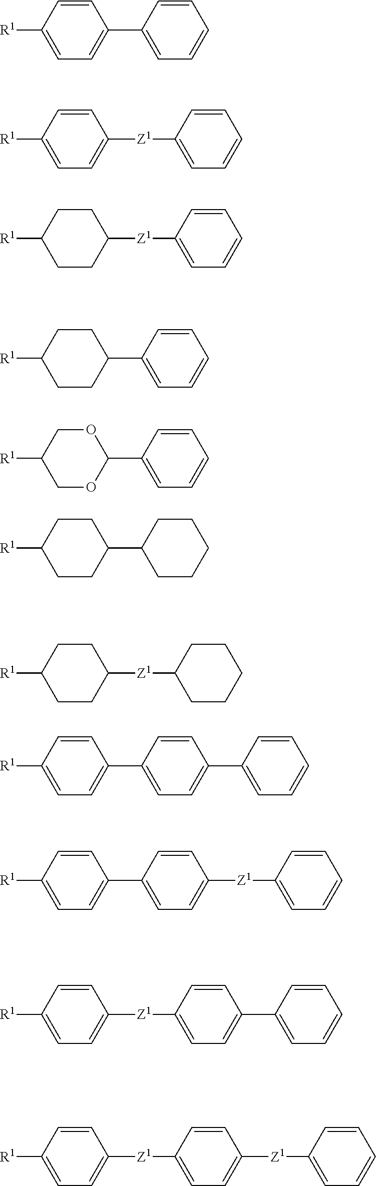

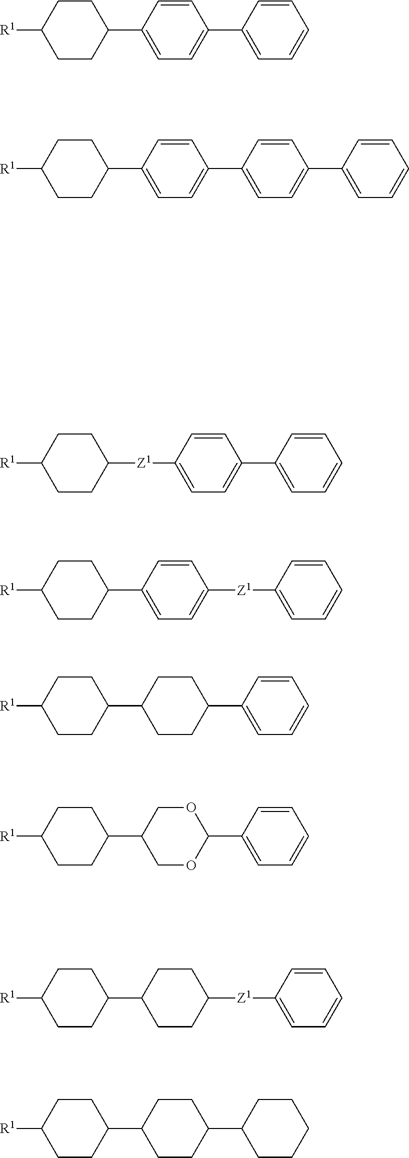

in which the substituents are defined as above and below, the rings are optionally substituted by a group L and the right-hand ring corresponding to the ring A² in the formulae I and I-1 to I-5 is substituted by one or two groups R².

Preference is accordingly given to structures selected from the formulae:

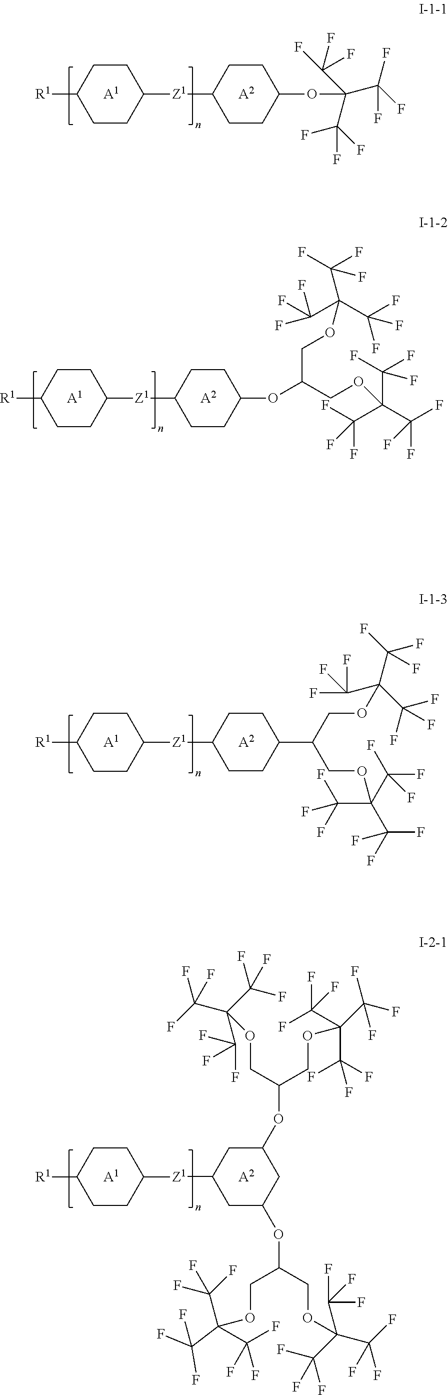

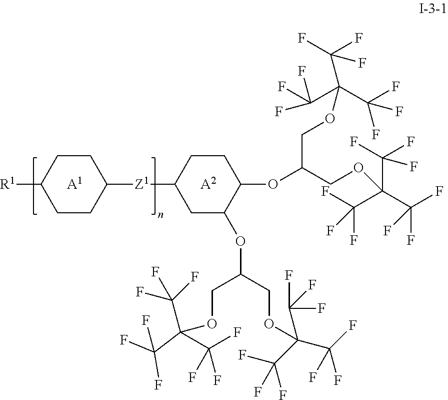

in which the variables are defined as above and below. Most preferably a compound of structure I-2-1 is used as spreading additive.

The group R¹ in formula I and sub-formulae thereof preferably denotes an alkyl radical having 1 to 15 C atoms, in particular an alkyl radical having 2 to 6 C atoms. It is preferably an n-alkyl group.

The compounds according to the invention are very readily soluble in the usual liquid-crystalline media for display devices. The compounds improve the wetting with liquid-crystalline media on substrates and the flow properties on surfaces. They effect, inter alia, a reduced surface tension, a reduced contact angle of a medium with a substrate and excellent spreading of droplets on surfaces. They are therefore good spreading agents or wetting agents, in particular for liquid-crystalline media. Suitable substrates are surfaces of glass, ITO (indium tin oxide), polyimide layers (alignment coatings) or diverse plastics. With the compounds according to the invention as additives, stable nematic phases can readily be produced in a broad temperature range. In effect ODF drop mura and other mura related to spreading are significantly reduced.

Besides the excellent properties as liquid-crystalline component, the compounds according to the invention are distinguished by very little influence on the already optimised physical properties of the medium, such as VHR (‘voltage holding ratio’), long-term stability (reliability), low-temperature stability, response times, etc.

Halogen in connection with the present invention denotes fluorine, chlorine, bromine or iodine, particularly fluorine or chlorine and very particularly fluorine.

Particular preference is given, for example, to the following specific individual compounds:

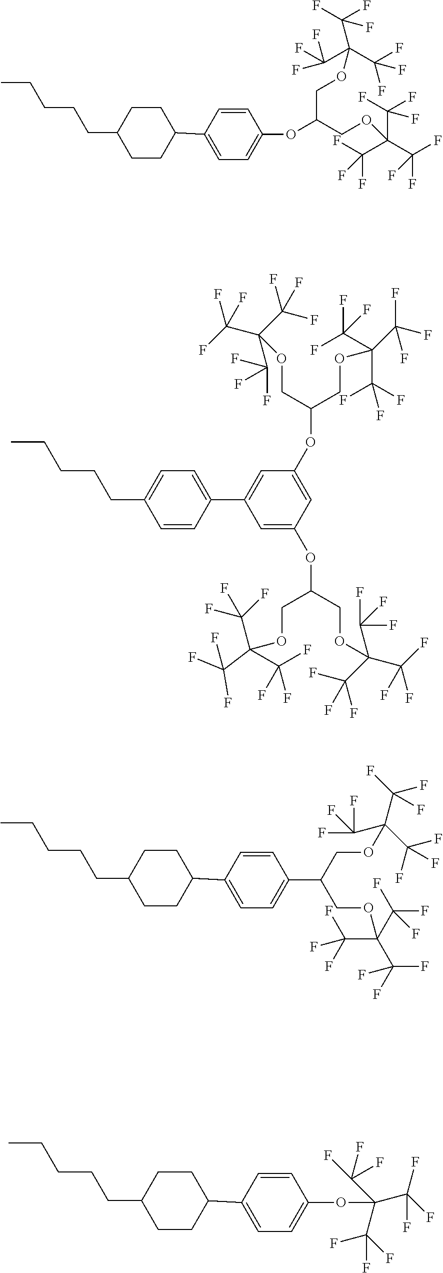 [SMILES: CCCCCC1CCC(c2ccc(OC(COC(C(F)(F)F)(C(F)(F)F)C(F)(F)F)COC(C(F)(F)F)(C(F)(F)F)C(F)(F)F)cc2)CC1 ; CCCCCc1ccc(-c2cc(OC(COC(C(F)(F)F)(C(F)(F)F)C(F)(F)F)COC(C(F)(F)F)(C(F)(F)F)C(F)(F)F)cc(OC(COC(C(F)(F)F)(C(F)(F)F)C(F)(F)F)COC(C(F)(F)F)(C(F)(F)F)C(F)(F)F)c2)cc1 ; CCCCCC1CCC(c2ccc(C(COC(C(F)(F)F)(C(F)(F)F)C(F)(F)F)COC(C(F)(F)F)(C(F)(F)F)C(F)(F)F)cc2)CC1 ; CCCCCC1CCC(c2ccc(OC(C(F)(F)F)(C(F)(F)F)C(F)(F)F)cc2)CC1]

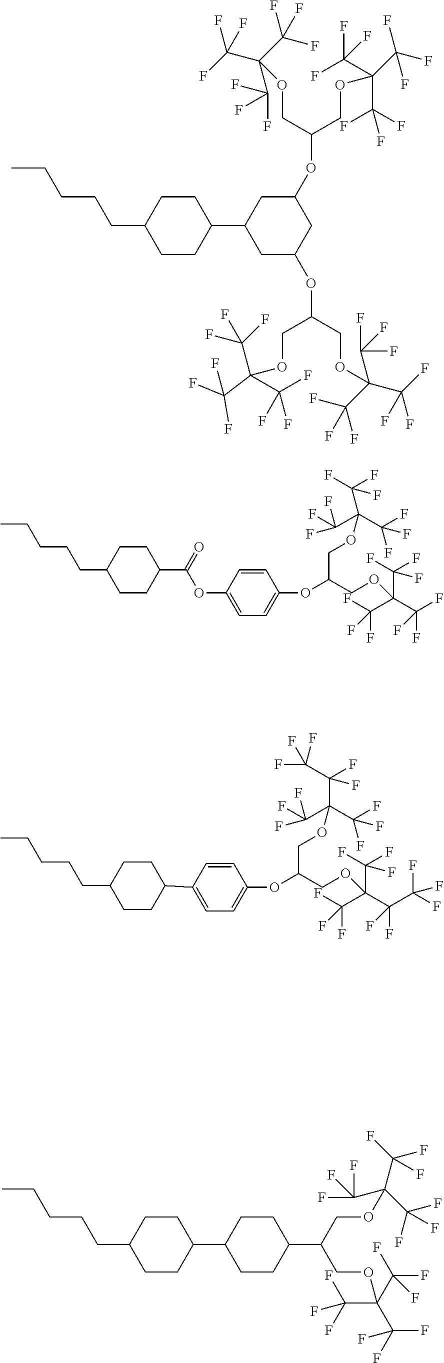

In accordance with the present invention, the compounds of the formula I are used in a total concentration of 0.001% to 2%, more preferably of 0.005% or more to 0.1% or less, particularly preferably of 0.01% or more to 0.05% or less.

The term “aryl” denotes an aromatic carbon group or a group derived therefrom. The term “heteroaryl” denotes “aryl” as defined above, containing one or more heteroatoms, preferably selected from N, O, S, Se, Te, Si and Ge.

Aryl and heteroaryl groups can be monocyclic or polycyclic, i.e. they can contain one ring (such as, for example, phenyl) or two or more rings, which are fused (such as, for example, naphthyl).

Particular preference is given to mono-, bi- or tricyclic aryl groups having 6 to 25 C atoms and mono-, bi- or tricyclic heteroaryl groups having 5 to 25 ring atoms, which optionally contain fused rings and are optionally substituted. Preference is furthermore given to 5-, 6- or 7-membered aryl and heteroaryl groups, in which, in addition, one or more CH groups may be replaced by N, S or O in such a way that O atoms and/or S atoms are not linked directly to one another.

Preferred aromatic ring systems (aryl groups) are, for example, phenyl, naphthyl, anthracene, binaphthyl, phenanthrene, 9,10-dihydrophenanthrene, pyrene, dihydropyrene, chrysene, perylene, tetracene, pentacene, benzopyrene, fluorene, indene, indenofluorene, spirobifluorene, etc.

Preferred unsaturated ring systems are cyclohexen-1,4-diyl rings.

Preferred heterocyclic ring systems are dioxan-2,5-diyl, tetrahydropyran-2,5-diyl, dibenzofuran-3,7-diyl, thiophene-2,5-diyl or selenophene-2,5-diyl. Heteroaryl groups include preferably, but are not limited to thiophene-2,5-diyl, dibenzofuran-3,7-diyl, dibenzothiophen-3,7-diyl or selenophene-2,5-diyl.

The liquid-crystalline medium according to the invention is preferably polar, i.e. it has positive or negative dielectric anisotropy. The medium is preferably nematic. More preferably it has a dielectric negative anisotropy. In this case it advantageously fits to the nematic displays of the VA or ECB type.

The liquid-crystalline medium preferably additionally comprises a proportion of polymerizable compounds, preferably selected from the compounds in Table G and compounds of formula II fitted with a polymerizable group P. The invention is especially advantageous for polymer stabilized media and display systems, because imperfect alignment and other defects are reduced, while otherwise such defects are made more or less permanent at the polymerization step. The LC media according to the invention preferably comprise one or more compounds comprising a methacrylate, acrylate or other kind of acrylate derivate group, most preferably a methacrylate group.

As a preferred embodiment, a medium having negative dielectric anisotropy is used and described below, which comprises
a) one or more compounds of the formula III

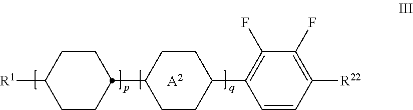

in which
R²¹ denotes an unsubstituted alkyl radical having 1 to 7 C atoms, an unsubstituted alkoxy radical having 1 to 6 C atoms or an unsubstituted alkenyl radical having 2 to 7 C atoms,
R²² denotes an unsubstituted alkyl radical having 1 to 7 C atoms or an unsubstituted alkoxy radical having 1 to 6 C atoms,

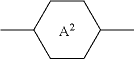

denotes

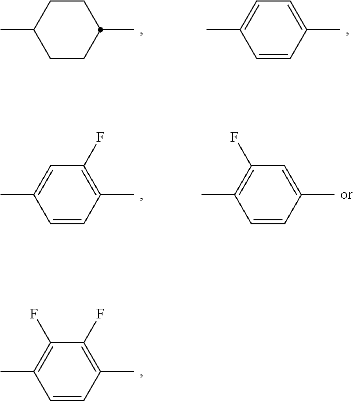

p and q each, independently of one another, denote 0, 1 or 2 and
(p+q) denotes 1, 2 or 3,
b) optionally one or more compounds of the formula IV

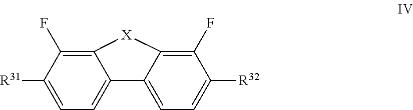

in which
X denotes O or S, preferably O, and
R³¹, R³², independently of one another, denote an unsubstituted alkyl radical having 1 to 7 C atoms, preferably an n-alkyl radical, particularly preferably having 2 to 5 C atoms, or an unsubstituted alkoxy radical having 2 to 7 C atoms, particularly preferably having 2 to 5 C atoms,
where preferably at least one of the radicals R³¹ and R³² denotes alkoxy,
   and
c) optionally, preferably obligatorily, one or more compounds selected from the group of the compounds of the formulae V and VI, more preferably of the formula V,

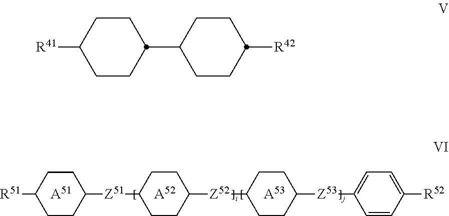

in which
R⁴¹ denotes an unsubstituted alkyl radical having 1 to 7 C atoms or an unsubstituted alkenyl radical having 2 to 7 C atoms, preferably an n-alkyl radical, particularly preferably having 2, 3, 4 or 5 C atoms, and
R⁴² denotes an unsubstituted alkyl radical having 1 to 7 C atoms or an unsubstituted alkoxy radical having 1 to 6 C atoms, both preferably having 2 to 5 C atoms, an unsubstituted alkenyl radical having 2 to 7 C atoms, preferably having 2, 3 or 4 C atoms, more preferably a vinyl radical or a 1-propenyl radical and in particular a vinyl radical,
R⁵¹ and R⁵², independently of one another, have one of the meanings given for R²¹ and R²² and preferably denote alkyl having 1 to 7 C atoms, preferably n-alkyl, particularly preferably n-alkyl having 1 to 5 C atoms, alkoxy having 1 to 7 C atoms, preferably n-alkoxy, particularly preferably n-alkoxy having 2 to 5 C atoms, alkoxyalkyl, alkenyl or alkenyloxy having 2 to 7 C atoms, preferably having 2 to 4 C atoms, preferably alkenyloxy,

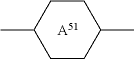

to

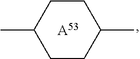

if present, in each case independently of one another, denote

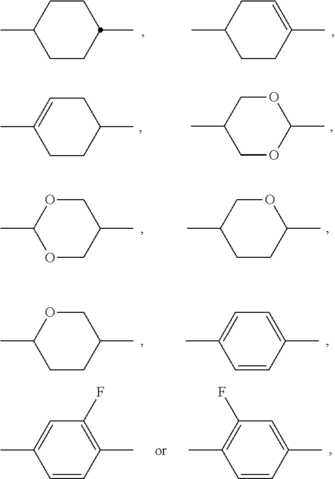

preferably

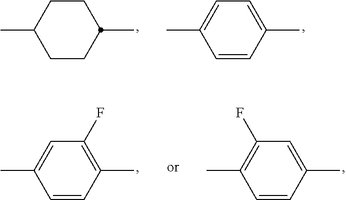

preferably

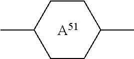

denotes

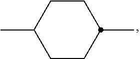

and, if present,

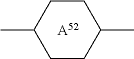

preferably denotes

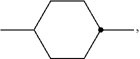

Z⁵¹ to Z⁵³ each, independently of one another, denote —CH₂—CH₂—, —CH₂—O—, —CH═CH—, —C≡C—, —COO— or a single bond, preferably —CH₂—CH₂—, —CH₂—O— or a single bond and particularly preferably a single bond,
i and j each, independently of one another, denote 0 or 1,
(i+j) preferably denotes 0 or 1.

The liquid-crystalline media according to the invention preferably comprise one or more compounds of the formula III selected from the group of the formulae III-1 to III-3, preferably of the formula III-1 and III-3,

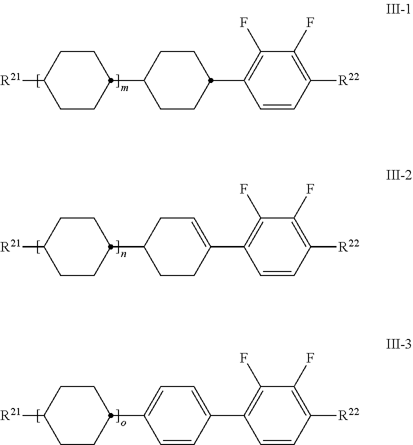

in which
R²¹ denotes an unsubstituted alkyl radical having 1 to 7 C atoms, preferably an n-alkyl radical, particularly preferably having 2 to 5 C atoms, or
an unsubstituted alkenyl radical having 2 to 7 C atoms, preferably a straight-chain alkenyl radical, particularly preferably having 2 to 5 C atoms,
R²² denotes an unsubstituted alkyl radical having 1 to 7 C atoms, preferably having 2 to 5 C atoms, or an unsubstituted alkoxy radical having 1 to 6 C atoms, preferably having 2, 3 or 4 C atoms, and
m, n and o each, independently of one another, denote 0 or 1.

The medium according to the invention preferably comprises one or more compounds selected from the group of the formulae III-1 to III-3 in a total concentration in the range from 10% or more to 80% or less, preferably from 15% or more to 70% or less, particularly preferably from 20% or more to 60% or less.

In a further preferred embodiment, the medium according to the invention, in addition to the compounds selected from the group of the formulae III-1 to III-3, comprises one or more compounds of the formula IV-1 in a total concentration in the range from 1% or more to 20% or less, preferably from 2% or more to 15% or less, particularly preferably from 3% or more to 10% or less.

The media in accordance with the present invention, in addition to the compounds of the formula III, or preferred sub-formulae thereof, preferably comprise one or more dielectrically neutral compounds of the formula V in a total concentration in the range from 5% or more to 90% or less, preferably from 10% or more to 80% or less, particularly preferably from 20% or more to 70% or less.

In a preferred embodiment of the present invention, the media according to the invention comprise one or more compounds of the formula III-1, preferably one or more compounds selected from the group of the compounds of the formulae III-1-1 and III-1-2

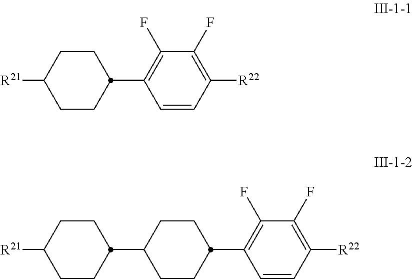

in which the parameters have the meaning given above in the case of formula III-1 and preferably
R²¹ denotes an alkyl radical having 2 to 5 C atoms, preferably having 3 to 5 C atoms, and
R²² denotes an alkyl or alkoxy radical having 2 to 5 C atoms, preferably an alkoxy radical having 2 to 4 C atoms, or an alkenyloxy radical having 2 to 4 C atoms.

In a preferred embodiment of the present invention, the media according to the invention comprise one or more compounds of the formula III-2, preferably one or more compounds selected from the group of the compounds of the formulae III-2-1 and III-2-2

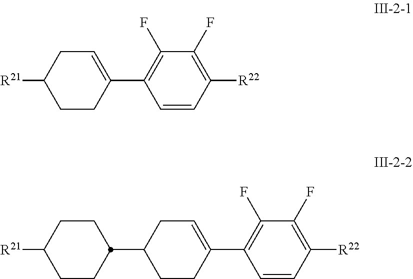

in which the parameters have the meaning given above in the case of formula III-2 and preferably
R²¹ denotes an alkyl radical having 2 to 5 C atoms, preferably having 3 to 5 C atoms, and
R²² denotes an alkyl or alkoxy radical having 2 to 5 C atoms, preferably an alkoxy radical having 2 to 4 C atoms or an alkenyloxy radical having 2 to 4 C atoms.

In a particularly preferred embodiment of the present invention, the media according to the invention comprise one or more compounds of the formula III-3, preferably one or more compounds selected from the group of the compounds of the formulae III-3-1 and III-3-2, very particularly preferably of the formula III-3-2,

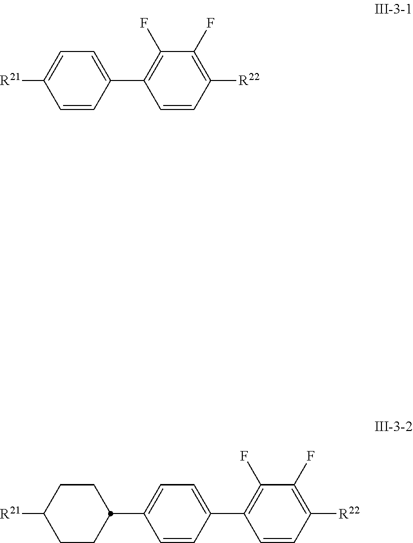

in which the parameters have the meaning given above in the case of formula III-3 and preferably
R²¹ denotes an alkyl radical having 2 to 5 C atoms, preferably having 3 to 5 C atoms, and
R²² denotes an alkyl or alkoxy radical having 2 to 5 C atoms, preferably an alkoxy radical having 2 to 4 C atoms or an alkenyloxy radical having 2 to 4 C atoms.

In a further preferred embodiment, the medium comprises one or more compounds of the formulae IV-1 bis IV-3

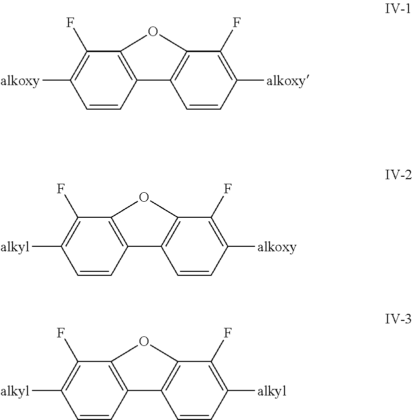

in which alkyl, alkyl′ denote alkyl having 1 to 7 C atoms, preferably having 2-5 C atoms,
alkoxy, alkoxy′ denote alkoxy having 1 to 7 C atoms, preferably having 2 to 5 C atoms.

The medium particularly preferably comprises one or more compounds of the formula IV-1.

In a further preferred embodiment, the medium comprises one or more compounds of the formula V

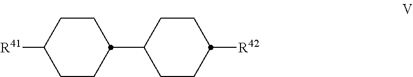

in which
R⁴¹ denotes an unsubstituted alkyl radical having 1 to 7 C atoms or an unsubstituted alkenyl radical having 2 to 7 C atoms, preferably an n-alkyl radical, particularly preferably having 2, 3, 4 or 5 C atoms, and
R⁴² denotes an unsubstituted alkyl radical having 1 to 7 C atoms or an unsubstituted alkoxy radical having 1 to 6 C atoms, both preferably having 2 to 5 C atoms, an unsubstituted alkenyl radical having 2 to 7 C atoms, preferably having 2, 3 or 4 C atoms, more preferably a vinyl radical or a 1-propenyl radical and in particular a vinyl radical.

In a particularly preferred embodiment, the medium comprises one or more compounds of the formula V, selected from the group of the compounds of the formulae V-1 to V-4, preferably selected from the group of the compounds of the formulae V-1 and V-2,

alkyl

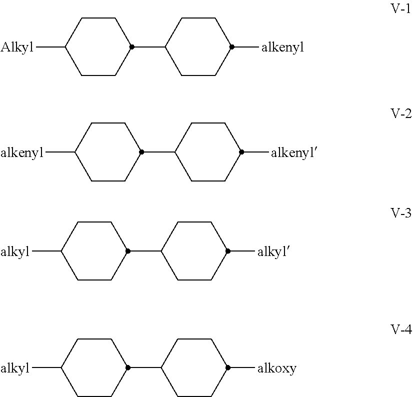

in which
alkyl and alkyl′, independently of one another, denote alkyl having 1 to 7 C atoms, preferably having 2 to 5 C atoms,
alkenyl denotes an alkenyl radical having 2 to 5 C atoms, preferably having 2 to 4 C atoms, particularly preferably 2 C atoms,
alkenyl′ denotes an alkenyl radical having 2 to 5 C atoms, preferably having 2 to 4 C atoms, particularly preferably having 2 to 3 C atoms, and
alkoxy denotes alkoxy having 1 to 5 C atoms, preferably having 2 to 4 C atoms.

In a particularly preferred embodiment, the media according to the invention comprise one or more compounds of the formula V-1 and/or one or more compounds of the formula V-2.

In a further preferred embodiment, the medium comprises one or more compounds of the formula VI

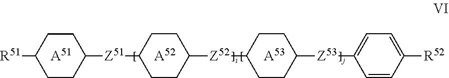

in which
R⁵¹ and R⁵², independently of one another, have one of the meanings given for R²¹ and R²² and preferably denotes alkyl having 1 to 7 C atoms, preferably n-alkyl, particularly preferably n-alkyl having 1 to 5 C atoms, alkoxy having 1 to 7 C atoms, preferably n-alkoxy, particularly preferably n-alkoxy having 2 to 5 C atoms, alkoxyalkyl, alkenyl or alkenyloxy having 2 to 7 C atoms, preferably having 2 to 4 C atoms, preferably alkenyloxy,

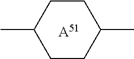

to

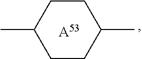

if present, in each case independently of one another, denote

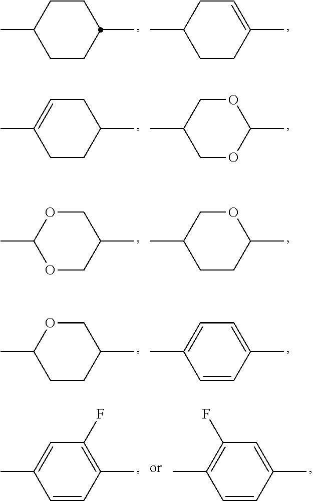

preferably

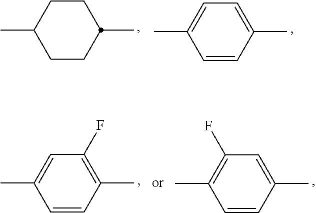

preferably

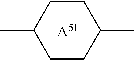

denotes

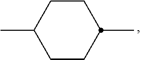

and, if present,

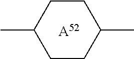

preferably denotes

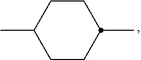

Z⁵¹ to Z⁵³ each, independently of one another, denote —CH₂—CH₂—, —CH₂—O—, —CH═CH—, —C≡C—, —COO— or a single bond, preferably —CH₂—CH₂—, —CH₂—O— or a single bond and particularly preferably a single bond,
i and j each, independently of one another, denote 0 or 1,
(i+j) preferably denotes 0 or 1.

The media according to the invention preferably comprise the following compounds in the total concentrations indicated:

5-60% by weight of one or more compounds selected from the group of the compounds of the formula III and/or
5-60% by weight of one or more compounds selected from the group of the compounds of the formula III and IV and/or
10-60% by weight of one or more compounds selected from the group of the compounds of the formulae III-1 to III-3 and/or
10-60% by weight of one or more compounds of the formulae V and/or VI,
where the total content of all compounds in the medium is 100%.

As a preferred embodiment, a medium having positive dielectric anisotropy is described below which comprises

one or more compounds of the formulae VII and VIII:

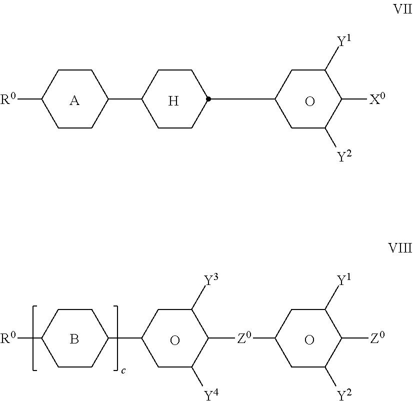

in which
R⁰ denotes an alkyl or alkoxy radical having 1 to 15 C atoms, in which optionally, in addition, one or more CH₂ groups in these radicals are substituted, independently of one another, by —C≡C—, —CF₂—O—, —CH═CH—,

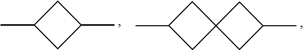

—O—, —(CO)O— or —O(CO)— in such a way that O atoms are not linked directly to one another, and in which, in addition, one or more H atoms may optionally be replaced by halogen,
ring A denotes

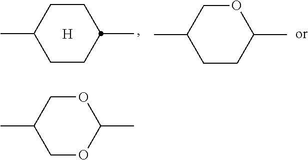

ring B, independently of one another, denotes 1,4-phenylene, optionally substituted by one or two F or Cl,

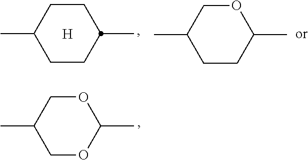

X⁰ denotes F, Cl, CN, SF₅, SCN, NCS, a halogenated alkyl group, a halogenated alkenyl group, a halogenated alkoxy group or a halogenated alkenyloxy group, in each case having up to 6 C atoms,
Y¹⁻⁴ each, independently of one another, denote H or F,
Z⁰ denotes —CF₂O—, —(CO)O— or a single bond, and
c denotes 0, 1 or 2, preferably 1 or 2,
   and
c) optionally, preferably obligatorily, one or more compounds selected from the group of the compounds of the formulae V and VI as provided above, preferably of the formula V.

The partial group

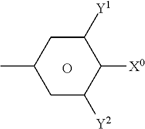

preferably denotes

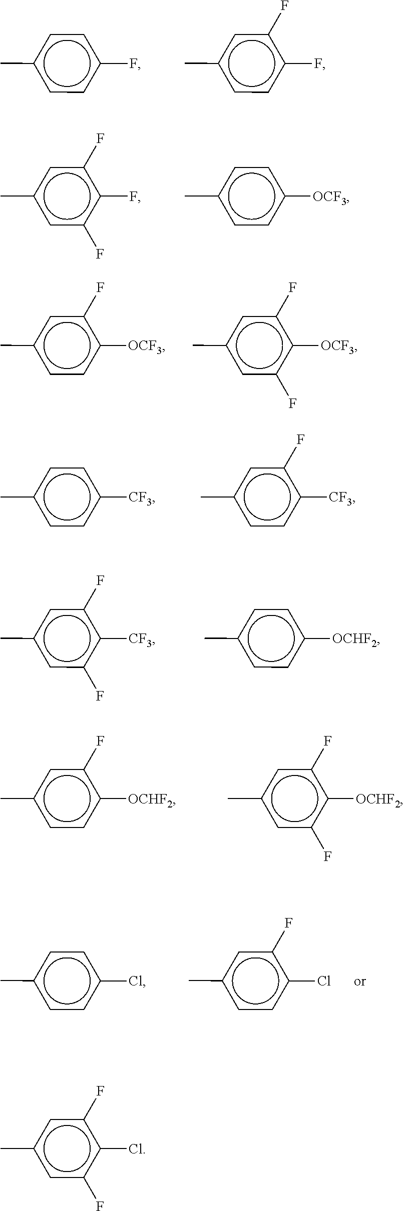

R⁰ preferably denotes straight-chain alkyl or alkenyl having 2 to 7 C atoms;
X⁰ preferably denotes F, OCF₃, Cl or CF₃, in particular F.

In a further embodiment, preference is given to media having positive or negative dielectric anisotropy which comprise both dielectrically negative compounds selected from the formulae III and IV and additionally dielectrically positive compounds selected from the formulae VII and VIII. Dielectrically neutral compounds are likewise optionally present therein.

Very generally, combinations of the preferred embodiments of the invention indicated above and below and the examples are also to be regarded as particularly preferred, so long as they can formally be combined with one another. Further embodiments are revealed by the claims and combinations thereof.

The compounds of the formulae I to VIII are prepared by methods known per se, as described in the literature (for example in the standard works, such as Houben-Weyl, Methoden der organischen Chemie [Methods of Organic Chemistry], Georg-Thieme-Verlag, Stuttgart), to be precise under reaction conditions which are known and suitable for the said reactions. Use can also be made here of variants known per se which are not mentioned here in greater detail. The compounds of the formula I can advantageously be prepared as can be seen from the following illustrative syntheses (Scheme 1).

A typical preparation process for a series of the compounds according to the invention includes a process step in which a polyfluorinated alcohol (for example C(CF₃)₃OH) is etherified using a further OH-functionalised compound having one or more ring systems (Scheme 1). The condensation is preferably carried out under Mitsunobu conditions. It is therefore preferably carried out in the presence of triphenylphosphine and an azodicarboxylate (for example DIAD, DEAD), preferably with diisopropyl azodicarboxylate. The reaction is typically carried out in THF at 20-50° C.

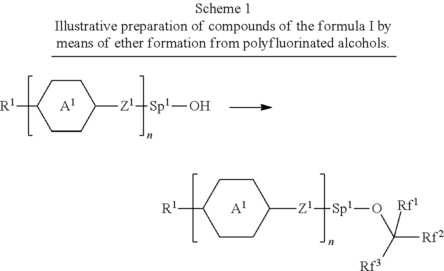

A typical preparation process for another series of the compounds according to invention includes a process step in which a polyfluorinated alkene (for example F₂C═C(CF₃)₂) is linked to a halogenated (electrophilic) compound by means of a C—C bond (Scheme 2).

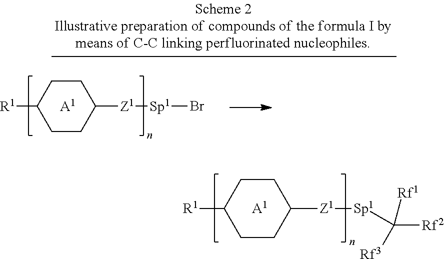

As illustrative reaction, a reaction in accordance with Scheme 3 is shown in which a perfluoroalkene is activated by means of caesium fluoride to give a carbanion and linked to a benzoyl bromide (cf., for example, K. N. Makarov et al. Journal of Fluorine Chemistry, 10 (1977) 157-158).

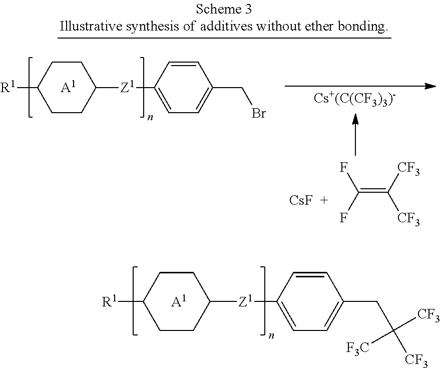

Suitable polyfluorinated starting materials (alcohols, alkenes) are commercially available. Alcohols of the structure R¹-[A¹-Z¹]ₙ-Sp¹-OH or R¹-[A¹-Z¹]ₙ-Sp¹-(OH)₂ shown in Scheme 1 as starting material are known from the literature or can be obtained analogously thereto, as can the analogous halide compounds in accordance with Scheme 2.

The substituents of the compounds in Scheme 1 can be varied analogously to the general formula I by varying the building blocks employed. In this way, very different compounds according to invention are obtained.

The compounds of the formula I are suitable for use in VA-TFT display systems of the SA-VA type and other self-aligned vertical alignment display systems. The person skilled in the art is familiar with further vertically aligned display types in which a combination of additives of formula I and II according to the invention can be employed in liquid-crystal media advantageously.

The present invention also relates to electro-optical displays or electro-optical components which contain liquid-crystalline media according to the invention. Preference is given to electro-optical displays which are based on the VA or ECB effect and in particular those which are addressed by means of an active-matrix addressing device.

Accordingly, the present invention likewise relates to the use of a liquid-crystalline medium according to the invention in an electro-optical display or in an electro-optical component.

The invention likewise relates to a process for the preparation of a liquid-crystalline medium as described above and below, which is characterised in that one or more compounds of the formula I and of formula II are mixed with one or more liquid-crystalline compounds, and further compounds and additives are optionally added. Preference is given to a process for the preparation of the liquid-crystalline media according to the invention, characterised in that one or more compounds of the formula I and of formula II are mixed with one or more compounds of the formula III, and with one or more further liquid-crystalline compounds and/or additives.

In the present application, the term “compounds”, also written as “compound(s)”, denotes one or more compounds, unless explicitly indicated otherwise.

In the present application:
alkyl particularly preferably denotes straight-chain alkyl, in particular CH₃—, C₂H₅—, n-C₃H₇, n-C₄H₉— or n-C₅H₁₁—,
alkenyl particularly preferably denotes CH₂═CH—, E-CH₃—CH═CH—, CH₂═CH—CH₂—CH₂—, E-CH₃—CH═CH—CH₂—CH₂— or E-(n-C₃H₇)—CH═CH—,
alkoxy particularly preferably denotes straight-chain alkoxy, in particular CH₃O—, C₂H₅O—, n-C₃H₇O—, n-C₄H₉O— or n-C₅H₁₁O—.

For the present invention, the sub-formulae

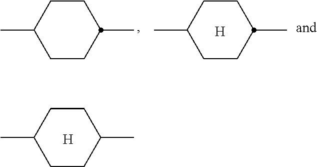

denote trans-1,4-cyclohexylene and the sub-formulae

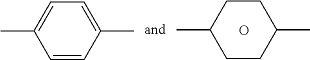

denote 1,4-phenylene.

In the present application, the expression dielectrically positive describes compounds or components where Δε>3.0, dielectrically neutral describes compounds or components where −1.5≤Δε≤3.0 and dielectrically negative describes compounds or components where Δε<−1.5. Δε is determined at a frequency of 1 kHz and 20° C. The dielectric anisotropy of the respective compound is determined from the results of a solution of 10% of the respective individual compound in a nematic host mixture. If the solubility of the respective compound in the host mixture is less than 10%, the concentration is reduced to 5%. The capacitances of the test mixtures are determined both in a cell having homeotropic alignment and also in a cell having homogeneous alignment. The cell thickness in both cell types is about 20 μm. The applied voltage is a rectangular wave having a frequency of 1 kHz and an effective value of typically 0.5 V to 1.0 V, but is always selected so that it is below the capacitive threshold for the respective test mixture.

Δε is defined as (ε∥−ε⊥), while εₐᵥₑ is (ε∥+2ε⊥)/3.

The host mixture used for dielectrically positive compounds is mixture ZLI-4792 and the host mixture used for dielectrically neutral and dielectrically negative compounds is mixture ZLI-3086, both from Merck KGaA, Germany. The absolute values of the dielectric constants of the compounds are determined from the change in the respective values of the host mixture on addition of the compounds of interest. The values are extrapolated to a concentration of the compounds of interest of 100%.

Components which have a nematic phase at the measurement temperature of 20° C. are measured as such, all others are treated like compounds.

The expression threshold voltage in the present application denotes the optical threshold and is indicated for 10% relative contrast (V₁₀), the expression saturation voltage denotes the optical saturation and is indicated for 90% relative contrast (V₉₀), in both cases unless expressly indicated otherwise. The capacitive threshold voltage (V₀), also called the Freedericks threshold V_{Fr}, is only used if this is expressly stated.

The parameter ranges indicated in this application all include the limit values, unless expressly indicated otherwise.

The different upper and lower limit values indicated for various ranges of properties give rise in combination with one another to additional preferred ranges.

Throughout the application, unless indicated otherwise, the following conditions and definitions apply. All concentrations are indicated in percent by weight and in each case relate to the entire mixture, all temperatures and all temperature differences are indicated in degrees Celsius or differential degrees. All physical properties are determined in accordance with “Merck Liquid Crystals, Physical Properties of Liquid Crystals”, status November 1997, Merck KGaA, Germany, and are quoted for a temperature of 20° C., unless indicated otherwise. The optical anisotropy (Δn) is determined at a wavelength of 589.3 nm. The dielectric anisotropy (Δε) is determined at a frequency of 1 kHz. The threshold voltages and all other electro-optical properties are determined in test cells made at Merck. The test cells for the determination of Δε have a cell thickness of about 20 μm. The electrode is a circular ITO electrode having an area of 1.13 cm² and a protective ring. The alignment layers are SE-1211 from Nissan Chemicals, Japan, for homeotropic alignment (ε∥) and polyimide AL-1054 from Japan Synthetic Rubber, Japan, for homogeneous alignment (ε⊥). The capacitances are determined with a Solatron 1260 frequency response analyser using a sinus wave with a voltage of 0.3 Vᵣₘₛ. The light used in the electro-optical measurements is white light. A set-up with a commercially available DMS instrument from Autronic-Melchers, Germany, is used. The characteristic voltages are determined with perpendicular observation. The threshold voltage (V₁₀), “mid-grey voltage” (V₅₀) and saturation voltage (V₉₀) are determined for 10%, 50% and 90% relative contrast.

The liquid-crystal media in accordance with the present invention may comprise further additives and chiral dopants in the usual concentrations. The total concentration of these further constituents is in the range from 0% to 10%, preferably 0.1% to 6%, based on the entire mixture. The concentrations of the individual compounds used are preferably in each case in the range from 0.1% to 3%. The concentration of these and similar additives is not taken into account when quoting the values and concentration ranges of the liquid-crystal components and compounds in the liquid-crystal media in this application.

The liquid-crystal media according to the invention consist of a plurality of compounds, preferably of 3 to 30, more preferably of 4 to 20 and very preferably of 4 to 16 compounds. These compounds are mixed in the usual manner. In general, the desired amount of the compound used in the lesser amount is dissolved in the compound used in the greater amount. If the temperature is above the clearing point of the compound used in the higher concentration, the completeness of the dissolution operation is particularly easy to see. However, it is also possible to prepare the media by other conventional routes, for example using so-called premixes, which are, for example, homologous or eutectic mixtures of compounds, or using so-called “multi-bottle” systems, whose constituents are themselves ready-to-use mixtures.

By addition of suitable additives, the liquid-crystal media in accordance with the present invention can be modified in such a way that they can be used in all known types of liquid-crystal displays which employ a vertically aligned or tilted vertically aligned liquid crystalline phase.

All temperatures, such as, for example, the melting point T(C,N) or T(C,S), the transition from the smectic (S) to the nematic (N) phase T(S,N) and the clearing point T (N,I) of the liquid crystals are indicated in degrees Celsius. All temperature differences are indicated in differential degrees.

In the present invention and in particular in the following examples, the structures of the mesogenic compounds are indicated by means of abbreviations, which are also called acronyms. In these acronyms, the chemical formulae are abbreviated as follows using the following Tables A to C. All groups CₙH₂ₙ₊₁, CₘH₂ₘ₊₁ and CₗH₂ₗ₊₁ or CₙH₂ₙ₋₁, CₘH₂ₘ₋₁ and CₗH₂ₗ₋₁ denote straight-chain alkyl or alkenyl respectively, preferably 1-E-alkenyl, in each case having n, m or l C atoms respectively. Table A shows the codes used for the ring elements of the core structures of the compounds, while Table B shows the linking groups. Table C shows the meanings of the codes for the end groups on the left-hand or right-hand side. The acronyms are composed of the codes for the ring elements with optional linking groups, followed by a first hyphen and the codes for the left-hand end group, and a second hyphen and the codes for the right-hand end group. Table D lists illustrative structures of compounds with their respective abbreviations.

TABLE A
Ring elements

| | |
|---|---|
| C | 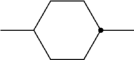 |
| D | 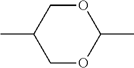 |
| A | 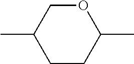 |
| G | 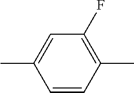 |
| U | 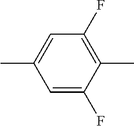 |
| M | 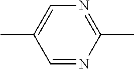 |
| N | 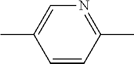 |
| Y | 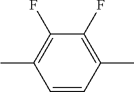 |
| P(F, Cl)Y | 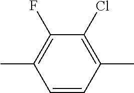 |
| Np | 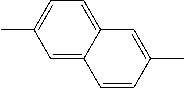 |
| n3f | 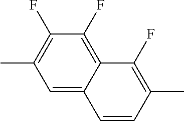 |
| tH | 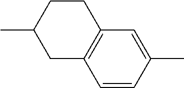 |
| tH2f | 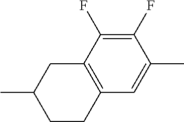 |
| o2f | 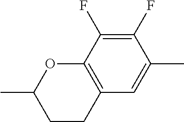 |
| dh | 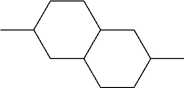 |
| K | 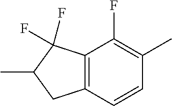 |
| L | 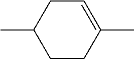 |
| F | 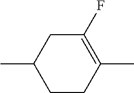 |
| Nf | 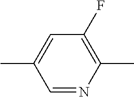 |
| P | 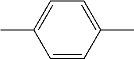 |
| DI | 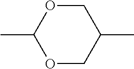 |
| AI | 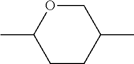 |
| GI | 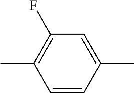 |
| UI | 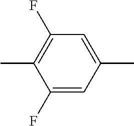 |
| MI | 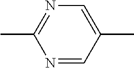 |
| NI | 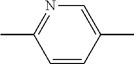 |
| P(Cl, F)Y | 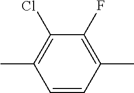 |
| dH | 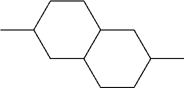 |
| nN3fI | 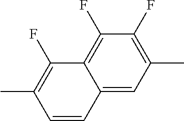 |
| tHI | 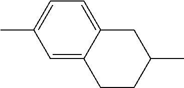 |
| tH2fI | 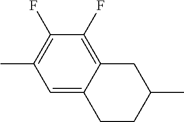 |
| o2fI | 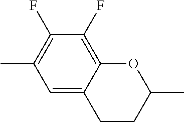 |
| B | 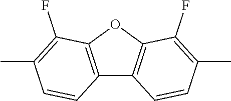 |
| KI | 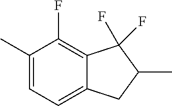 |
| LI | 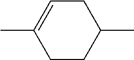 |
| FI | 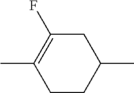 |
| NfI | 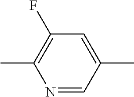 |

TABLE B
Bridging members

| | | | |
|---|---|---|---|
| E | —CH₂—CH₂— | | |
| V | —CH═CH— | | |
| T | —C≡C— | | |
| W | —CF₂—CF₂— | | |
| B | —CF═CF— | | |
| Z | —CO—O— | ZI | —O—CO— |
| X | —CF═CH— | XI | —CH═CF— |
| O | —CH2—O— | OI | —O—CH₂— |
| Q | —CF2—O— | QI | —O—CF₂— |

TABLE C
End groups

| On the left individually or in | | On the right individually or in | |
|---|---|---|---|
| combination | | combination | |
| -n- | CₙH₂ₙ₊₁— | -n | —CₙH₂ₙ₊₁ |
| -nO- | CₙH₂ₙ₊₁—O— | -On | —O—CₙH₂ₙ₊₁ |
| -V- | CH₂═CH— | -V | —CH═CH₂ |
| -nV- | CₙH₂ₙ₊₁—CH═CH— | -nV | —CₙH₂ₙ—CH═CH₂ |
| -Vn- | CH₂═CH—CₙH₂ₙ— | -Vn | —CH═CH—CₙH₂ₙ₊₁ |
| -nVm- | CₙH₂ₙ₊₁—CH═CH—CₘH₂ₘ— | -nVm | —CₙH₂ₙ—CH═CH—CₘH₂ₘ₊₁ |
| -N- | N≡C— | -N | —C≡N |
| -S- | S═C═N— | -S | —N═C═S |
| -F- | F— | -F | —F |
| -CL- | Cl— | -CL | —Cl |
| -M- | CFH₂— | -M | —CFH₂ |
| -D- | CF₂H— | -D | —CF₂H |
| -T- | CF₃— | -T | —CF₃ |
| -MO- | CFH₂O— | -OM | —OCFH₂ |
| -DO- | CF₂HO— | -OD | —OCF₂H |
| -TO- | CF₃O— | -OT | —OCF₃ |
| -A- | H—C≡C— | -A | —C≡C—H |
| -nA- | CₙH₂ₙ₊₁—C≡C— | -An | —C≡C—CₙH₂ₙ₊₁ |
| -NA- | N≡C—C≡C— | -AN | —C≡C—C≡N |
| | | -OXF | —O—CH═CF₂ |
| On the left only in combination | | On the right only in combination | |
| - . . . n . . . - | —CₙH₂ₙ— | - . . . n . . . | —CₙH₂ₙ— |
| - . . . M . . . - | —CFH— | - . . . M . . . - | —CFH— |
| - . . . D . . . - | —CF₂— | - . . . D . . . - | —CF₂— |
| - . . . V . . . - | —CH═CH— | - . . . V . . . | —CH═CH— |
| - . . . Z . . . - | —CO—O— | - . . . Z . . . | —CO—O— |
| - . . . ZI . . . - | —O—CO— | - . . . ZI . . . | —O—CO— |
| - . . . K . . . - | —CO— | - . . . K . . . | —CO— |
| - . . . W . . . - | —CF═CF— | - . . . W . . . | —CF═CF— |
| | | - . . . X . . . | —CH═CF— |

in which n and m are each integers and the three dots “ . . . ” are placeholders for other abbreviations from this table.

The following table shows illustrative structures together with their respective abbreviations. These are shown in order to demonstrate the meaning of the rules for the abbreviations. The mixtures according to the invention, besides the compounds of the formula I, preferably comprise one or more compounds of the compounds shown below.

The following abbreviations are used:

(n, m and z, independently of one another, each denote an integer, preferably 1 to 6).

TABLE D
Illustrative structures

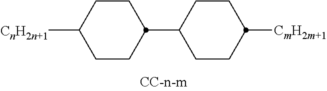

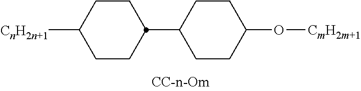

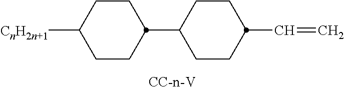

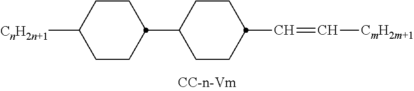

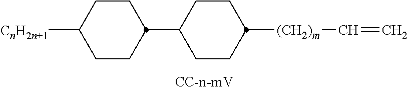

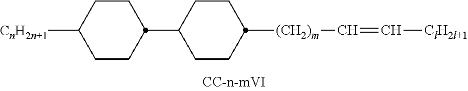

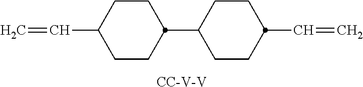

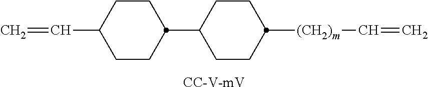

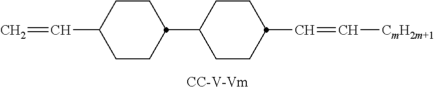

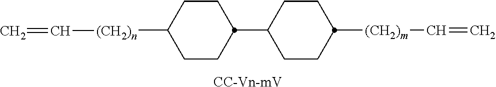

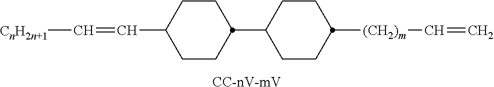

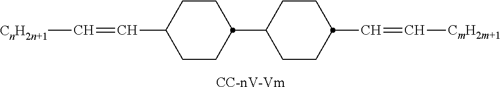

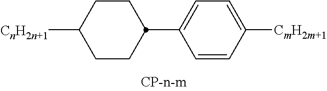

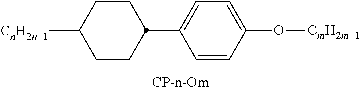

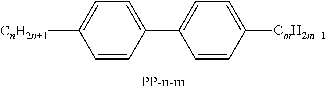

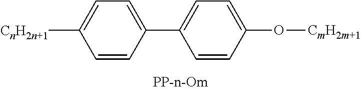

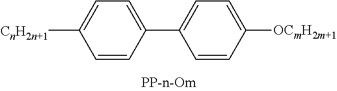

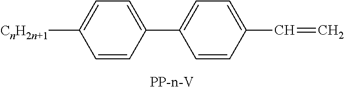

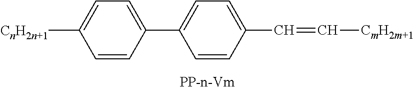

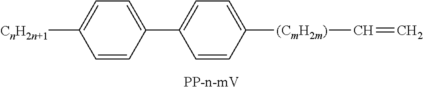

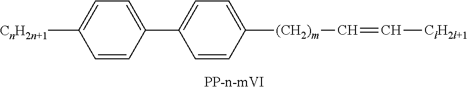

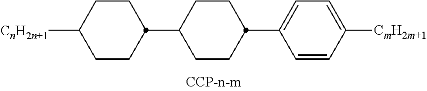

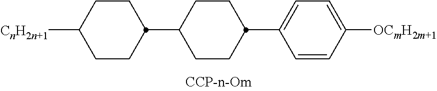

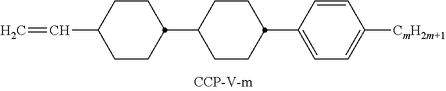

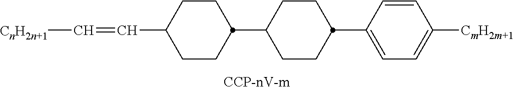

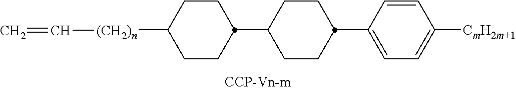

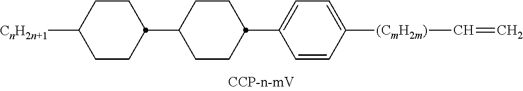

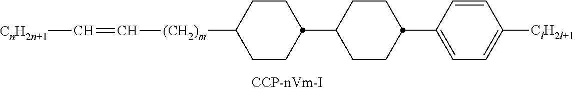

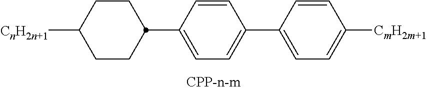

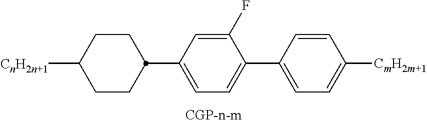

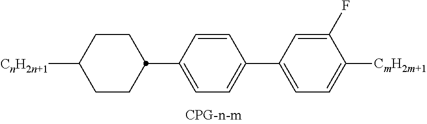

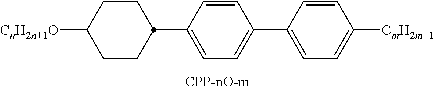

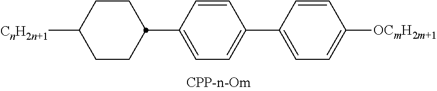

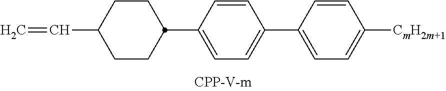

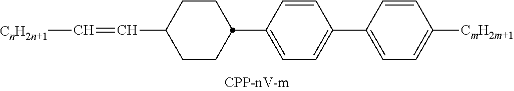

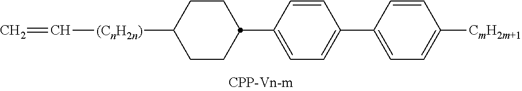

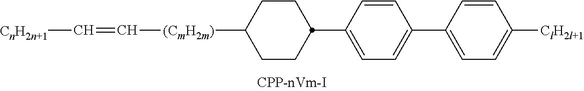

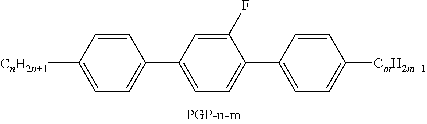

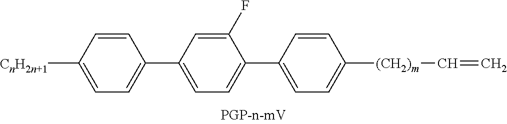

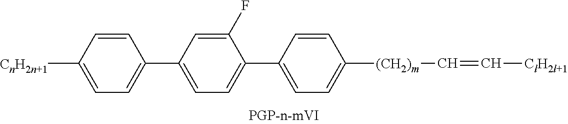

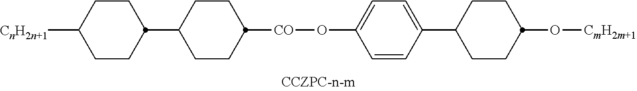

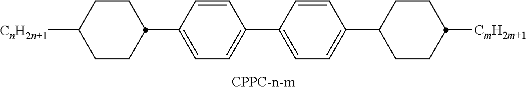

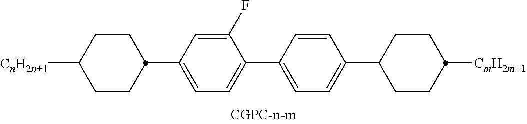

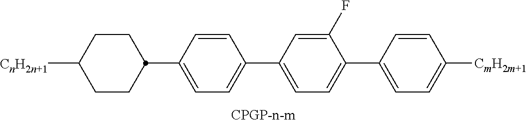

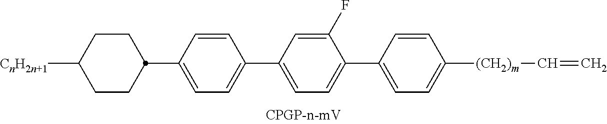

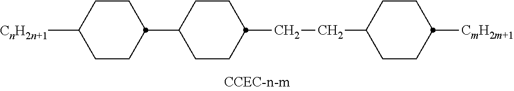

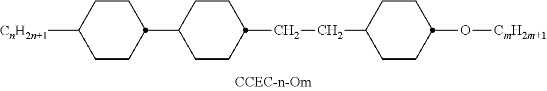

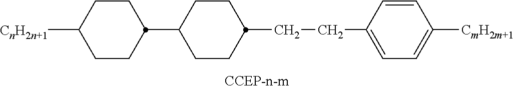

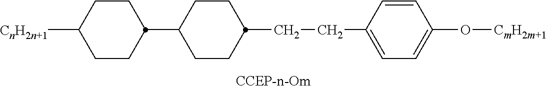

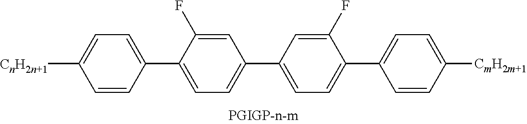

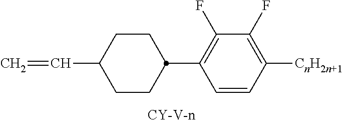

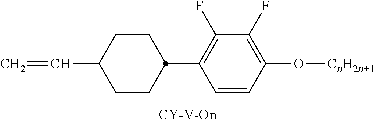

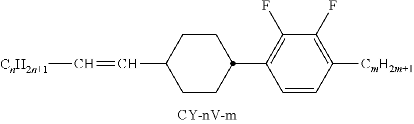

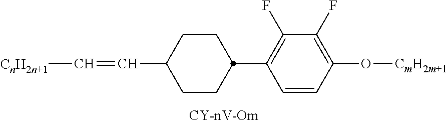

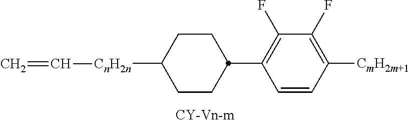

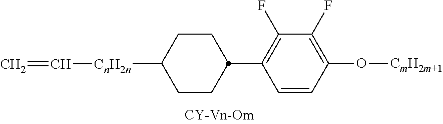

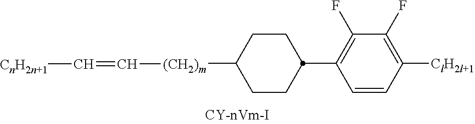

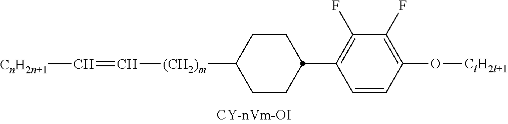

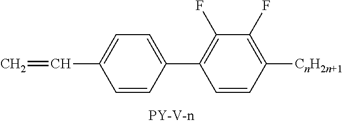

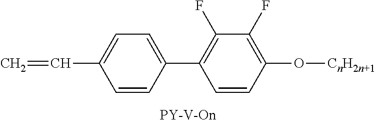

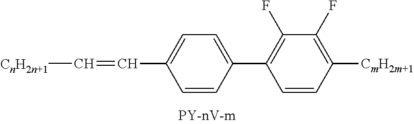

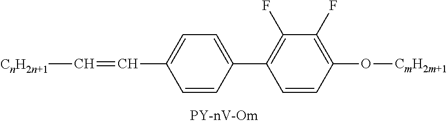

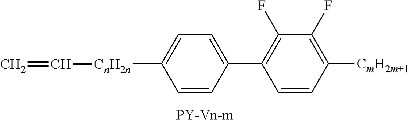

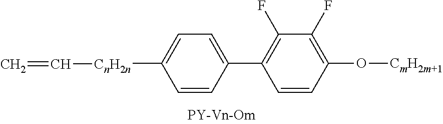

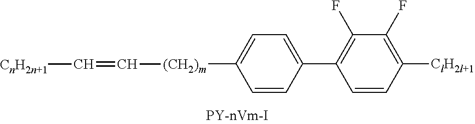

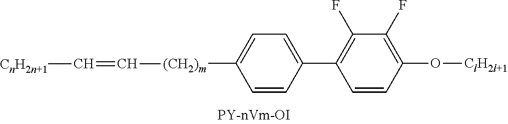

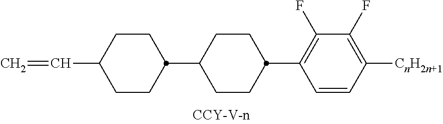

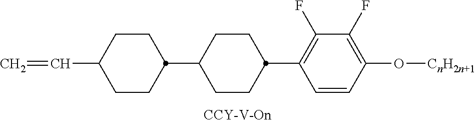

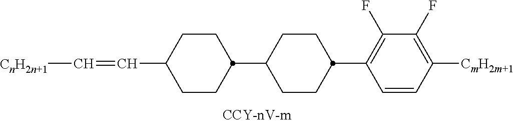

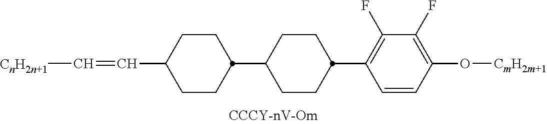

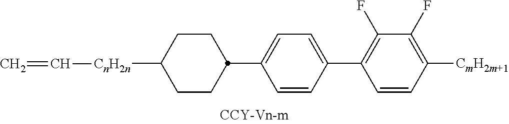

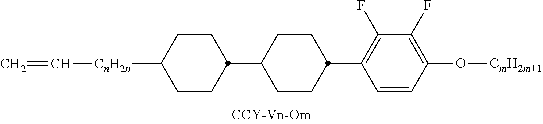

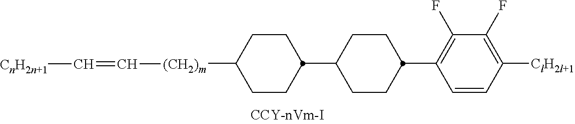

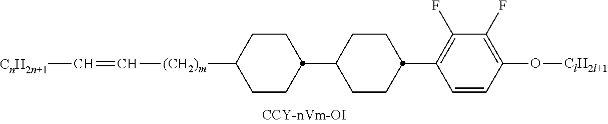

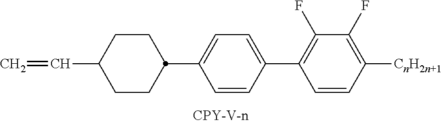

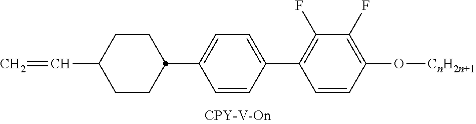

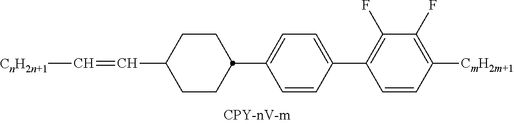

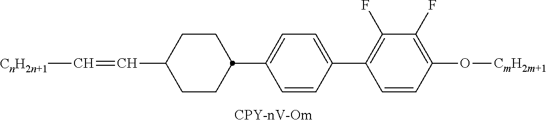

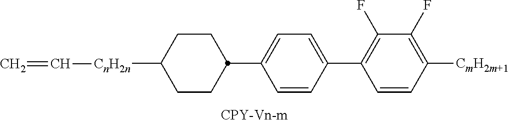

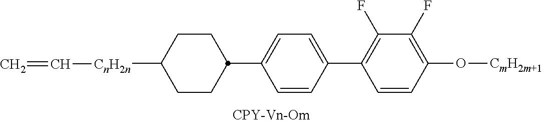

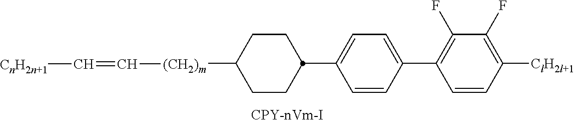

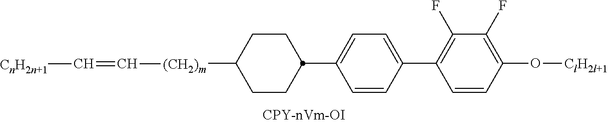

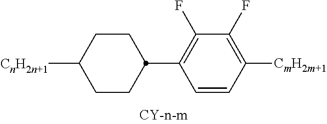

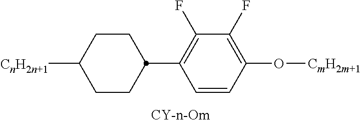

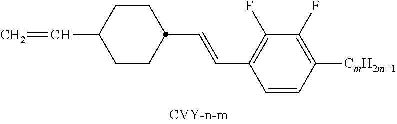

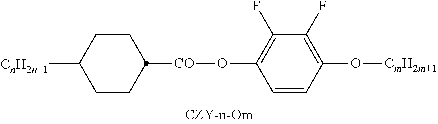

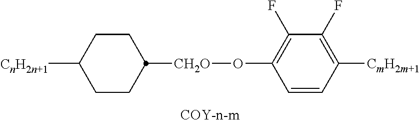

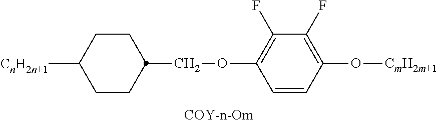

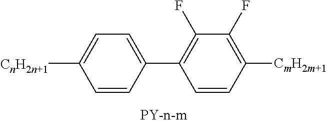

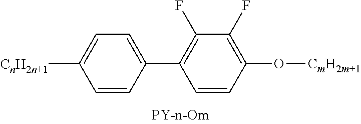

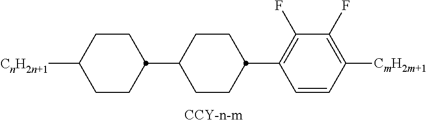

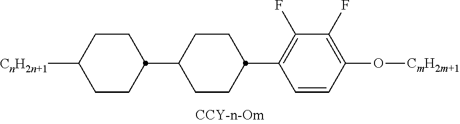

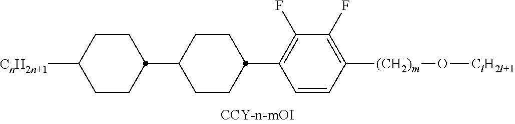

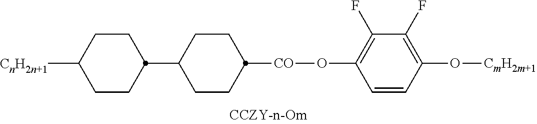

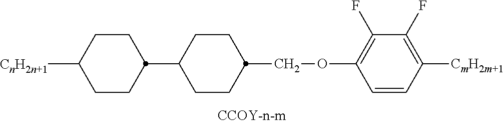

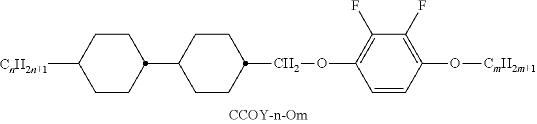

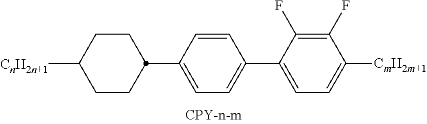

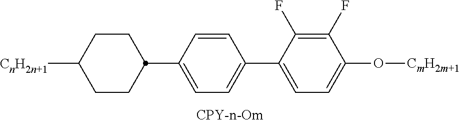

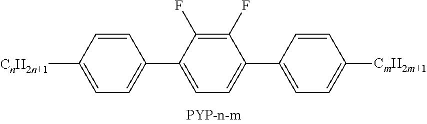

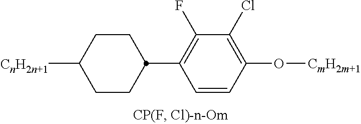

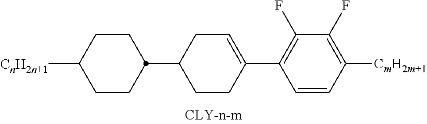

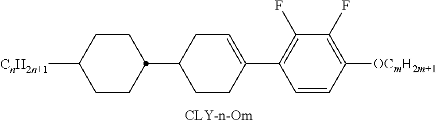

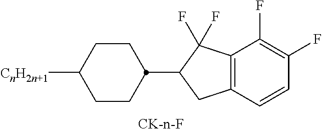

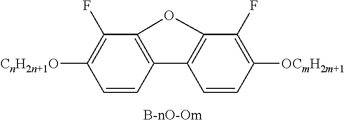

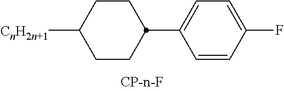

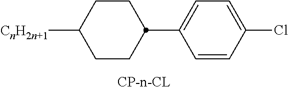

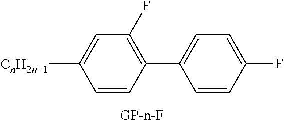

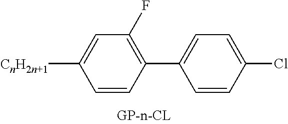

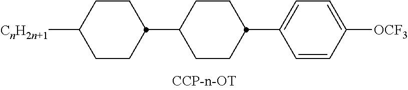

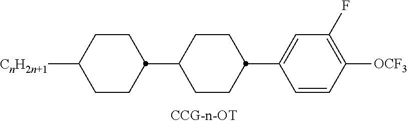

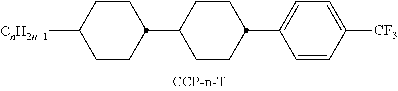

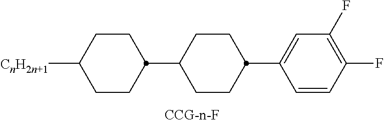

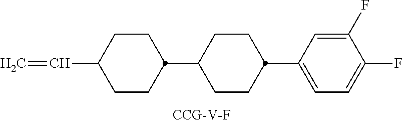

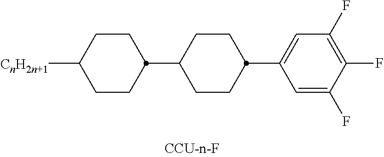

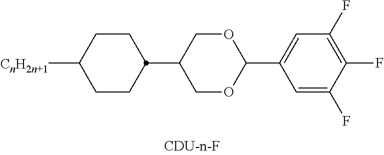

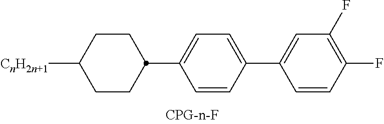

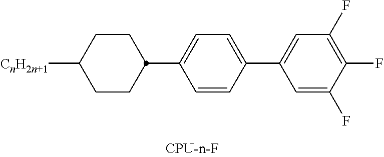

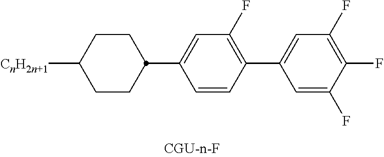

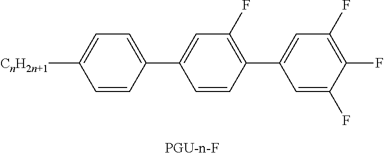

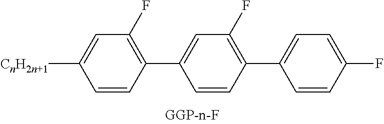

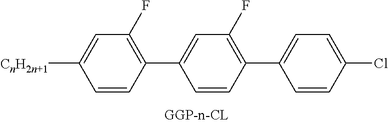

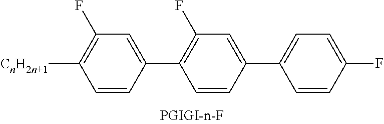

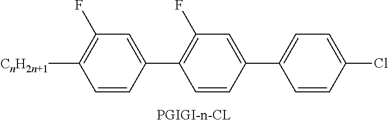

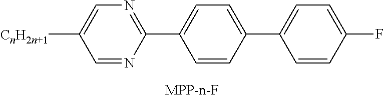

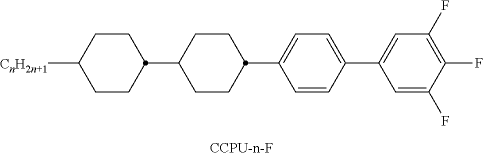

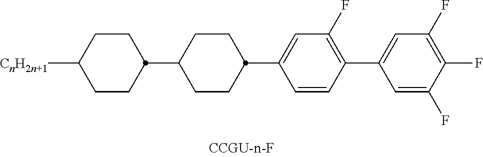

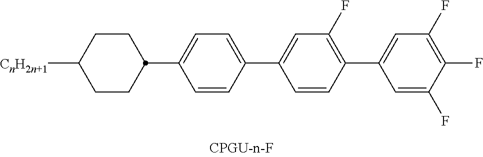

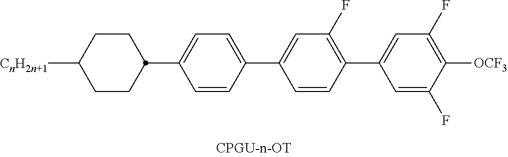

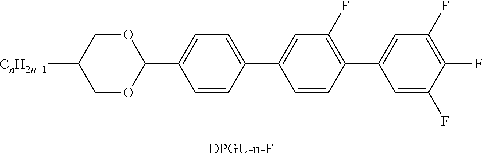

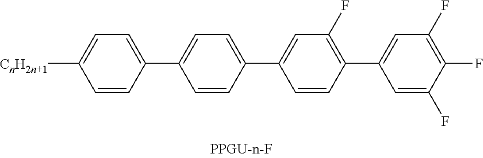

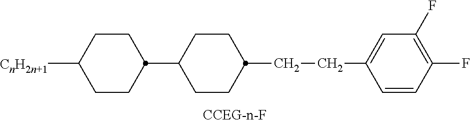

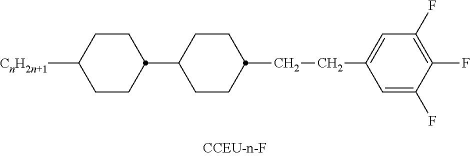

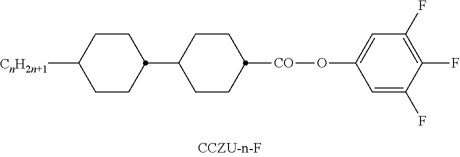

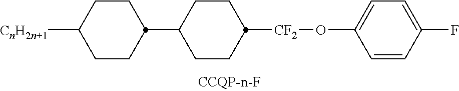

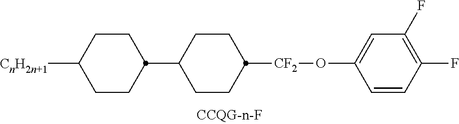

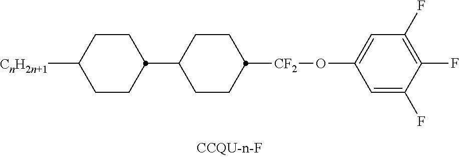

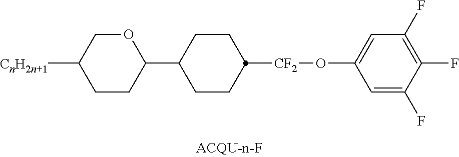

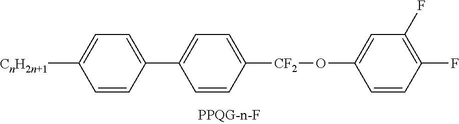

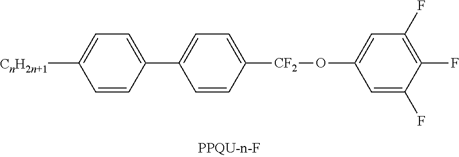

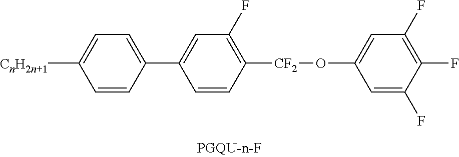

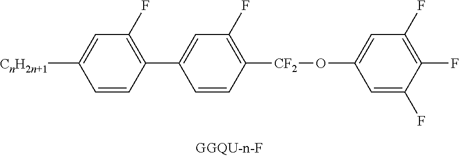

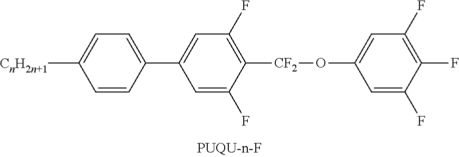

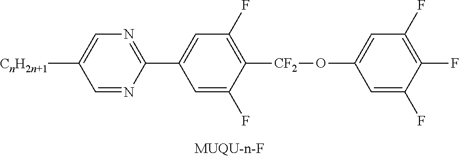

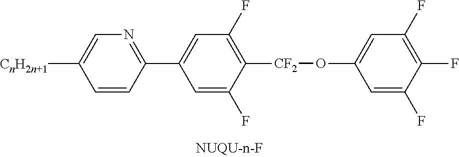

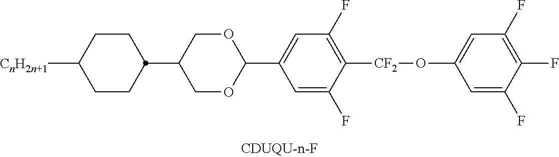

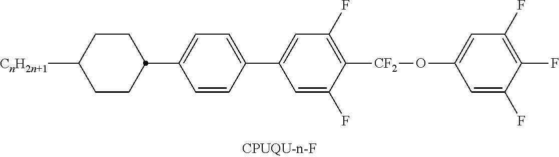

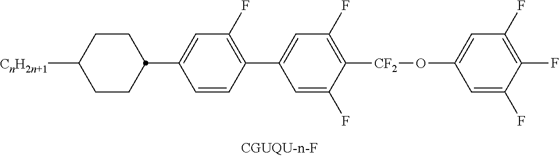

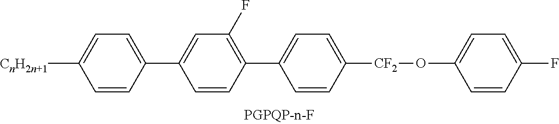

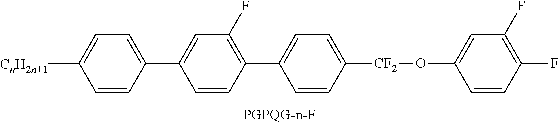

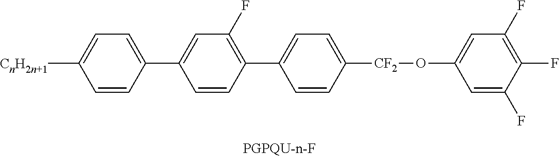

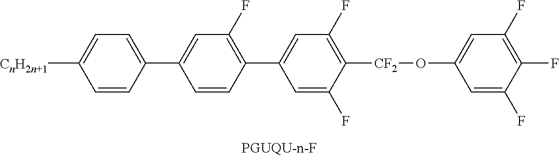

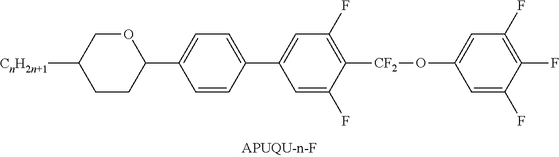

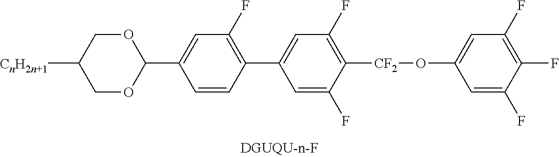

Table E below shows chiral dopants which can preferably be employed in the mixtures according to the invention.

TABLE E

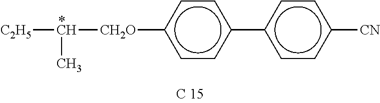

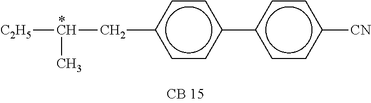

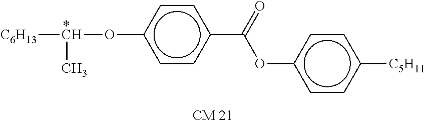

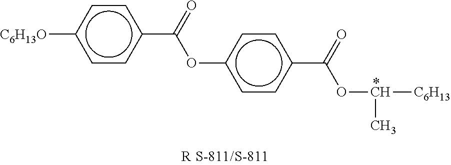

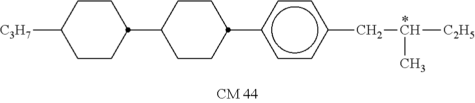

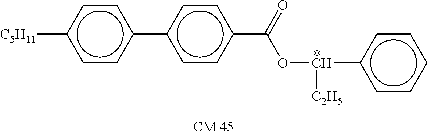

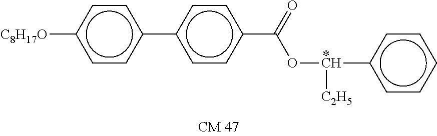

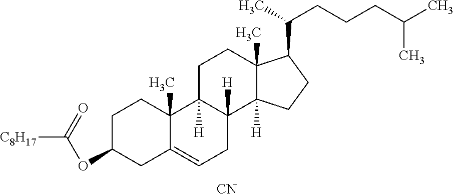

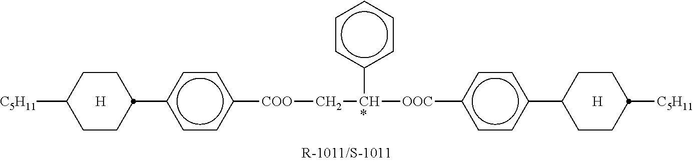

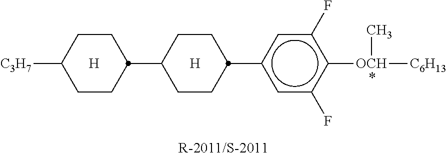

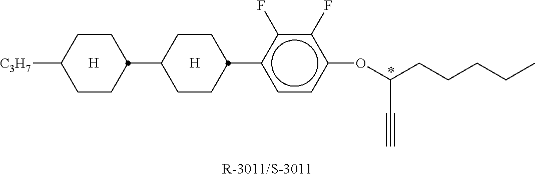

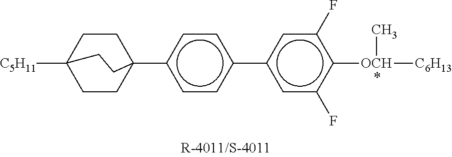

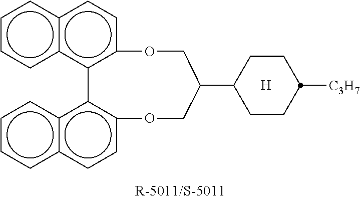

In a preferred embodiment of the present invention, the media according to the invention comprise one or more compounds selected from the group of the compounds from Table E.

Table F shows stabilisers which can be employed in the mixtures according to the invention. The parameter n here denotes an integer in the range from 1 to 12.

TABLE F

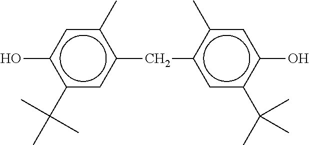

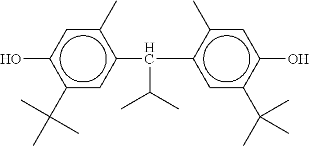

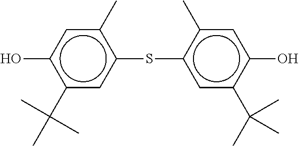

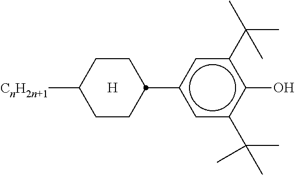

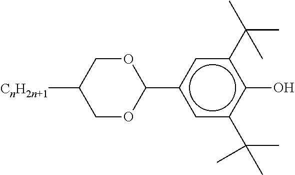

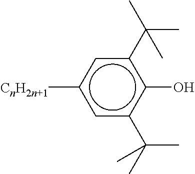

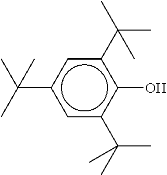

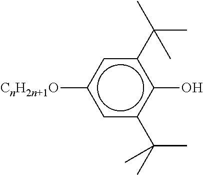

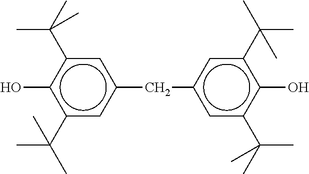

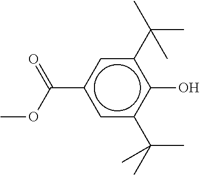

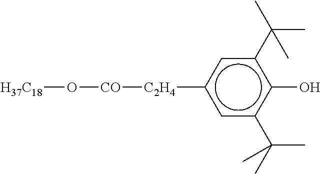

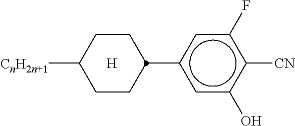

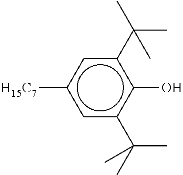

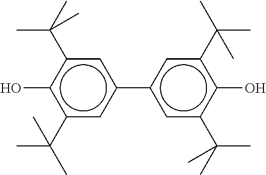

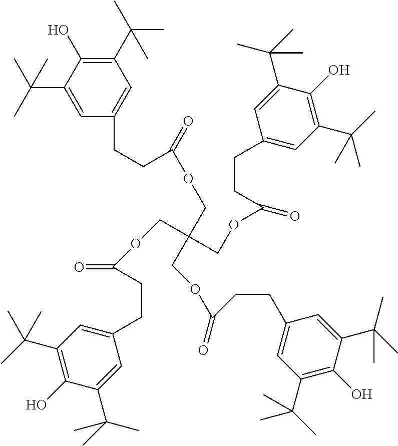 [SMILES: CC(C)(C)c1cc(CCC(=O)OCC(COC(=O)CCc2cc(C(C)(C)C)c(O)c(C(C)(C)C)c2)(COC(=O)CCc2cc(C(C)(C)C)c(O)c(C(C)(C)C)c2)COC(=O)CCc2cc(C(C)(C)C)c(O)c(C(C)(C)C)c2)cc(C(C)(C)C)c1O]

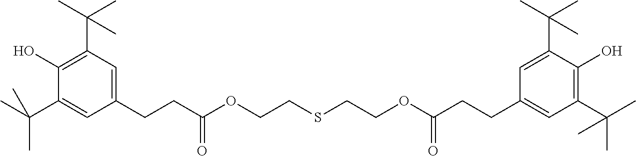 [SMILES: CC(C)(C)c1cc(CCC(=O)OCCSCCOC(=O)CCc2cc(C(C)(C)C)c(O)c(C(C)(C)C)c2)cc(C(C)(C)C)c1O]

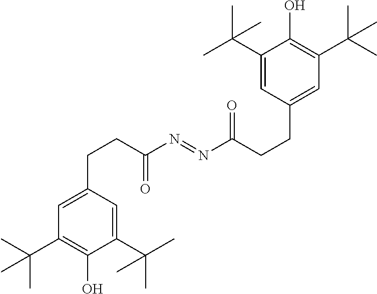 [SMILES: CC(C)(C)c1cc(CCC(=O)/N=N/C(=O)CCc2cc(C(C)(C)C)c(O)c(C(C)(C)C)c2)cc(C(C)(C)C)c1O]

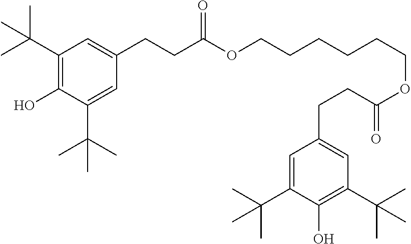 [SMILES: CC(C)(C)c1cc(CCC(=O)OCCCCCCOC(=O)CCc2cc(C(C)(C)C)c(O)c(C(C)(C)C)c2)cc(C(C)(C)C)c1O]

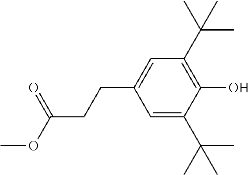 [SMILES: COC(=O)CCc1cc(C(C)(C)C)c(O)c(C(C)(C)C)c1]

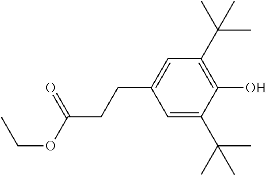 [SMILES: CCOC(=O)CCc1cc(C(C)(C)C)c(O)c(C(C)(C)C)c1]

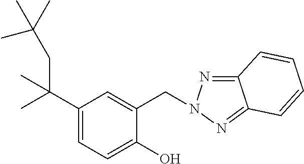 [SMILES: CC(C)(C)CC(C)(C)c1ccc(O)c(Cn2nc3ccccc3n2)c1]

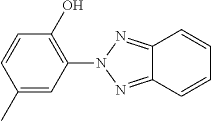 [SMILES: Cc1ccc(O)c(-n2nc3ccccc3n2)c1]

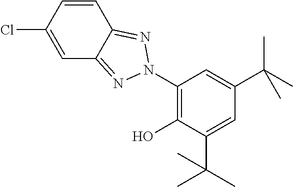 [SMILES: CC(C)(C)c1cc(-n2nc3ccc(Cl)cc3n2)c(O)c(C(C)(C)C)c1]

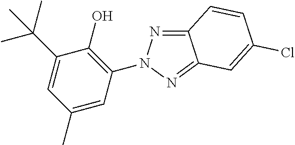 [SMILES: Cc1cc(-n2nc3ccc(Cl)cc3n2)c(O)c(C(C)(C)C)c1]

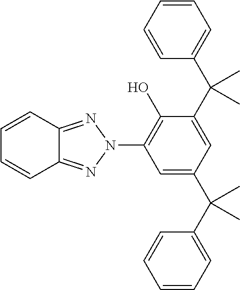 [SMILES: CC(C)(c1ccccc1)c1cc(-n2nc3ccccc3n2)c(O)c(C(C)(C)c2ccccc2)c1]

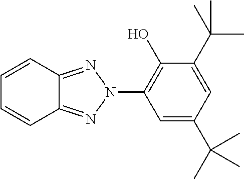 [SMILES: CC(C)(C)c1cc(-n2nc3ccccc3n2)c(O)c(C(C)(C)C)c1]

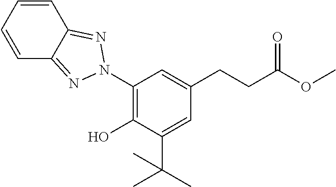 [SMILES: COC(=O)CCc1cc(-n2nc3ccccc3n2)c(O)c(C(C)(C)C)c1]

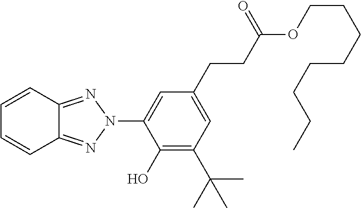 [SMILES: CCCCCCCCOC(=O)CCc1cc(-n2nc3ccccc3n2)c(O)c(C(C)(C)C)c1]

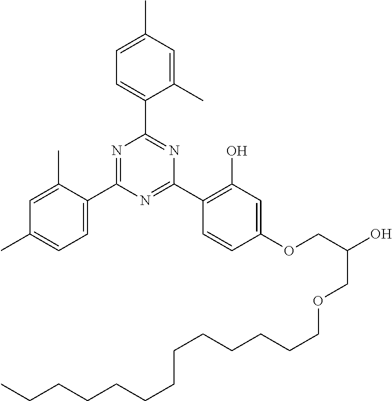 [SMILES: CCCCCCCCCCCCCOCC(O)COc1ccc(-c2nc(-c3ccc(C)cc3C)nc(-c3ccc(C)cc3C)n2)c(O)c1]

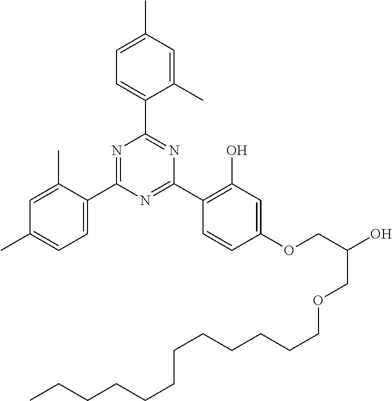 [SMILES: CCCCCCCCCCCCOCC(O)COc1ccc(-c2nc(-c3ccc(C)cc3C)nc(-c3ccc(C)cc3C)n2)c(O)c1]

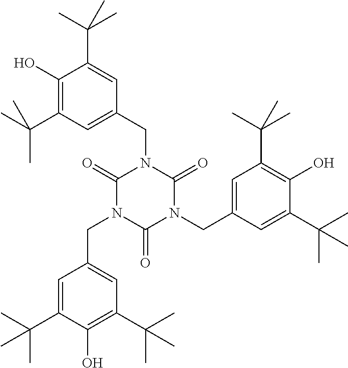 [SMILES: CC(C)(C)c1cc(Cn2c(=O)n(Cc3cc(C(C)(C)C)c(O)c(C(C)(C)C)c3)c(=O)n(Cc3cc(C(C)(C)C)c(O)c(C(C)(C)C)c3)c2=O)cc(C(C)(C)C)c1O]

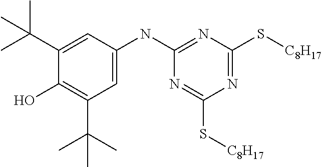

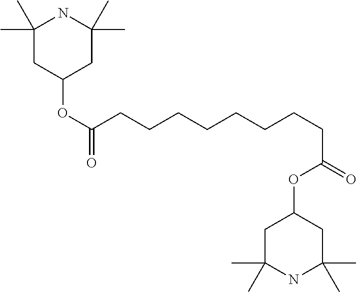

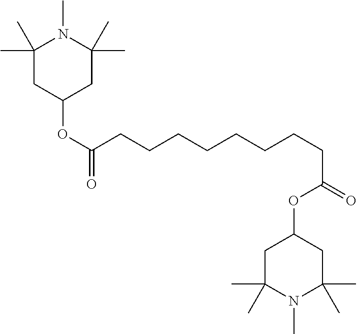

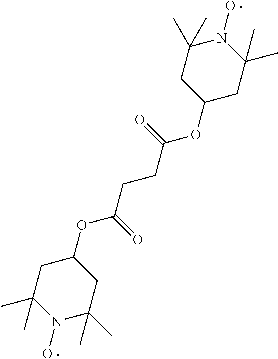

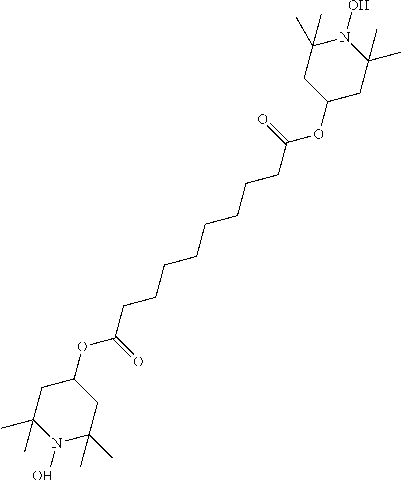

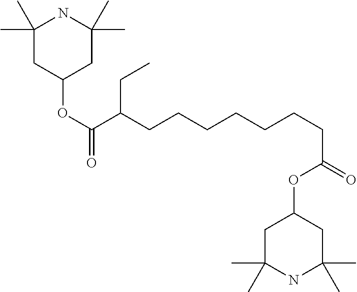

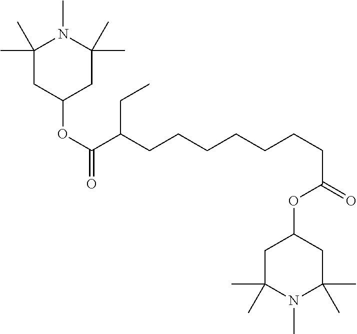

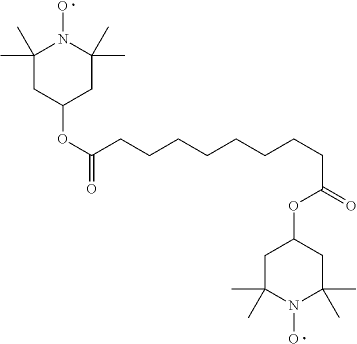

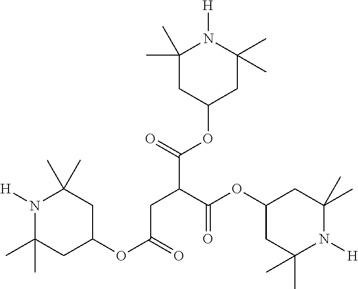 [SMILES: CC1(C)CC(OC(=O)CC(C(=O)OC2CC(C)(C)NC(C)(C)C2)C(=O)OC2CC(C)(C)NC(C)(C)C2)CC(C)(C)N1]

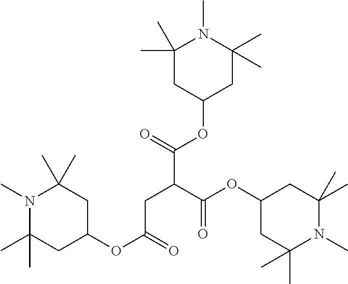

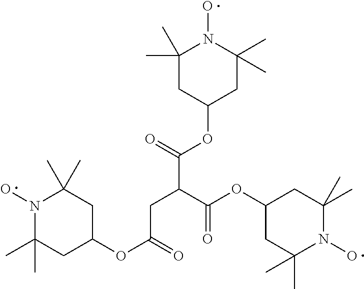

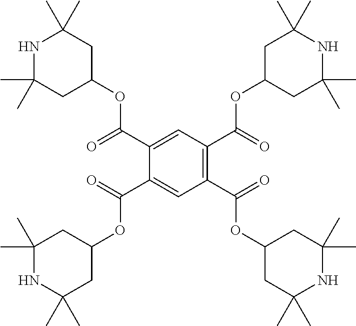

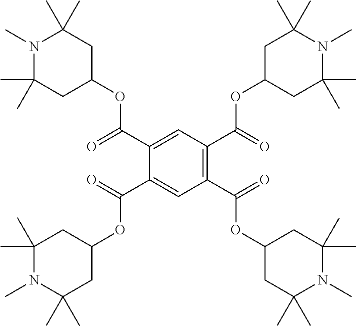

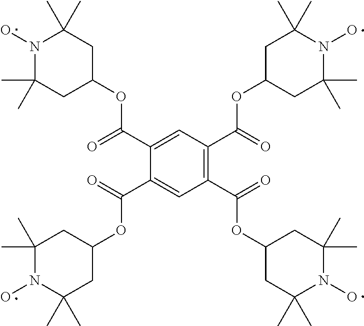

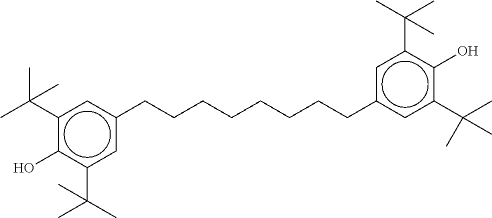

In a preferred embodiment of the present invention, the media according to the invention comprise one or more compounds selected from the group of the compounds from Table F, in particular one or more compounds selected from the group of the compounds of the two formulae

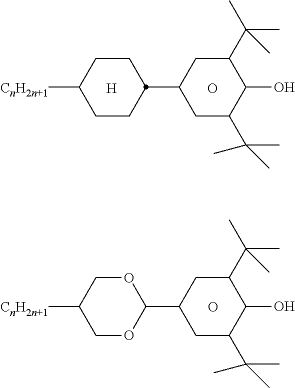

Table G lists illustrative compounds which can preferably be used as polymerizable compounds in the LC media in accordance with the present invention.

TABLE G

| | |
|---|---|
| 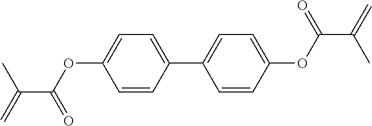 | RM-1 |
| 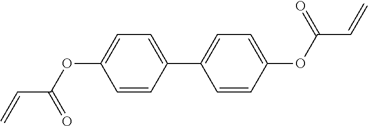 | RM-2 |
| 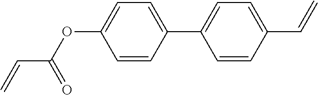 | RM-3 |
| 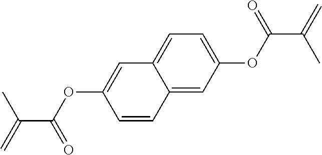 | RM-4 |
| 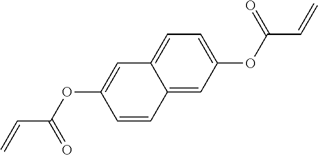 | RM-5 |
| 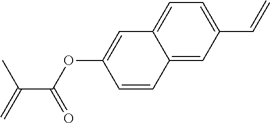 | RM-6 |
| 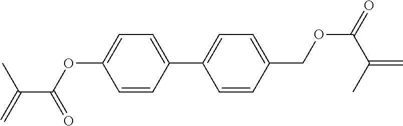 | RM-7 |
| 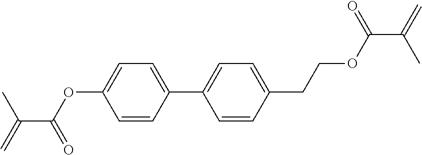 | RM-8 |
| 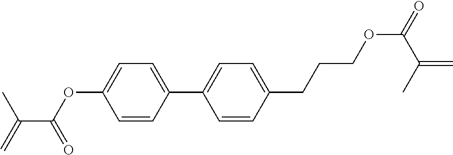 | RM-9 |
| 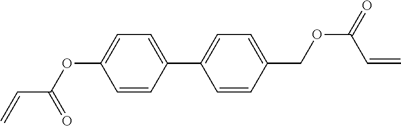 | RM-10 |
| 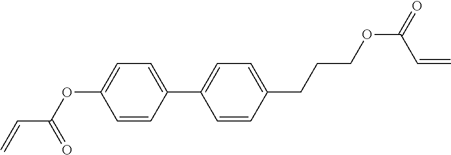 | RM-11 |
| 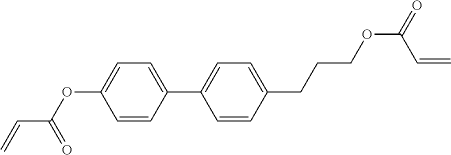 | RM-12 |
| 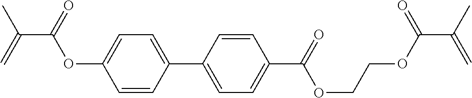 | RM-13 |
| 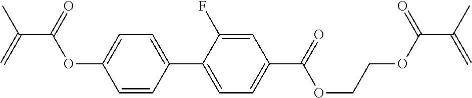 | RM-14 |
| 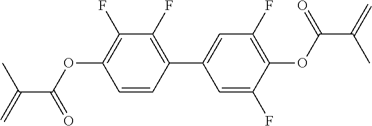 | RM-15 |
| 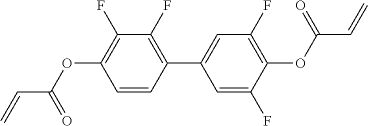 | RM-16 |
| 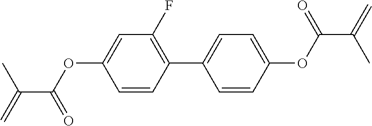 | RM-17 |
| 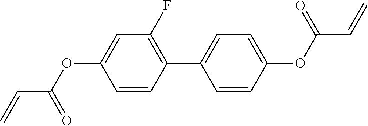 | RM-18 |
| 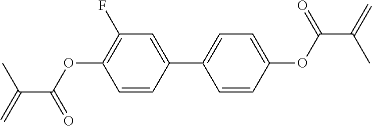 | RM-19 |
| 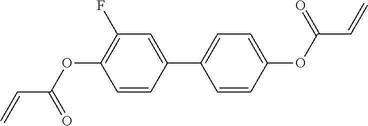 | RM-20 |
| 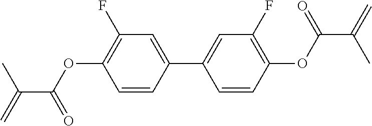 | RM-21 |
| 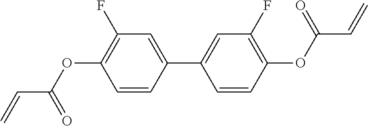 | RM-22 |
| 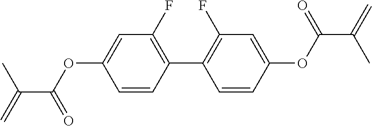 | RM-23 |
| 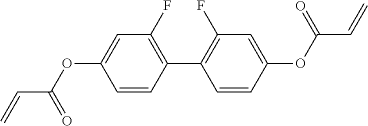 | RM-24 |
| 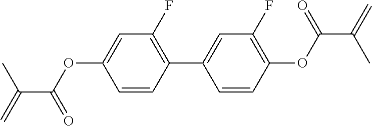 | RM-25 |
| 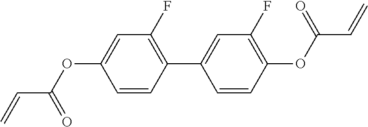 | RM-26 |
| 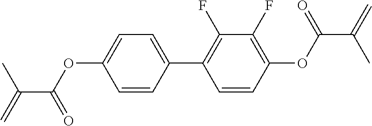 | RM-27 |
| 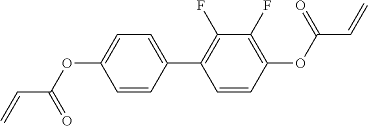 | RM-28 |
| 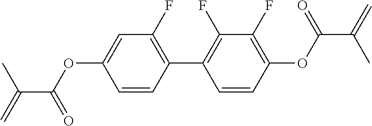 | RM-29 |
| 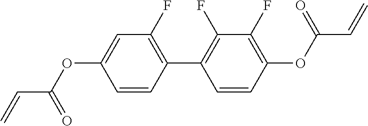 | RM-30 |
| 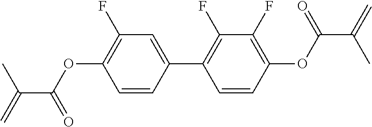 | RM-31 |
| 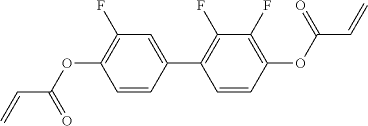 | RM-32 |
| 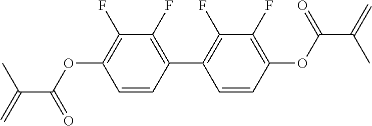 | RM-33 |
| 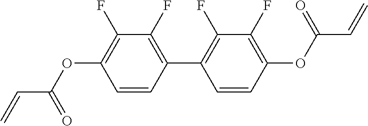 | RM-34 |
| 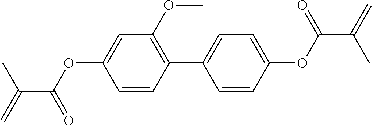 | RM-35 |
| 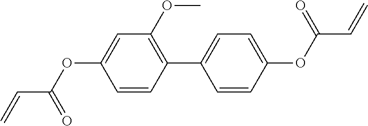 | RM-36 |
| 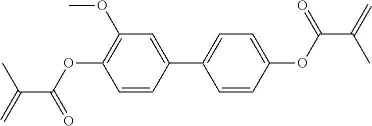 | RM-37 |
| 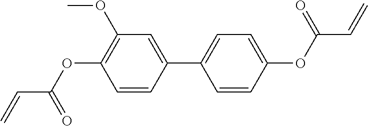 | RM-38 |
| 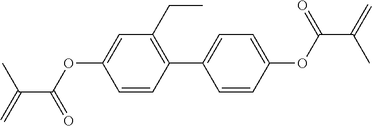 | RM-39 |
| 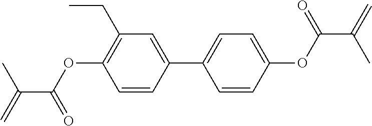 | RM-40 |
| 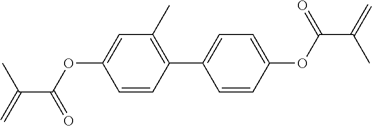 | RM-41 |
| 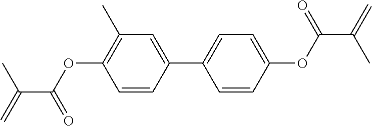 | RM-42 |
| 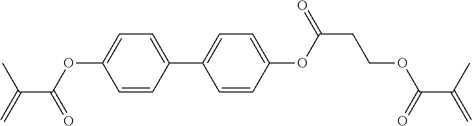 | RM-43 |
| 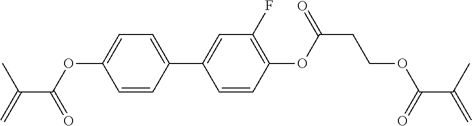 | RM-44 |
| 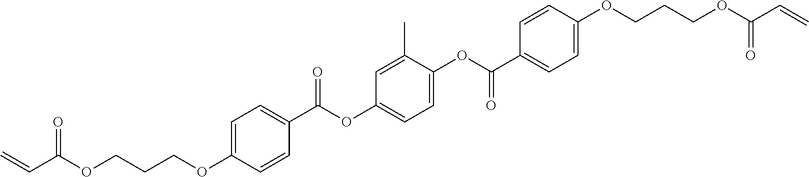 | RM-45 |
| 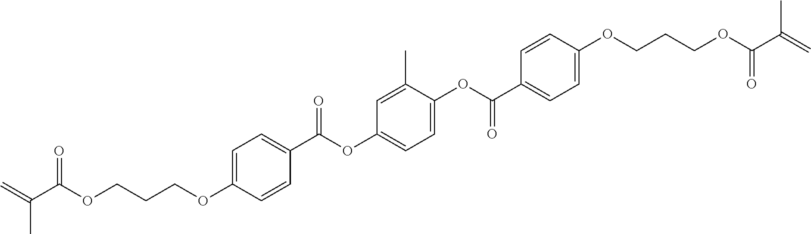 | RM-46 |
| 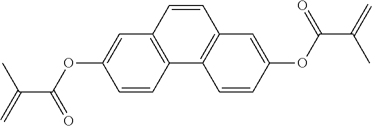 | RM-47 |
| 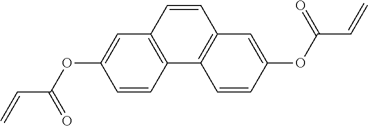 | RM-48 |
| 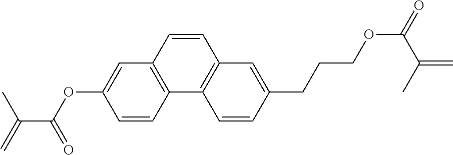 | RM-49 |
| 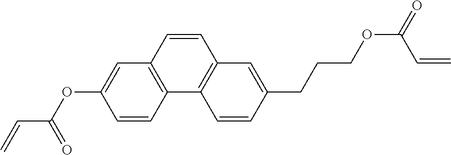 | RM-50 |
| 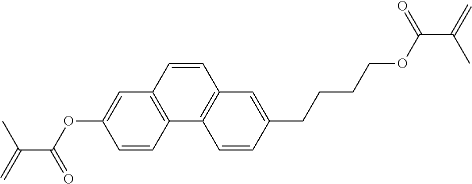 | RM-51 |
| 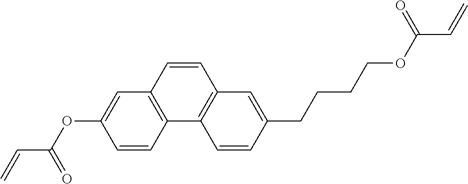 | RM-52 |
| 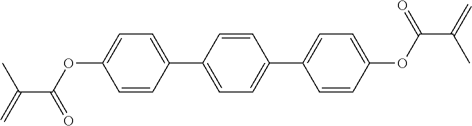 | RM-53 |
| 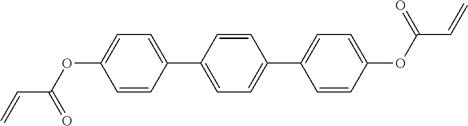 | RM-54 |
| 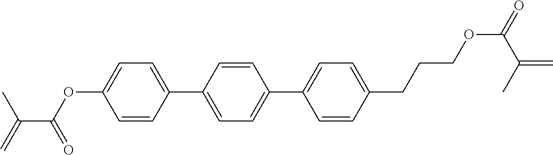 | RM-55 |
| 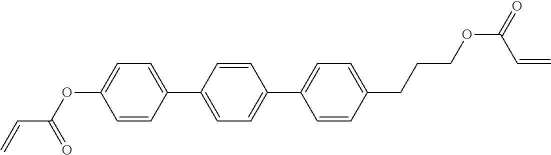 | RM-56 |
| 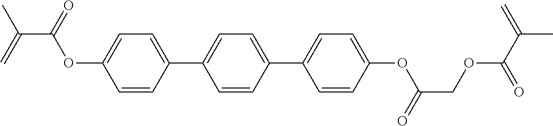 | RM-57 |
| 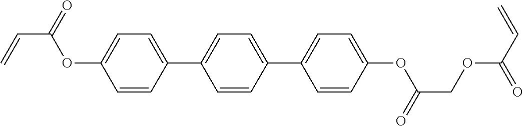 | RM-58 |
| 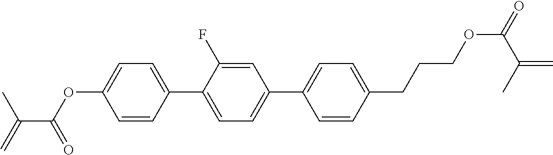 | RM-59 |
| 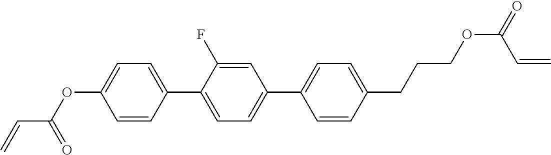 | RM-60 |
| 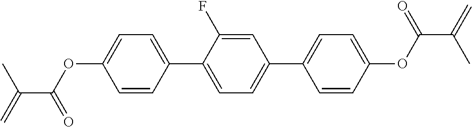 | RM-61 |
| 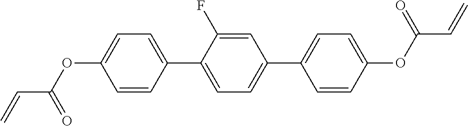 | RM-62 |
| 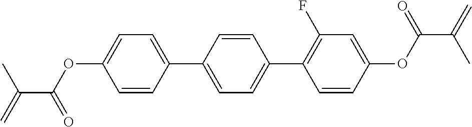 | RM-63 |
| 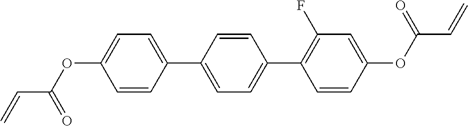 | RM-64 |
| 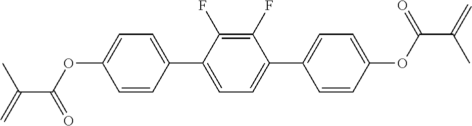 | RM-65 |
| 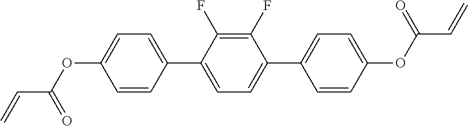 | RM-66 |
| 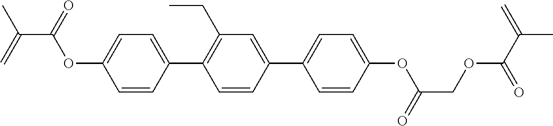 | RM-67 |
| 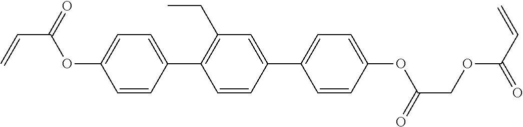 | RM-68 |
| 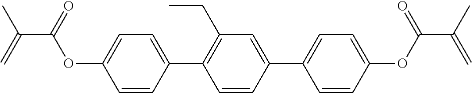 | RM-69 |
| 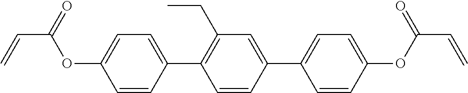 | RM-70 |
| 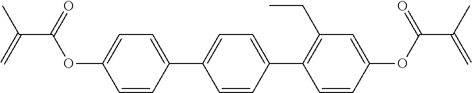 | RM-71 |
| 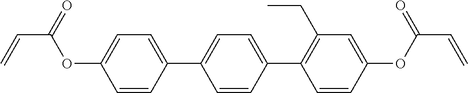 | RM-72 |
| 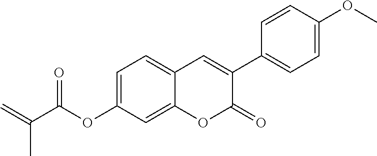 | RM-73 |
| 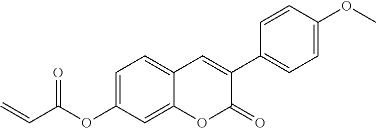 | RM-74 |
| 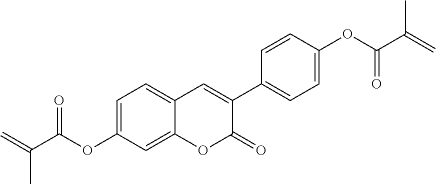 | RM-75 |
| 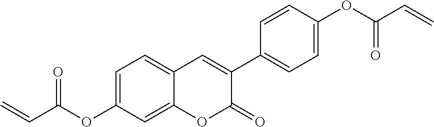 | RM-76 |
| 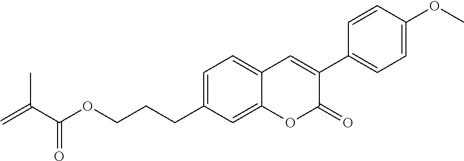 | RM-77 |
| 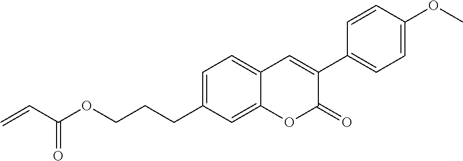 | RM-78 |
| 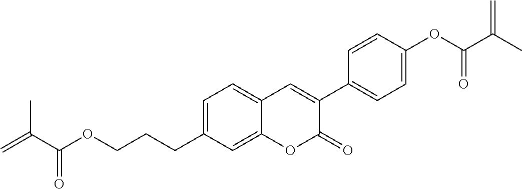 | RM-79 |
| 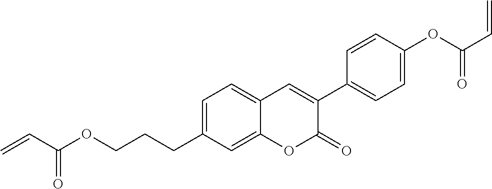 | RM-80 |
| 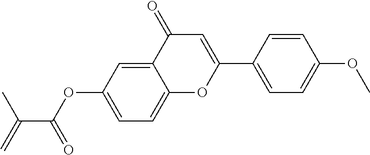 | RM-81 |
| 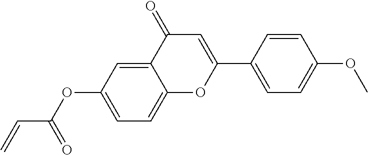 | RM-82 |
| 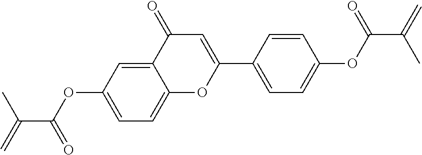 | RM-83 |
| 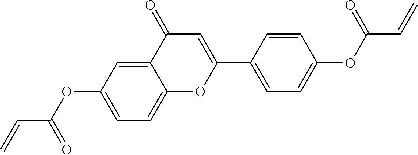 | RM-84 |
| 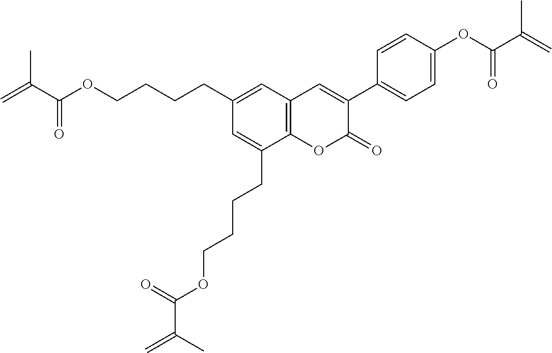 | RM-85 |
| 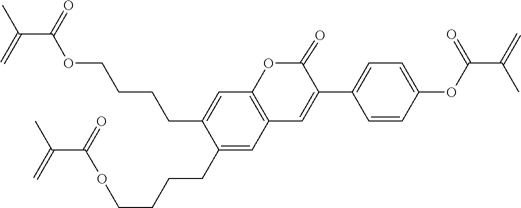 | RM-86 |
| 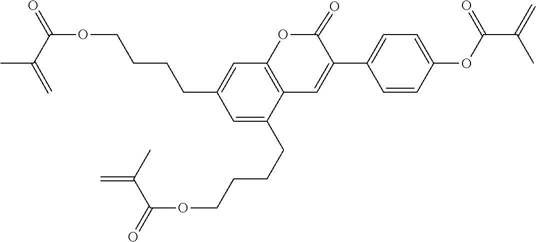 | RM-87 |
| 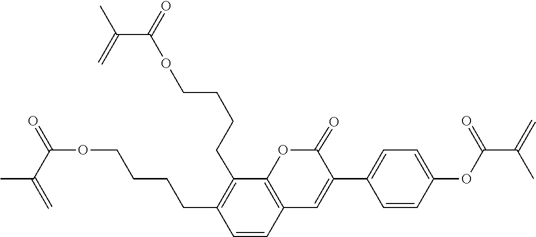 | RM-88 |
| 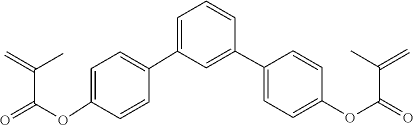 | RM-89 |
| 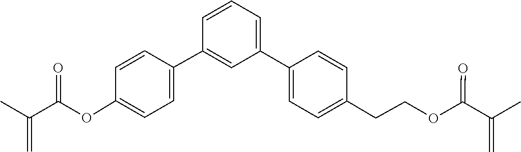 | RM-90 |
| 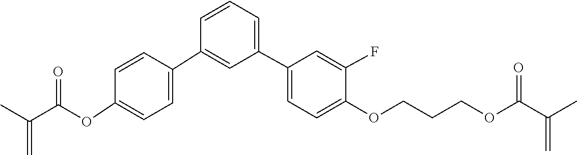 | RM-91 |
| 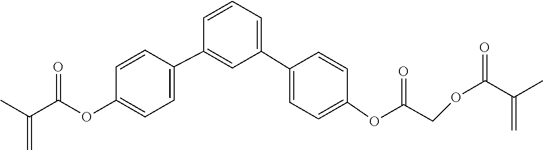 | RM-92 |
| 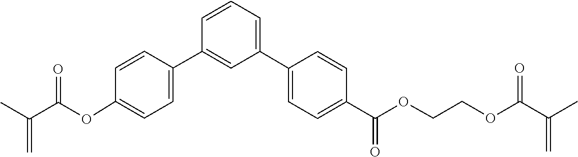 | RM-93 |
| 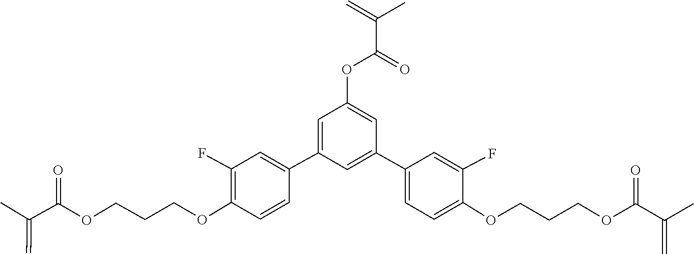 | RM-94 |
| 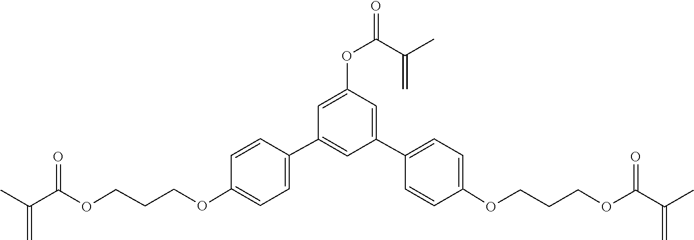 | RM-95 |
| 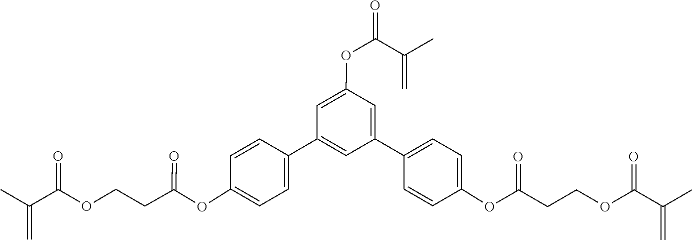 | RM-96 |
| 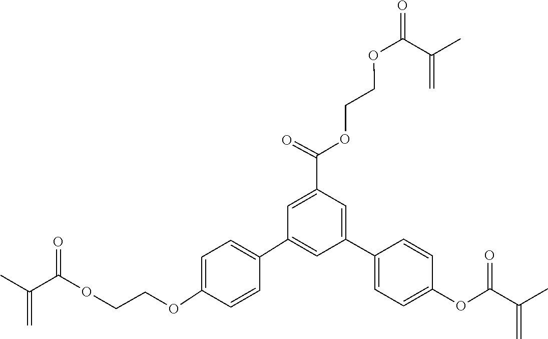 | RM-97 |
| 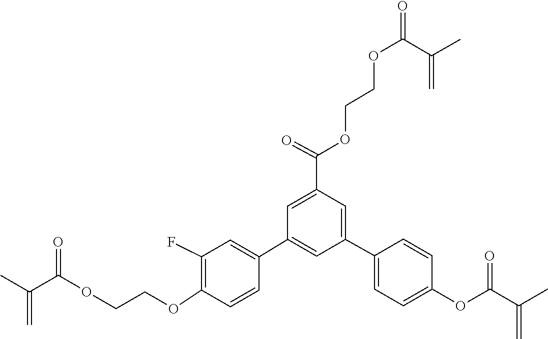 | RM-98 |
| 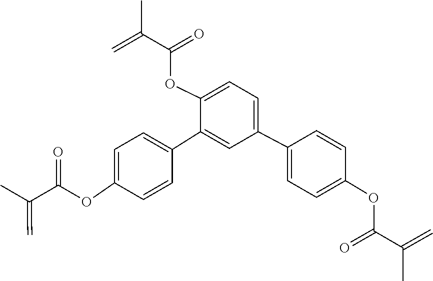 | RM-99 |
| 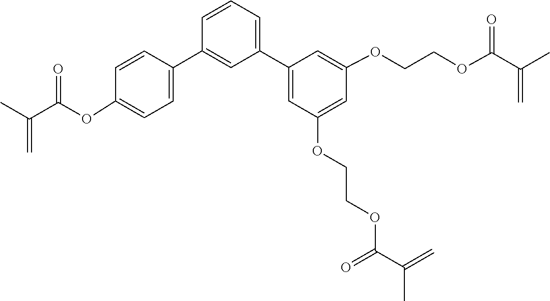 | RM-100 |
| 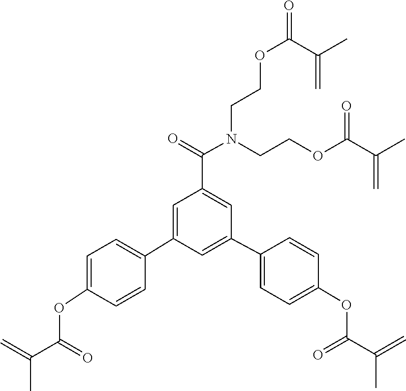 | RM-101 |
| 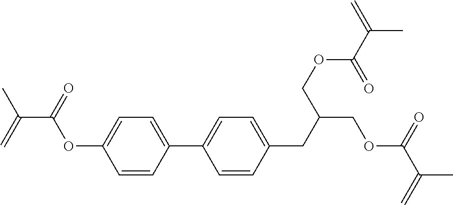 | RM-102 |
| 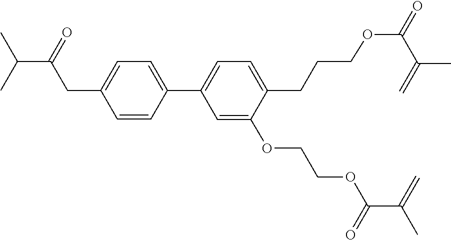 | RM-103 |
| 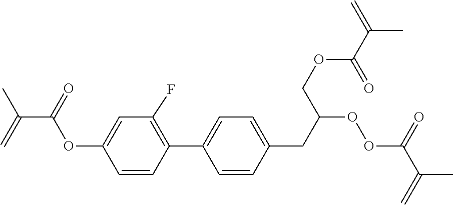 | RM-104 |
| 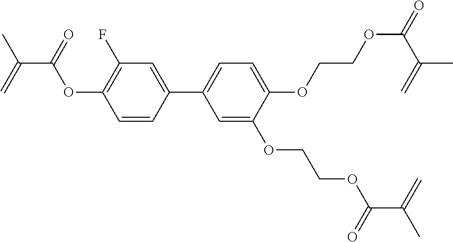 | RM-105 |
| 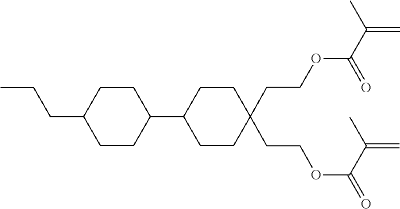 | RM-106 |
| 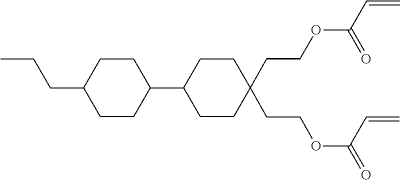 | RM-107 |
| 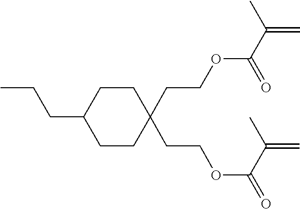 | RM-108 |
| 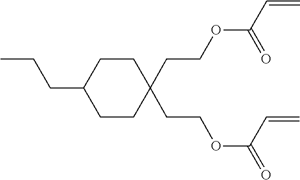 | RM-109 |
| 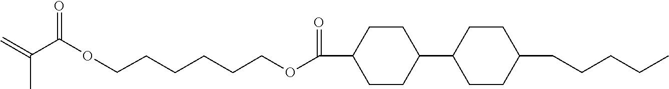 | RM-110 |
| 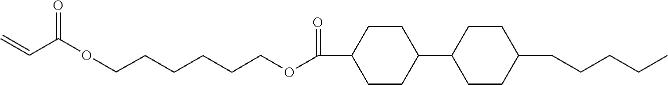 | RM-111 |
| 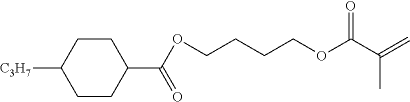 | RM-112 |
| 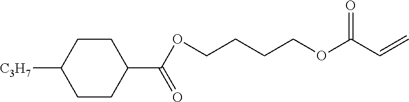 | RM-113 |
| 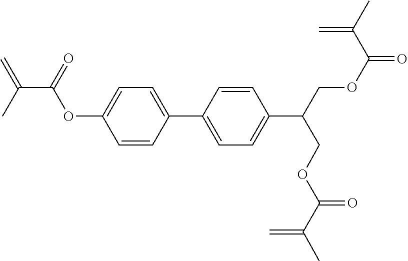 | RM-114 |
| 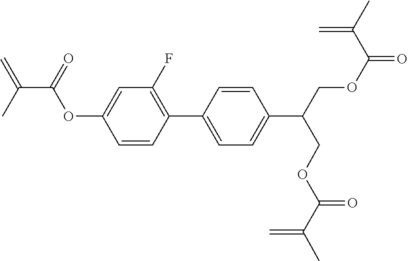 | RM-115 |
| 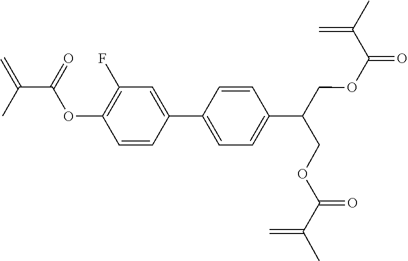 | RM-116 |
| 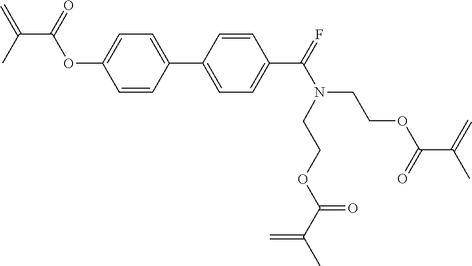 | RM-117 |
| 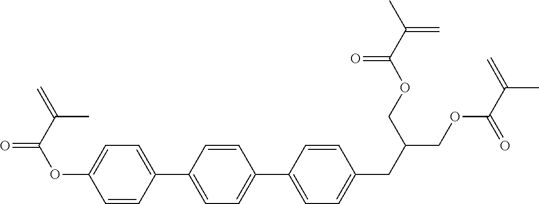 | RM-118 |
| 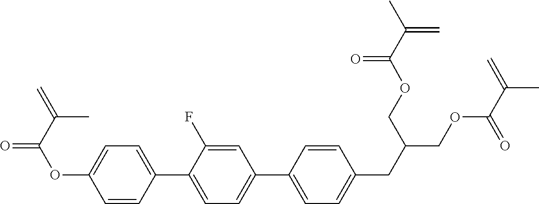 | RM-119 |
| 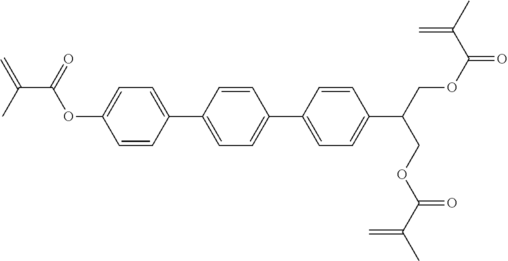 | RM-120 |
| 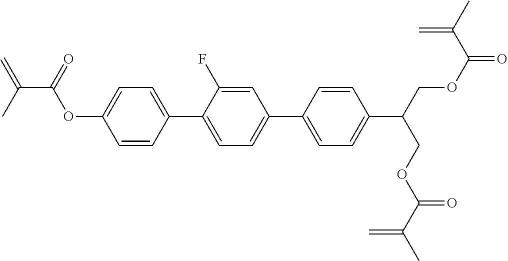 | RM-121 |
| 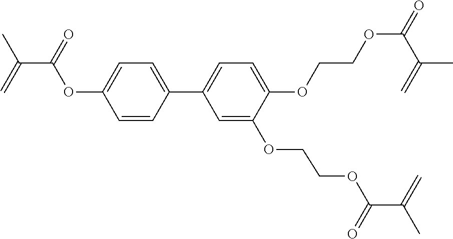 | RM-122 |
| 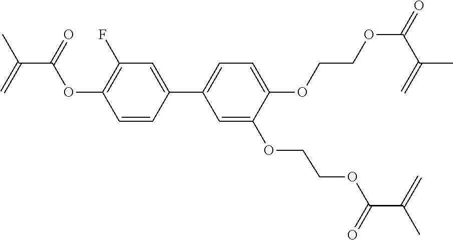 | RM-123 |
| 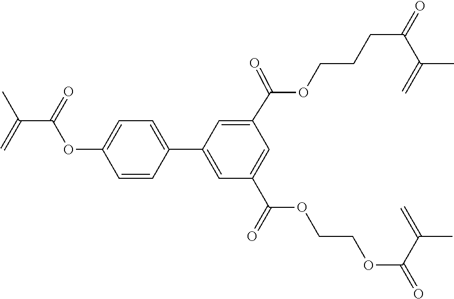 | RM-124 |
| 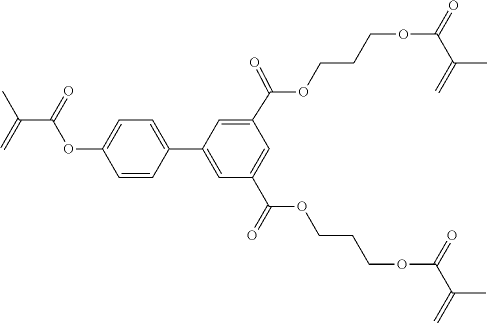 | RM-125 |
| 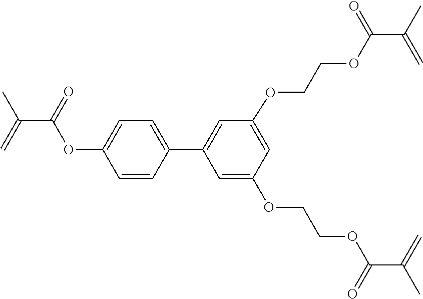 | RM-126 |
| 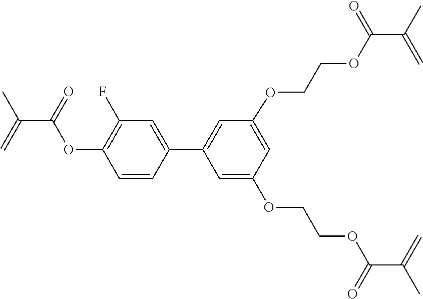 | RM-127 |
| 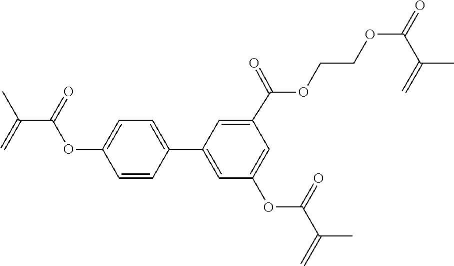 | RM-128 |
| 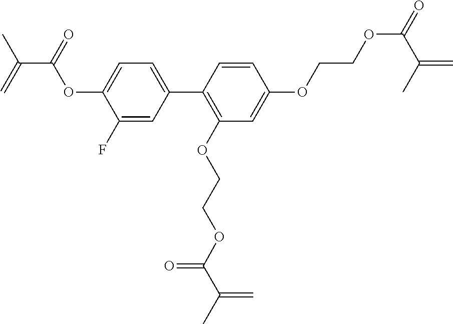 | RM-129 |
| 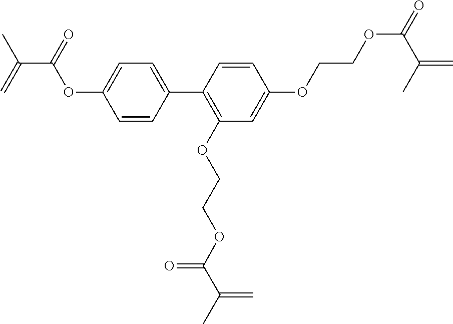 | RM-130 |
| 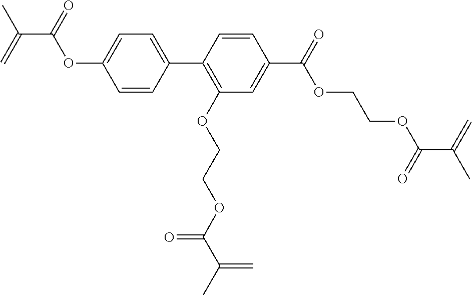 | RM-131 |
| 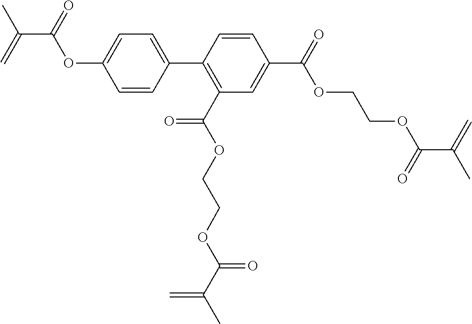 | RM-132 |
| 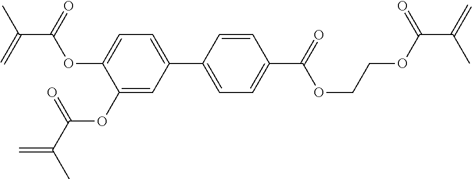 | RM-133 |
| 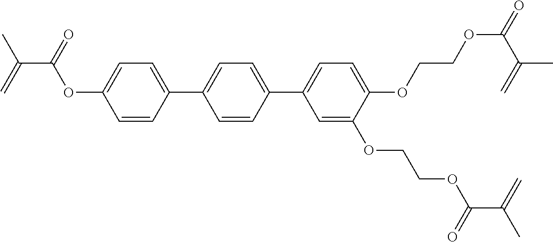 | RM-134 |
| 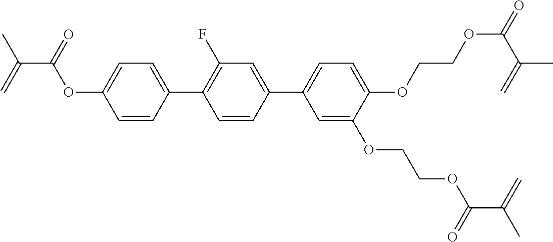 | RM-135 |
| 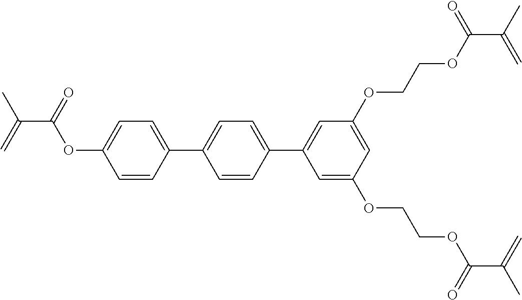 | RM-136 |
| 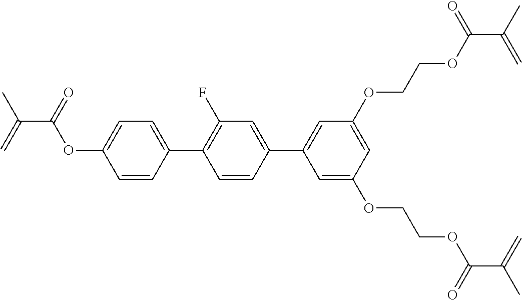 | RM-137 |
| 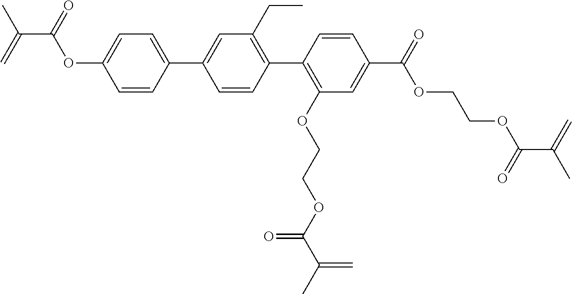 | RM-138 |

In a preferred embodiment of the present invention, the mesogenic media comprise one or more compounds selected from the group of the compounds from Table G.

### BRIEF DESCRIPTION OF THE DRAWINGS

FIG. 1 represents an image of two filled liquid-crystal test cells observed between crossed polarizers (initial alignment image). Black area indicates vertically aligned areas of the cells. The right side cell is filled according to Example 1 with a polyfluorinated additive, the left side cell contains a reference sample without the polyfluorinated additive.

FIG. 2 represents another initial alignment image in the manner of FIG. 1. The right side cell is filled according to Example 2 with a polyfluorinated additive, the left side cell contains a reference sample without the polyfluorinated additive.

### EXAMPLES

The following examples are intended to explain the invention without limiting it. Above and below, percentage data denote percent by weight. All temperatures are indicated in degrees Celsius. Furthermore, C=crystalline state, N=nematic phase, Sm=smectic phase and I=isotropic phase. The data between these symbols represent the transition temperatures. Δn denotes the optical anisotropy (589 nm, 20° C.), Δε denotes the dielectric anisotropy (1 kHz, 20° C.) and γ₁ denotes the rotational viscosity (in the unit mPa·s).

Physical, physicochemical or electro-optical parameters are determined by generally known methods, as described, inter alia, in the brochure “Merck Liquid Crystals—Licristal®—Physical Properties of Liquid Crystals—Description of the Measurement Methods”, 1998, Merck KGaA, Darmstadt. Above and below, Δn denotes the optical anisotropy (589 nm, 20° C.) and Δε denotes the dielectric anisotropy (1 kHz, 20° C.). The dielectric anisotropy Δε is determined at 20° C. and 1 kHz. The optical anisotropy Δn is determined at 20° C. and a wavelength of 589.3 nm.

The Δε and Δn values and the rotational viscosity (γ₁) of the compounds according to the invention are obtained by linear extrapolation from liquid-crystalline mixtures consisting of 5 to 10% of the respective compound according to the invention and 90-95% of the commercially available liquid-crystal mixture ZLI-4792 (for Δε>1, Δn, γ₁) or ZLI-2857 (for Δε<1) (mixtures, Merck KGaA, Darmstadt).

### SYNTHESIS EXAMPLES

### Synthesis Example 1

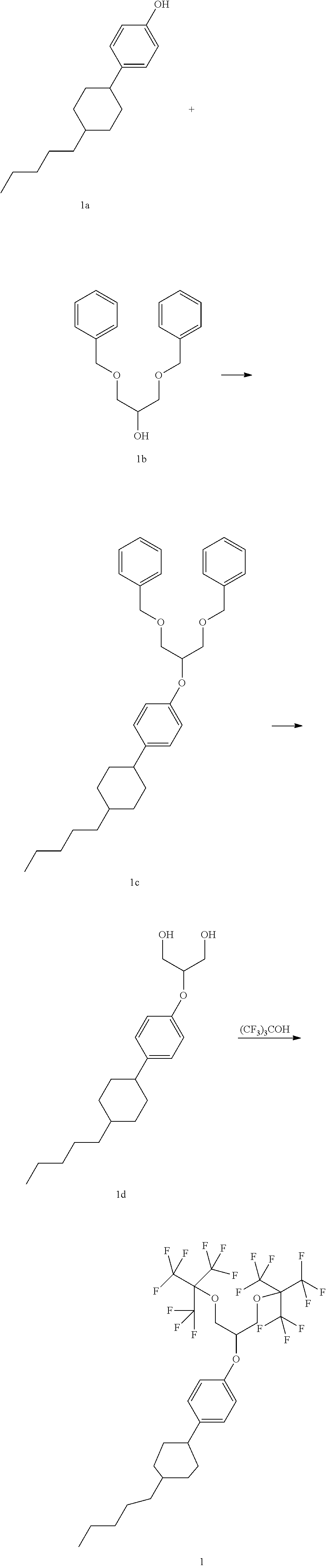

1c: Diisopropyl azodicarboxylate (4.70 ml, 23.9 mmol) is added dropwise to a solution of 1a (5.00 g, 20.3 mmol), 1b (5.53 g, 20.3 mmol) and triphenylphosphine (6.04 g, 23.0 mmol) in 50 ml of dry tetrahydrofuran (THF), during which the reaction temperature is held below 30° C. The reaction mixture is stirred overnight at room temperature. After the solvent has been separated off, the oily residue is purified by means of flash chromatography on silica gel with heptane/ethyl acetate, giving 1c as a colourless oil (5.8 g).

1d: Palladium (5%) on active carbon (2.5 g) is added to a solution of 1c (5.2 g, 10.4 mmol) in 50 ml of THF, and the mixture is hydrogenated under hydrogen for 19 h. The catalyst is filtered off. After the solvent has been removed, the residue is purified by means of flash chromatography on silica gel with dichloromethane/methanol, giving 1d as a white solid (2.6 g).

1: Diisopropyl azodicarboxylate (1.87 ml, 9.6 mmol) is added dropwise at 0° C. to a solution of 1d (1.03 g, 3.2 mmol) and triphenylphosphine (2.52 g, 9.6 mmol) in 25 ml of dry THF. After the mixture has been stirred for 30 min, perfluoro-tert-butanol (2.27 g, 9.6 mmol) is added, and the mixture is stirred overnight at 45° C. After the solvent has been separated off, the residue is purified by means of flash chromatography on silica gel with heptane/ethyl acetate, giving 1 as white crystals (1.0 g, m.p. 41° C.).

### Synthesis Example 2

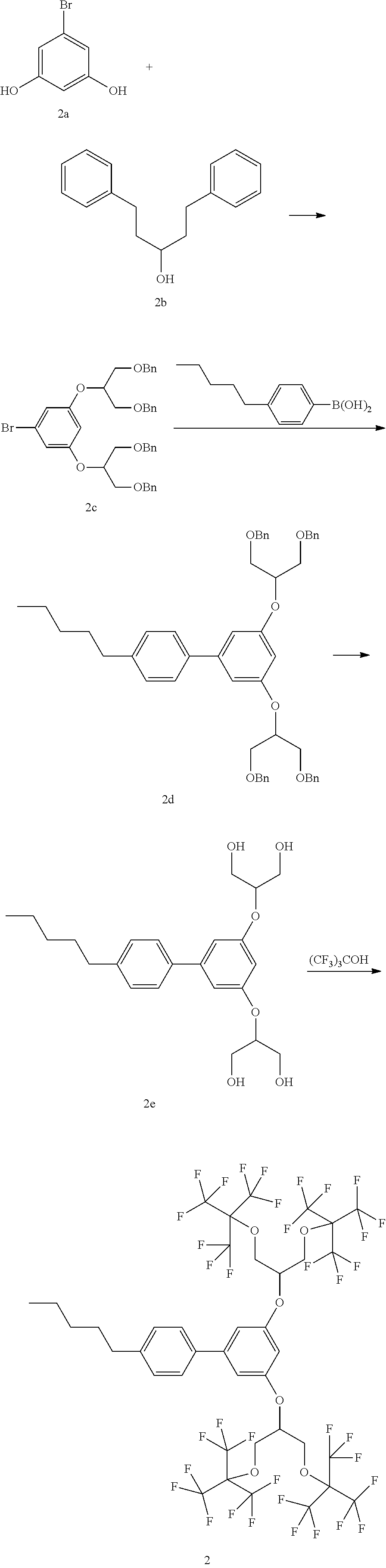

2c: Diisopropyl azodicarboxylate (3.70 ml, 18.8 mmol) is added dropwise to a solution of 2a (2.50 g, 13.5 mmol), 2b (7.60 g, 27.0 mmol) and triphenylphosphine (8.00 g, 30.0 mmol) in 60 ml of THF, during which the reaction temperature is kept below 30° C. The reaction mixture is stirred overnight at room temperature. After the solvent has been separated off, the oily residue is purified by means of flash chromatography on silica gel with heptane/ethyl acetate, giving 2d as a colourless oil (2.1 g).

2d: Sodium carbonate (0.9 g, 8.5 mmol) and 4 ml of distilled water are added to a solution of 2c (2.00 g, 2.9 mmol) and 4-pentylphenylboronic acid (0.60 g, 3.1 mmol) in 20 ml of 1,4-dioxane. After the mixture has been degassed using argon, [1,1′-bis(diphenylphosphine)ferrocene]palladium(II) dichloride (0.063 g, 0.09 mmol) is added. The reaction mixture is heated to reflux and stirred overnight. After conventional work-up, the collected organic phases are dried over sodium sulfate. After removal of the solvent, the residue is purified by means of flash chromatography on silica gel with heptane/ethyl acetate, giving 2d (2.0 g).

2e: Palladium (5%) on active carbon (0.5 g) is added to a solution of 2d (2.0 g, 2.6 mmol) in 20 ml of THF, and the mixture is hydrogenated under hydrogen for 16 h. The catalyst is filtered off. After removal of the solvent, the residue is purified by means of flash chromatography on silica gel with dichloromethane/methanol, giving 2e as a colourless oil (1.0 g).

2: Diisopropyl azodicarboxylate (2.43 ml, 12.4 mmol) is added dropwise at 0° C. to a solution of 2e (1.0 g, 2.5 mmol) and triphenylphosphine (2.72 ml, 12.4 mmol) in 50 ml of dry THF. After the mixture has been stirred for 30 min, perfluoro-tert-butanol (3.5 g, 14.8 mmol) is added, and the mixture is stirred overnight at 45° C. After the solvent has been separated off, the residue is purified by means of flash chromatography on silica gel with heptane/ethyl acetate. Recrystallisation of the crude product obtained from ethanol gives the product 2 as white crystals (1.0 g, melting point 46° C.).

The following are prepared analogously to Example 1 or 2:

### Synthesis Example 3

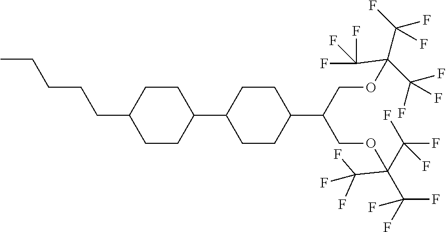 [SMILES: CCCCCC1CCC(C2CCC(C(COC(C(F)(F)F)(C(F)(F)F)C(F)(F)F)COC(C(F)(F)F)(C(F)(F)F)C(F)(F)F)CC2)CC1]

Melting point 65° C. (C 65 I).

### Synthesis Example 4

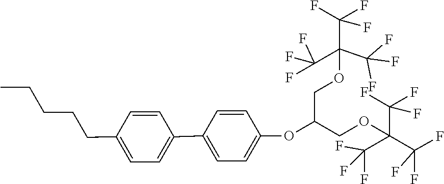 [SMILES: CCCCCc1ccc(-c2ccc(OC(COC(C(F)(F)F)(C(F)(F)F)C(F)(F)F)COC(C(F)(F)F)(C(F)(F)F)C(F)(F)F)cc2)cc1]

### Synthesis Example 5

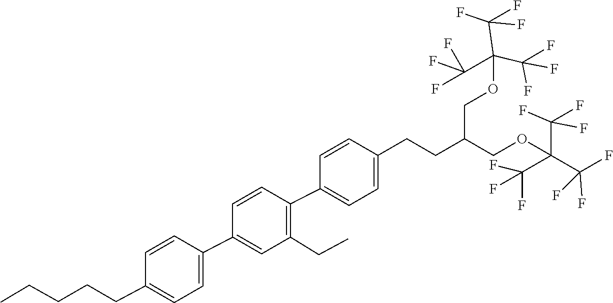 [SMILES: CCCCCc1ccc(-c2ccc(-c3ccc(CCC(COC(C(F)(F)F)(C(F)(F)F)C(F)(F)F)COC(C(F)(F)F)(C(F)(F)F)C(F)(F)F)cc3)c(CC)c2)cc1]

Melting point 40° C. (C 40 SmA (23) I)

### Synthesis Example 6

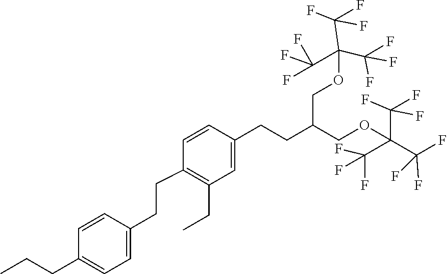 [SMILES: CCCc1ccc(CCc2ccc(CCC(COC(C(F)(F)F)(C(F)(F)F)C(F)(F)F)COC(C(F)(F)F)(C(F)(F)F)C(F)(F)F)cc2CC)cc1]

Melting point 36° C. (C 36 I)

### Synthesis Example 7

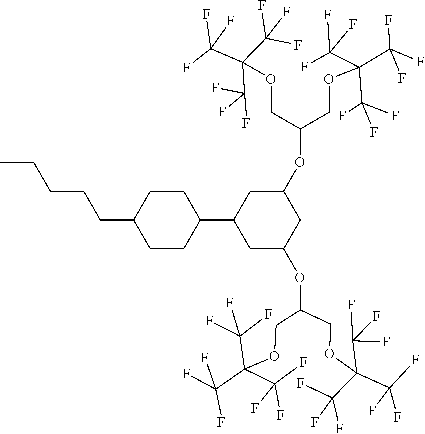

Mixture of the isomers prepared by catalytic hydrogenation of the product from Synthesis Example 2. Oil (main fraction: Tg−38° C. I)

### Synthesis Example 8

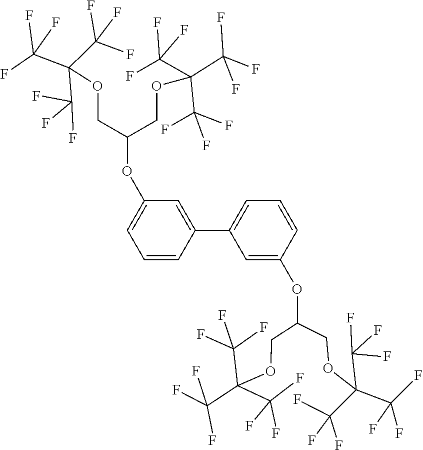

Oil (Tg−19° C. I)

### Synthesis Example 9

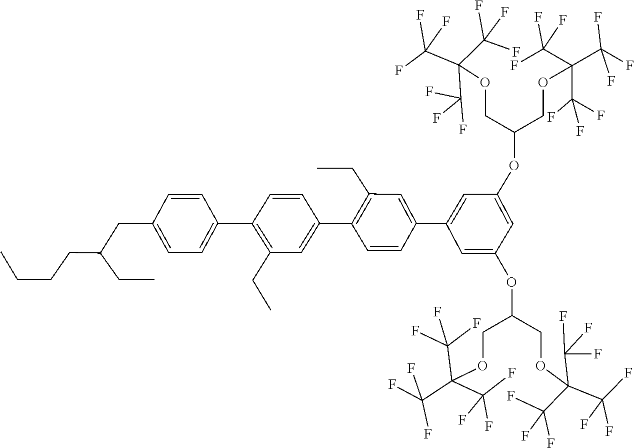

### Synthesis Example 10

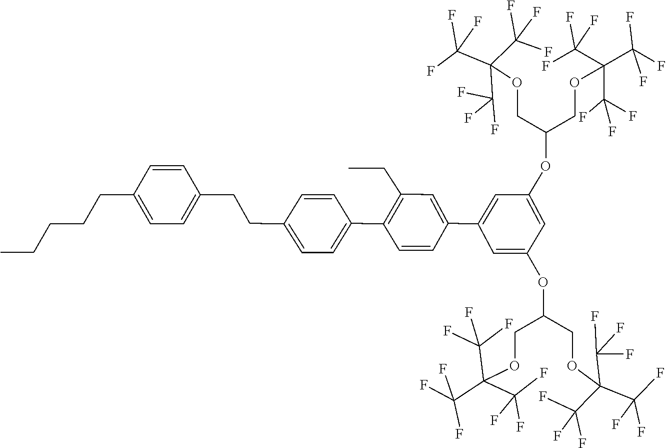

### Synthesis Example 11

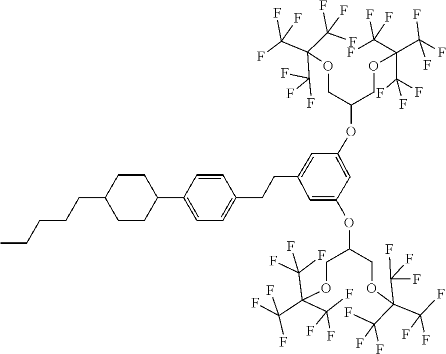

### Synthesis Example 12

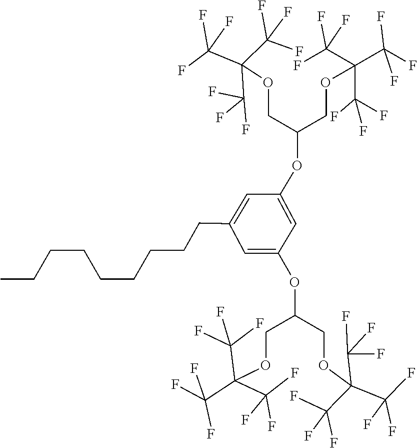

### Synthesis Example 13

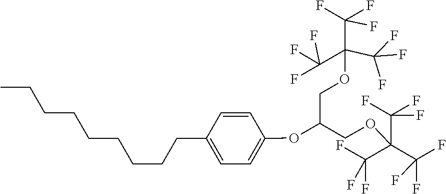 [SMILES: CCCCCCCCCc1ccc(OC(COC(C(F)(F)F)(C(F)(F)F)C(F)(F)F)COC(C(F)(F)F)(C(F)(F)F)C(F)(F)F)cc1]

### Synthesis Example 14

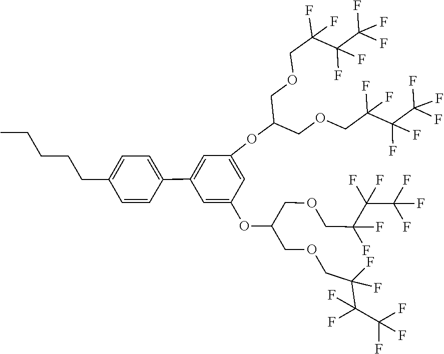 [SMILES: CCCCCc1ccc(-c2cc(OC(COCC(F)(F)C(F)(F)C(F)(F)F)COCC(F)(F)C(F)(F)C(F)(F)F)cc(OC(COCC(F)(F)C(F)(F)C(F)(F)F)COCC(F)(F)C(F)(F)C(F)(F)F)c2)cc1]

Oil.

¹H NMR (500 MHz, chloroform-d) δ 7.55-7.41 (m, 2H), 7.27 (dd, J=7.7, 5.9 Hz, 2H), 6.84 (d, J=2.2 Hz, 2H), 6.56 (t, J=2.2 Hz, 1H), 4.59 (p, J=4.8 Hz, 2H), 4.15-3.97 (m, 8H), 3.95-3.85 (m, 8H), 2.67 (dd, J=8.7, 6.9 Hz, 2H), 1.74-1.63 (m, 2H), 1.46-1.34 (m, 4H), 0.97-0.87 (m, 3H).

### Synthesis Example 15

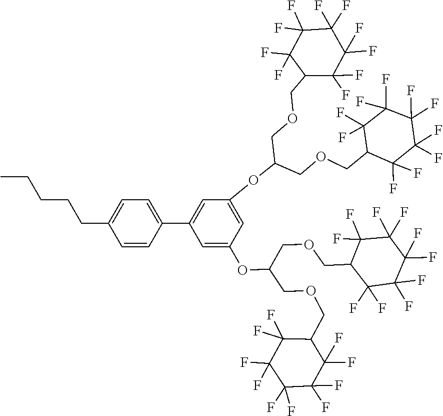 [SMILES: CCCCCc1ccc(-c2cc(OC(COCC3C(F)(F)C(F)(F)C(F)(F)C(F)(F)C3(F)F)COCC3C(F)(F)C(F)(F)C(F)(F)C(F)(F)C3(F)F)cc(OC(COCC3C(F)(F)C(F)(F)C(F)(F)C(F)(F)C3(F)F)COCC3C(F)(F)C(F)(F)C(F)(F)C(F)(F)C3(F)F)c2)cc1]

### Synthesis Example 16

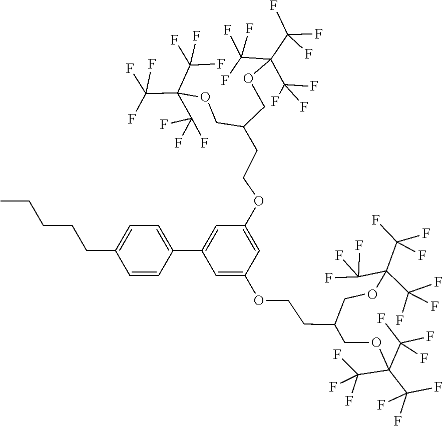 [SMILES: CCCCCc1ccc(-c2cc(OCCC(COC(C(F)(F)F)(C(F)(F)F)C(F)(F)F)COC(C(F)(F)F)(C(F)(F)F)C(F)(F)F)cc(OCCC(COC(C(F)(F)F)(C(F)(F)F)C(F)(F)F)COC(C(F)(F)F)(C(F)(F)F)C(F)(F)F)c2)cc1]

### Synthesis Example 17

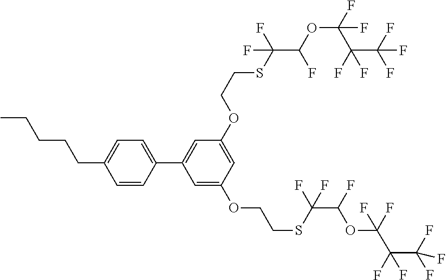 [SMILES: CCCCCc1ccc(-c2cc(OCCSC(F)(F)C(F)OC(F)(F)C(F)(F)C(F)(F)F)cc(OCCSC(F)(F)C(F)OC(F)(F)C(F)(F)C(F)(F)F)c2)cc1]

Oil.

¹H NMR (chloroform-d) δ 7.55-7.45 (m, 2H), 7.27 (dd, J=7.6, 5.8 Hz, 2H), 6.77 (d, J=2.2 Hz, 2H), 6.45 (t, J=2.2 Hz, 1H), 6.04 (dt, J=54.4, 3.8 Hz, 2H), 4.27 (t, J=6.5 Hz, 4H), 3.32 (t, J=6.4 Hz, 4H), 2.71-2.61 (m, 2H), 1.73-1.62 (m, 2H), 1.46-1.20 (m, 4H), 0.93 (td, J=6.7, 4.3 Hz, 3H).

### Synthesis Example 18

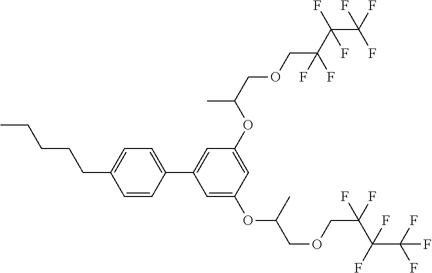 [SMILES: CCCCCc1ccc(-c2cc(OC(C)COCC(F)(F)C(F)(F)C(F)(F)F)cc(OC(C)COCC(F)(F)C(F)(F)C(F)(F)F)c2)cc1]

Oil.

¹H NMR (chloroform-d) δ 7.43-7.34 (m, 2H), 7.17 (dd, J=9.0, 7.1 Hz, 2H), 6.67 (d, J=2.1 Hz, 2H), 6.39 (t, J=2.2 Hz, 1H), 4.51 (pd, J=6.2, 4.5 Hz, 2H), 3.98 (t, J=13.7 Hz, 4H), 3.70 (qd, J=10.5, 5.0 Hz, 4H), 2.63-2.52 (m, 2H), 1.65-1.50 (m, 2H), 1.28 (app t, J=6.8 Hz, 10H), 0.88-0.79 (m, 3H).

### Synthesis Example 19

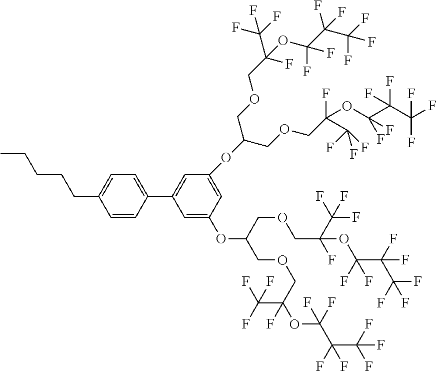 [SMILES: CCCCCc1ccc(-c2cc(OC(COCC(F)(OC(F)(F)C(F)(F)C(F)(F)F)C(F)(F)F)COCC(F)(OC(F)(F)C(F)(F)C(F)(F)F)C(F)(F)F)cc(OC(COCC(F)(OC(F)(F)C(F)(F)C(F)(F)F)C(F)(F)F)COCC(F)(OC(F)(F)C(F)(F)C(F)(F)F)C(F)(F)F)c2)cc1]

Oil.

¹H NMR (chloroform-d) δ 7.51-7.40 (m, 2H), 7.27 (d, J=8.0 Hz, 2H), 6.80 (d, J=2.1 Hz, 2H), 6.48 (t, J=2.3 Hz, 1H), 4.56 (p, J=4.8 Hz, 2H), 4.18-4.04 (m, 8H), 3.93-3.81 (m, 8H), 2.73-2.62 (m, 2H), 1.72-1.61 (m, 2H), 1.44-1.33 (m, 4H), 0.97-0.86 (m, 3H).

### Synthesis Example 20

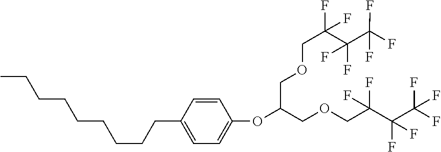 [SMILES: CCCCCCCCCc1ccc(OC(COCC(F)(F)C(F)(F)C(F)(F)F)COCC(F)(F)C(F)(F)C(F)(F)F)cc1]

Oil

¹H NMR (chloroform-d) δ 7.02 (d, J=8.3 Hz, 2H), 6.82-6.74 (m, 2H), 4.41 (p, J=4.9 Hz, 1H), 3.94 (h, J=12.9 Hz, 4H), 3.83-3.73 (m, 4H), 2.52-2.43 (m, 2H), 1.57-1.45 (m, 2H), 1.31-1.13 (m, 12H), 0.81 (t, J=6.8 Hz, 3H).

### Synthesis Example 21

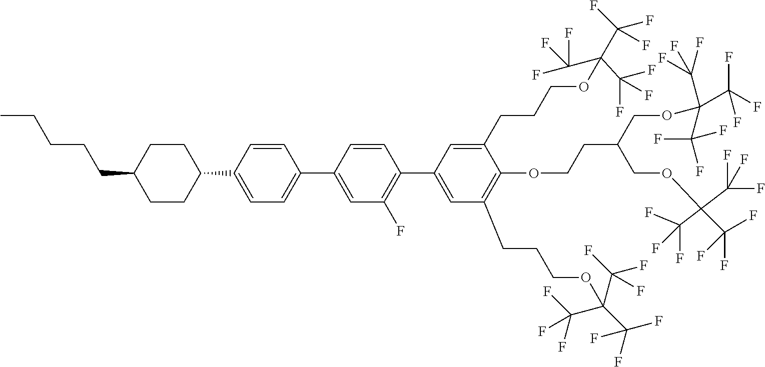 [SMILES: CCCCC[C@H]1CC[C@H](c2ccc(-c3ccc(-c4cc(CCCOC(C(F)(F)F)(C(F)(F)F)C(F)(F)F)c(OCCC(COC(C(F)(F)F)(C(F)(F)F)C(F)(F)F)COC(C(F)(F)F)(C(F)(F)F)C(F)(F)F)c(CCCOC(C(F)(F)F)(C(F)(F)F)C(F)(F)F)c4)c(F)c3)cc2)CC1]

Melting point 92° C. (C 92 I).

### Mixture Examples: Liquid-Crystal Media with Additives

The following additives are added to the liquid-crystal media:

| Additive No. | Structure of the additive |
|---|---|
| 1 | 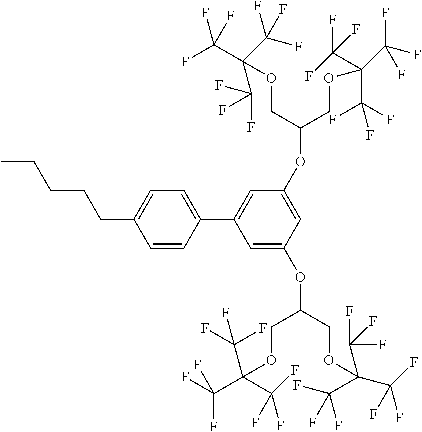 [SMILES: CCCCCc1ccc(-c2cc(OC(COC(C(F)(F)F)(C(F)(F)F)C(F)(F)F)COC(C(F)(F)F)(C(F)(F)F)C(F)(F)F)cc(OC(COC(C(F)(F)F)(C(F)(F)F)C(F)(F)F)COC(C(F)(F)F)(C(F)(F)F)C(F)(F)F)c2)cc1] |
| 2 | 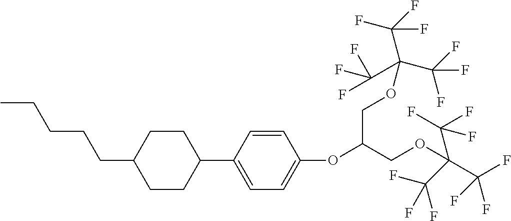 [SMILES: CCCCCC1CCC(c2ccc(OC(COC(C(F)(F)F)(C(F)(F)F)C(F)(F)F)COC(C(F)(F)F)(C(F)(F)F)C(F)(F)F)cc2)CC1] |
| 3 | 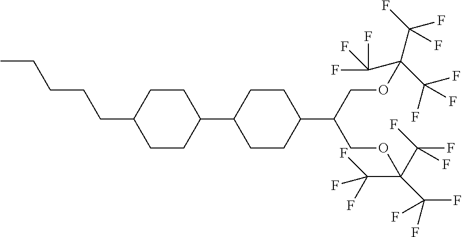 [SMILES: CCCCCC1CCC(C2CCC(C(COC(C(F)(F)F)(C(F)(F)F)C(F)(F)F)COC(C(F)(F)F)(C(F)(F)F)C(F)(F)F)CC2)CC1] |
| 4 | 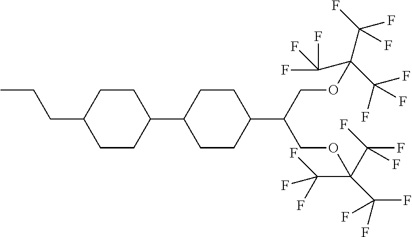 [SMILES: CCCC1CCC(C2CCC(C(COC(C(F)(F)F)(C(F)(F)F)C(F)(F)F)COC(C(F)(F)F)(C(F)(F)F)C(F)(F)F)CC2)CC1] |
| 5 | 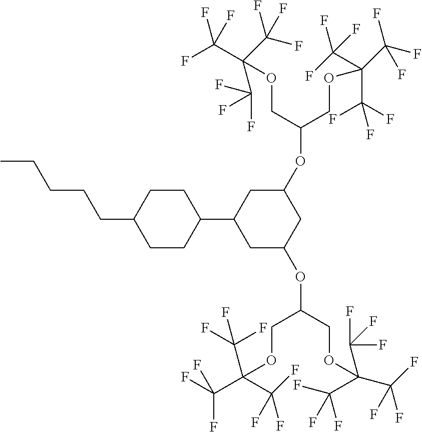 [SMILES: CCCCCC1CCC(C2CC(OC(COC(C(F)(F)F)(C(F)(F)F)C(F)(F)F)COC(C(F)(F)F)(C(F)(F)F)C(F)(F)F)CC(OC(COC(C(F)(F)F)(C(F)(F)F)C(F)(F)F)COC(C(F)(F)F)(C(F)(F)F)C(F)(F)F)C2)CC1] |

### Mixture Examples

The following alignment additives are used:

(prepared as described in EP 2918658 or analogously)

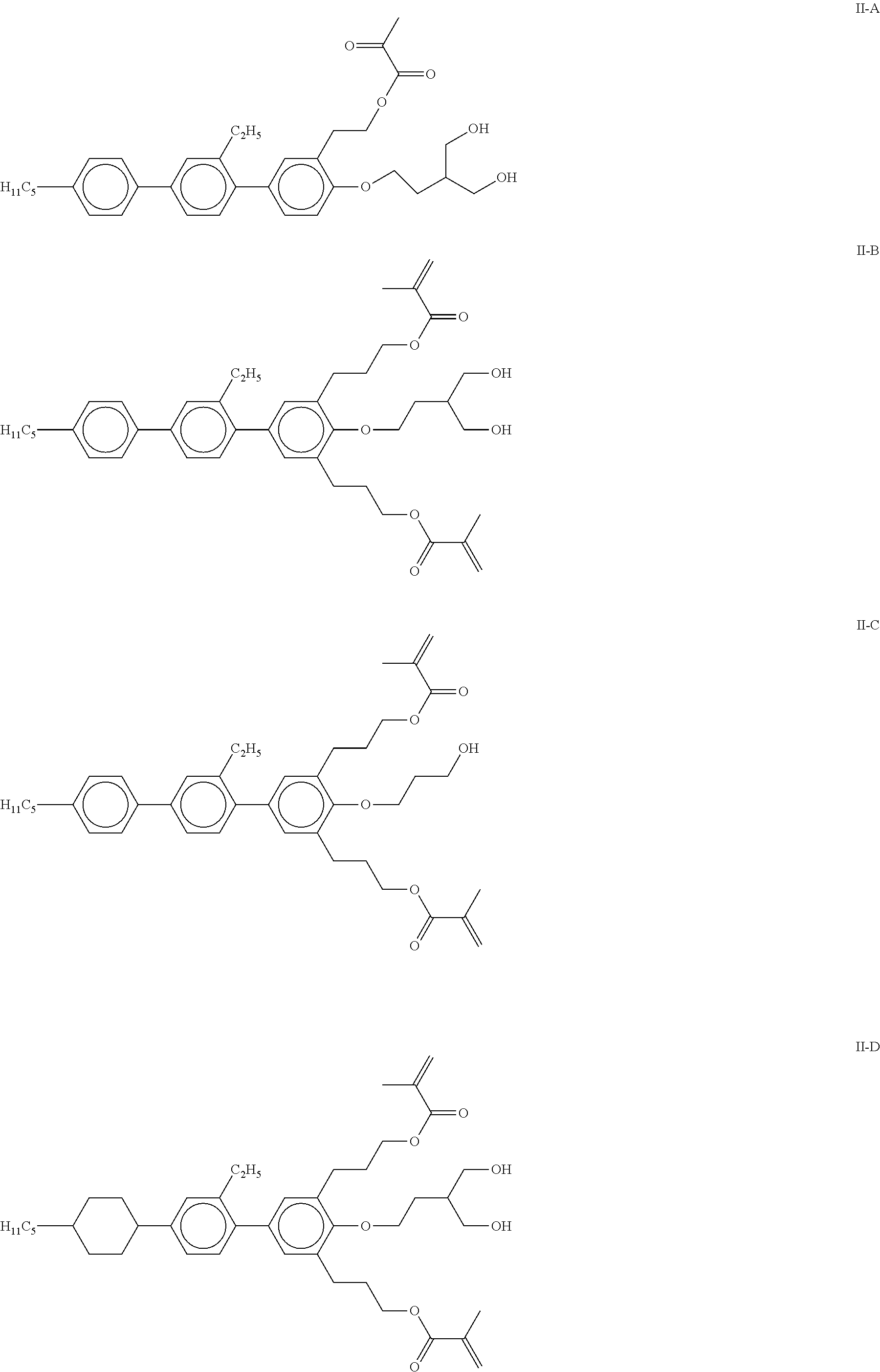

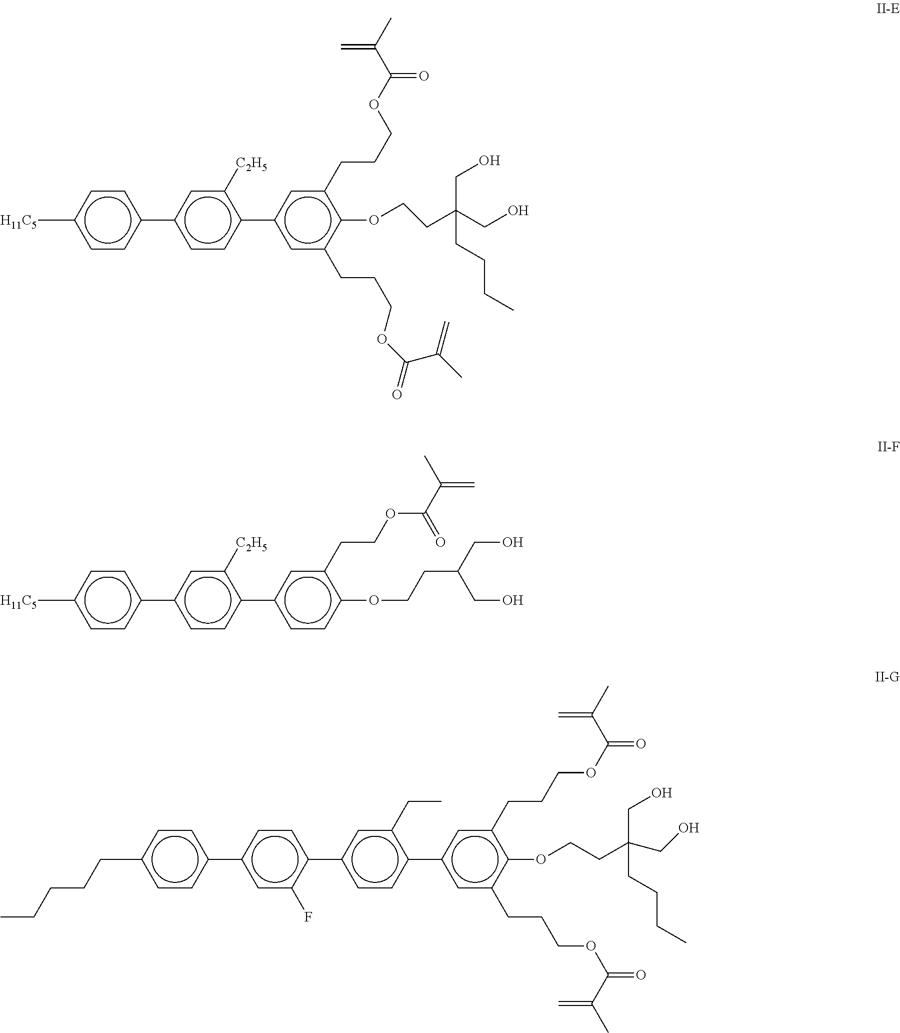

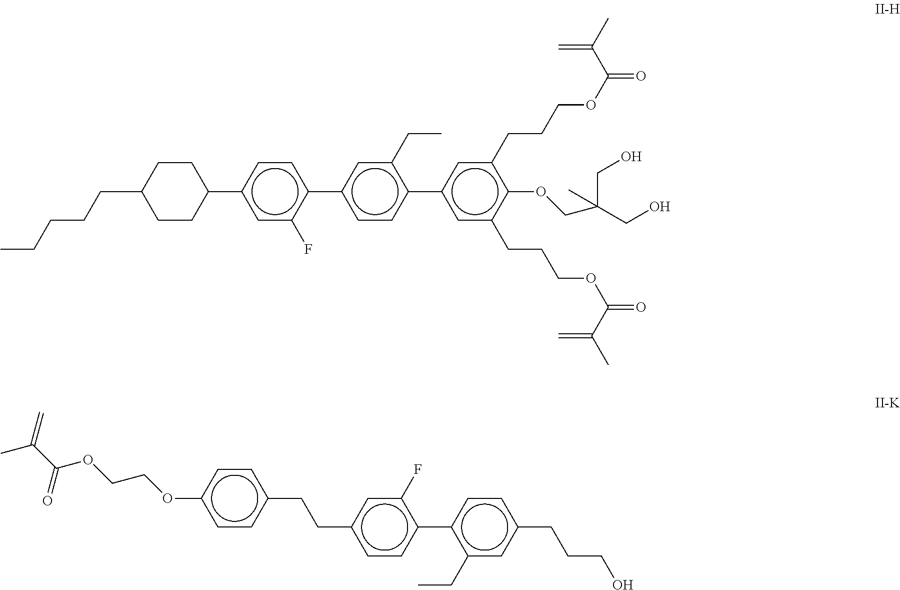

The following polymerizable compound is used:

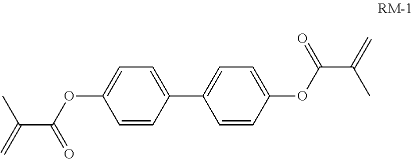 [SMILES: C=C(C)C(=O)Oc1ccc(-c2ccc(OC(=O)C(=C)C)cc2)cc1]

The base mixtures (hosts) used are the following liquid-crystal media H1 to H10 (figures in % by weight).

H1: Nematic host mixture (Δε<0)

| | | | |
|---|---|---|---|
| CPP-3-2 | 10.5% | Clearing point [° C.]: | 74.5 |
| CC-3-4 | 9.0% | Δn (589 nm, 20° C.): | 0.109 |
| CC-3-5 | 9.0% | Δε (1 kHz, 20° C.): | −3.4 |
| CCP-3-1 | 8.0% | ε_{∥} (1 kHz, 20° C.): | 3.7 |
| CCY-3-O2 | 9.5% | ε_{⊥} (1 kHz, 20° C.): | 7 |
| CCY-4-O2 | 5.5% | K₁ (20° C.) [pN]: | 14 |
| CPY-3-O2 | 5.5% | K₃ (20° C.) [pN]: | 15.7 |
| CY-3-O2 | 15% | γ₁ (20° C.) [mPa · s]: | 128 |
| CY-5-O2 | 5.0% | | |
| CP-3-O1 | 7.0% | | |
| PY-3-O2 | 16% | | |

H2: Nematic host mixture (Δε<0)

| | | | |
|---|---|---|---|
| CPP-3-2 | 6% | Clearing point [° C.]: | 74.8 |
| CC-3-V1 | 6% | Δn (589 nm, 20° C.): | 0.107 |
| CC-3-4 | 9% | Δε (1 kHz, 20° C.): | −3.3 |
| CC-3-5 | 7% | ε_{∥} (1 kHz, 20° C.): | 3.6 |
| CCP-3-1 | 8% | ε_{⊥} (1 kHz, 20° C.): | 6.9 |
| CCP-3-3 | 3% | K₁ (20° C.) [pN]: | 14.2 |
| CCY-3-1 | 2% | K₃ (20° C.) [pN]: | 16.5 |
| CCY-3-O2 | 10.5% | γ₁ (20° C.) [mPa · s]: | 118 |
| CCY-4-O2 | 5% | | |
| CPY-3-O2 | 3.5% | | |
| CY-3-O2 | 14% | | |
| CP-3-O1 | 5.5% | | |
| PY-1-O4 | 6.5% | | |
| PY-3-O2 | 14% | | |
| CPP-3-2 | 6% | | |
| CC-3-V1 | 6% | | |

H3: Nematic host mixture (Δε<0)

| | | | |
|---|---|---|---|
| B-2O-O5 | 4% | Clearing point [° C.]: | 74.2 |
| CPP-3-2 | 8% | Δn (589 nm, 20° C.): | 0.109 |
| CC-3-V1 | 9% | Δε (1 kHz, 20° C.): | −3.1 |
| CC-3-O1 | 2% | ε_{∥} (1 kHz, 20° C.): | 3.6 |
| CC-3-4 | 8% | ε_{⊥} (1 kHz, 20° C.): | 6.7 |
| CC-3-5 | 7% | K₁ (20° C.) [pN]: | 14.5 |
| CCP-3-1 | 8% | K₃ (20° C.) [pN]: | 16.5 |
| CCP-V2-1 | 5% | γ₁ (20° C.) [mPa · s]: | 108 |
| CCY-3-O2 | 10.5% | | |
| CLY-3-O2 | 1% | | |
| CPY-3-O2 | 2.5% | | |
| CY-3-O2 | 11.5% | | |
| CP-3-O1 | 5.5% | | |
| PY-3-O2 | 18% | | |

H4: Nematic host mixture (Δε<0)

| | | | |
|---|---|---|---|
| B(S)-2O-O5 | 4% | Clearing point [° C.]: | 74.7 |
| CPP-3-2 | 5% | Δn (589 nm, 20° C.): | 0.102 |
| CC-3-V1 | 6% | Δε (1 kHz, 20° C.): | −3.2 |
| CC-3-4 | 9% | ε_{∥} (1 kHz, 20° C.): | 3.6 |
| CC-3-5 | 9% | ε_{⊥} (1 kHz, 20° C.): | 6.7 |
| CCP-3-1 | 8% | K₁ (20° C.) [pN]: | 13.5 |
| CCY-3-O1 | 6.5% | K₃ (20° C.) [pN]: | 16.5 |
| CCY-3-O2 | 9% | γ₁ (20° C.) [mPa · s]: | 109 |
| CLY-3-O2 | 1% | | |
| CPY-3-O2 | 4.5% | | |
| CY-3-O2 | 13% | | |
| CP-3-O1 | 15% | | |
| PY-1-O2 | 8% | | |
| PY-2-O2 | 2% | | |

H5: Nematic host mixture (Δε<0)

| | | | |
|---|---|---|---|
| CC-2-3 | 14% | Clearing point [° C.]: | 110.5 |
| CC-3-4 | 12% | Δn (589 nm, 20° C.): | 0.102 |
| CCP-3-1 | 3% | Δε (1 kHz, 20° C.): | −3.1 |
| CCY-3-1 | 8% | ε_{∥} (1 kHz, 20° C.): | 3.2 |
| CCY-3-O2 | 12% | ε_{⊥} (1 kHz, 20° C.): | 6.2 |
| CCY-3-O3 | 12% | K1 (20° C.) [pN]: | 18.1 |
| CCY-4-O2 | 10% | K3 (20° C.) [pN]: | 19.3 |
| CPY-2-O2 | 3% | γ1 (20° C.) [mPa · s]: | 190 |
| CPY-3-O2 | 10% | | |
| CP-3-O1 | 10% | | |
| PYP-2-3 | 6% | | |

H6: Nematic host mixture (Δε<0)

| | |
|---|---|
| Host H1 | 98.85% |
| RM-1 | 0.35%% |

H7: Nematic host mixture (Δε<0)

| | |
|---|---|
| Host H2 | 98.95% |
| RM-1 | 0.25% |

H8: Nematic host mixture (Δε<0)

| | |
|---|---|
| Host H3 | 98.85% |
| RM-1 | 0.35% |

H9: Nematic host mixture (Δε<0)

| | |
|---|---|
| Host H4 | 98.85% |
| RM-1 | 0.35% |

H10: Nematic host mixture (Δε<0)

| | |
|---|---|
| Host H5 | 99% |
| RM-1 | 0.2% |

Various %-proportions by weight of the example additives and one or two alignment additives are added to the LC host mixtures, which are then investigated with respect to various parameters (alignment, drop mura, reliability).

For example, to these media H1 to H10 the spreading additives no. 1 to 5 are added in percentages of about 0.025 (±0.01) % by weight and one or more of the alignment additives II-A to II-K in an amount of about 0.5 (±0.3) % by weight.

### Test Sample Results

TABLE 1
Composition of Mixture Examples (additives in % by weight,
the LC host mixture makes up the remaining percentage)

| | Mixture Example 1 | Mixture Example 2 |
|---|---|---|
| Polymerizable | 0.35% of RM-1 | 0.35% of RM-1 |
| compound | | |
| Self-alignment | 0.6% of II-B | 0.3% of II-B |
| additive(s) for | 0.2% of II-C | |
| vertical alignment | | |
| Polyfluorinated | 0.025% of 1 | 0.025% of 1 |
| spreading additive | | |
| LC host mixture | H1 (adding to 100%) | H1 (adding to 100%) |

The procedure for test cell manufacture is,

1) adding polyfluorinated additive into SA-VA LC mixture,
2) dispensing LC mixture and sealant onto substrate,
3) cell assembly,
4) sealant curing,
5) PS-VA 1^{st} and 2^{nd} UV process,
6) Initial alignment confirmation and other evaluations.

To confirm the initial alignment, a DSLR camera (Nikon) for gathering high quality cell image is used.

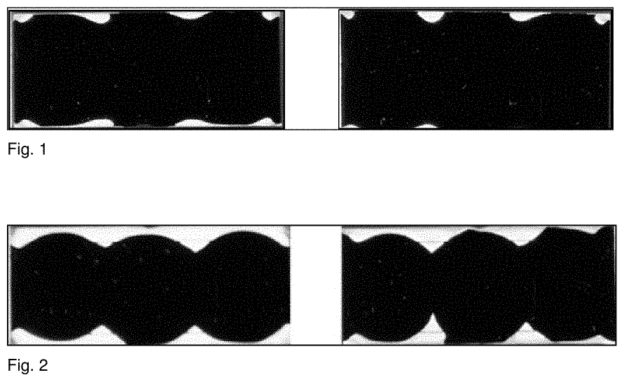

The results of Example 1 are provided in FIG. 1. The initial alignment of the test cell is visibly improved in the edge regions.

The results of Example 2 are provided in FIG. 2. The initial alignment of the test cell is visibly improved in the edge regions.

In summary, the additives of formula I improved the initial alignment.

### ODF Mura Evaluation

The ODF test enables evaluation of the additives under actual process conditions and shows whether ODF mura actually occurring can also be improved. The ODF test is composed of a number of part-processes.

### a) Production of the Test Displays

The substrates are cleaned before further processing, with the aim of removing all adhering particles. This is carried out by machine in a multistep process in which rinsing is carried out stepwise with a soap solution (distilled water and 0.5% of detergent) and pure distilled water. After completion of the rinsing operation, the substrates are dried at 120° C. for 30 min.
This is followed by application of the adhesive (Sekisui) at the edge of the substrate and the dropwise application (ODF) of the LC medium to the substrate. The lower substrate with the adhesive and the LC medium is brought together with an upper substrate provided with ITO and photospacer (3.3 μm) by means of vacuum (5 Pa, 30 s). This is followed by adhesion of the test display by means of UV light, with only the adhesive edge being exposed, and a heating step (in accordance with the adhesive manufacturer's instructions).
This is then followed by the PS-VA process for achieving the pre-tilt. To this end, a direct voltage of about 10 V is applied to the cell with UV illumination. The UV illumination initiates photopolymerization of the RM. The desired tilt is established via the RM concentration, the illumination intensity, the illumination duration or the strength of the applied field. When the desired pre-tilt has been achieved, the process is terminated. This is followed by a second UV step without voltage in order to remove the remaining RM.

### b) Evaluation of the Drop Mura

The ODF mura can be described by visual inspection and, alternatively, by measuring of tilt angles in different regions.

### Tilt Measurements:

The pre-tilt set is measured by means of a Mueller matrix polarimeter (Axometrics Axostep) with spatial resolution in the region in which the drop was located before spreading out during the vacuum process, and in the region where no LC medium was located before the process. The difference is a criterion which describes the ODF level. The smaller the difference, the smaller the ODF mura occurring.
The test display is operated at various grey shades (various driver voltages) against backlighting. With the aid of a DSLR camera, images of the display are recorded and analysed by means of software. The grey shades are determined with the aid of electro-optical curves (transmission against voltage) using an LCD-5200 (Otsuka, JP).

### c) Results

TABLE 2
ODF mura results

| | Mixture Example 1 | Mixture Example 2 |
|---|---|---|
| ODF drop mura | none | none |

The medium according to the invention showed no visible drop mura.

### Mixture Examples 3 to 6

TABLE 2
Composition of Mixture Examples (additives in % by weight,
the LC host mixture makes up the remaining percentage)

| | Mixture Example 3 | Mixture Example 4 |
|---|---|---|
| Polymerizable | 0.30% of RM-1 | 0.30% of RM-1 |
| compound | | |
| Self-alignment | 0.6% of II-B | 0.3% of II-B |
| additive(s) for | 0.2% of II-C | |
| vertical alignment | | |
| Polyfluorinated | 0.025% of 1 | 0.025% of 1 |
| spreading additive | | |
| LC host mixture | H1 (adding to 100%) | H1 (adding to 100%) |

TABLE 3
Composition of Mixture Examples (additives in % by weight,
the LC host mixture makes up the remaining percentage)

| | Mixture Example 5 | Mixture Example 6 |
|---|---|---|
| Polymerizable | 0.30% of RM-1 | 0.30% of RM-1 |
| compound | | |
| Self-alignment | 0.6% of II-B | 0.3% of II-B |
| additive(s) for | 0.2% of II-C | |
| vertical alignment | | |
| Polyfluorinated | 0.025% of 1 | 0.025% of 1 |
| spreading additive | | |
| LC host mixture | H2 (adding to 100%) | H2 (adding to 100%) |

1. Liquid-crystalline medium comprising a liquid-crystalline component, characterised in that the liquid-crystalline medium comprises one or more self-alignment additives for vertical alignment and one or more additives of the following formula I: 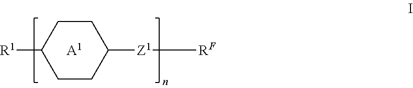
in which
R¹ denotes a straight-chain or branched alkyl group having 1 to 20 C atoms, or H, where, in addition, one or more CH₂ groups in this radical may each be replaced, independently of one another, by —C≡C—, —CH═CH—, 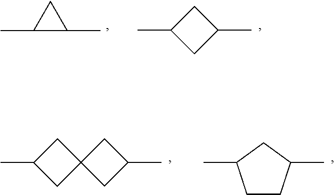
—O—, —S—, —CO—O— or —O—CO— in such a way that O or S atoms are not linked directly to one another,
R^{F} denotes a polyfluorinated alkyl group with 4 to 25 carbon atoms having at least 9 fluorine atoms,
Z¹ independently denotes a single bond, —CH₂CH₂—, —COO—, trans-—CH═CH—, trans-—CF═CF—, —CH₂O—, —CF₂O— or —C≡C—, in which asymmetrical bridges may be oriented to both sides, and where two O atoms of adjacent groups are not connected directly,
Sp¹ denotes a single bond or —(CH₂)ₘ—, in which m=1, 2, 3 or 4 and in which one or two CH₂ groups may be replaced by —O— or —S— in such a way that O/S atoms are not linked directly to one another,
Sp² denotes a linear or branched, trivalent spacer,
A¹, independently of one another, denotes a radical selected from the following groups:
a) the group consisting of trans-1,4-cyclohexylene and 1,4-cyclohexenylene, in which, in addition, one or more non-adjacent CH₂ groups may be replaced by —O— and/or —S— and in which, in addition, one or more H atoms may be replaced by F or Cl,
b) 1,4-phenylene, in which, in addition, one or two CH groups may be replaced by N and in which, in addition, one or more H atoms may be replaced by a group L or R², and
c) the group consisting of 2,6-naphthylene, dibenzofuran-3,7-diyl, dibenzothiophene-3,7-diyl, 9H-fluorene-2,7-diyl, phenanthrene-2,7-diyl, 6H-benzo[c]chromene-3,8-diyl, anthracene-2,6-diyl, tetrahydropyran-2,5-diyl, 1,3-dioxane-2,5-diyl, tetrahydrofuran-2,5-diyl, cyclobutane-1,3-diyl, piperidine-1,4-diyl, thiophene-2,5-diyl and selenophene-2,5-diyl, each of which may also be mono- or polysubstituted by a group L,
A² denotes a 6- or 5-membered saturated, unsaturated or aromatic, carbocyclic or heterocyclic ring system, which is in each case optionally additionally substituted by one or two groups L,
L independently denotes F, Cl, —CN, an alkyl group having 1 to 5 C atoms, an alkoxy group having 1-5 C atoms or an alkenyl group having 2 to 5 C atoms,
and
n denotes 0, 1, 2, 3 or 4.

2. Liquid-crystal medium according to claim 1, characterised in that in formula I the group
R^{F} is a group selected from the formulae
R², 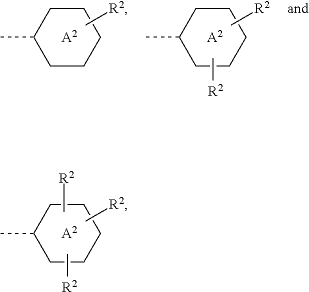
R² in each case independently denotes 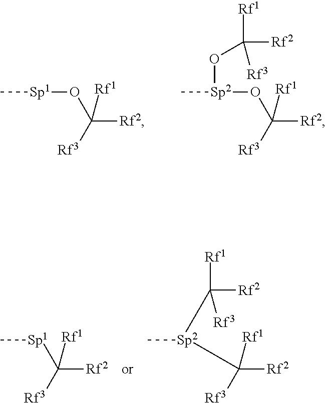
Rf¹, Rf³ independently denote H, F, —CF₃, —CF₂CF₃, —CF₂CF₂CF₃ or CF(CF₃)₂,
Rf² independently denotes an unbranched, branched or cyclic fluoroalkyl group having 3 to 15 fluorine atoms and 1 to 10 C atoms, in which one or more non-adjacent CH₂ groups may be replaced by —O— and/or —S—,

3. Liquid-crystal medium according to claim 1, characterised in that the one or more self-alignment additives for vertical alignment comprise one or more unpolymerizable, polymerizable or polymerized compounds of formula II:
MES-R^{a} II
in which
MES is a calamitic mesogenic group comprising two or more rings, which are connected directly or indirectly to each other or which are condensed to each other, and which is substituted optionally by one or more polymerizable groups, which are connected to MES directly or via a spacer, and
R^{a} is a polar anchor group, residing in a terminal position of the calamitic mesogenic group MES which comprises at least one carbon atom and at least one group selected from —OH, —SH,
—COOH, —CHO or primary or secondary amine function and which optionally comprises one or two polymerizable groups P.

4. The liquid-crystalline medium according to claim 1, wherein said self-alignment additive for vertical alignment is of formula IIa
R¹-[A²-Z²]ₘ-A¹-R^{a} IIa
in which
A¹, A² each, independently of one another, denote an aromatic, heteroaromatic, alicyclic or heterocyclic group, which may also contain fused rings, and which may also be mono- or polysubstituted by a group L or -Sp-P,
L in each case, independently of one another, denotes H, F, Cl, Br, I, —CN, —NO₂, —NCO, —NCS, —OCN, —SCN, —C(═O)N(R⁰)₂, —C(═O)R⁰, optionally substituted silyl, optionally substituted aryl or cycloalkyl having 3 to 20 C atoms, or straight-chain or branched alkyl, alkoxy, alkylcarbonyl, alkoxycarbonyl, alkylcarbonyloxy or alkoxycarbonyloxy having up to 25 C atoms, in which, in addition, one or more H atoms may each be replaced by F or Cl,
P denotes a polymerizable group,
Sp denotes a spacer group or a single bond,
Z² in each case, independently of one another, denotes a single bond, —O—, —S—, —CO—, —CO—O—, —OCO—, —O—CO—O—, —OCH₂—, —CH₂O—, —SCH₂—, —CH₂S—, —CF₂O—, —OCF₂—, —CF₂S—, —SCF₂—, —(CH₂)ₙ₁—, —CF₂CH₂—, —CH₂CF₂—, —(CF₂)ₙ₁—, —CH═CH—, —CF═CF—, —C≡C—, —CH═CH—COO—, —OCO—CH═CH—, —(CR⁰R⁰⁰)ₙ₁—, —CH(-Sp-P)—, —CH₂CH(-Sp-P)—, or —CH(-Sp-P)CH(-Sp-P)—,
n1 denotes 1, 2, 3 or 4,
m denotes 0, 1, 2, 3, 4, 5 or 6,
R⁰ in each case, independently of one another, denotes alkyl having 1 to 12 C atoms,
R⁰⁰ in each case, independently of one another, denotes H or alkyl having 1 to 12 C atoms,
R¹ independently of one another, denotes H, halogen, straight-chain, branched or cyclic alkyl having 1 to 25 C atoms, in which, in addition, one or more non-adjacent CH₂ groups may each be replaced by —O—, —S—, —CO—, —CO—O—, —O—CO—, or —O—CO—O— in such a way that O and/or S atoms are not linked directly to one another and in which, in addition, one or more H atoms may each be replaced by F or Cl,
or a group -Sp-P,
and
R^{a} denotes a polar anchor group residing in a terminal position of the calamitic mesogenic group MES which comprises at least one carbon atom and at least one group selected from —OH, —SH, —COOH, —CHO or primary or secondary amine function and which optionally comprises one or two polymerizable groups P.

5. The liquid-crystalline medium according to claim 1, wherein said self-alignment additive has an anchor group R^{a} which is selected from the formulae 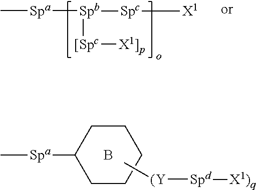
wherein
p denotes 1 or 2,
q denotes 2 or 3,
B denotes a substituted or unsubstituted ring system or condensed ring system,
Y independently of one another, denotes —O—, —S—, —C(O)—, —C(O)O—, —OC(O)—, —NR¹¹— or a single bond,
o denotes 0 or 1,
X¹ independently of one another, denotes H, alkyl, fluoroalkyl, OH, NH₂, NHR¹¹, NR¹¹₂, OR¹¹, C(O)OH, or —CHO,
where at least one group X¹ denotes a radical selected from —OH, —NH₂, NHR¹¹, C(O)OH and —CHO,
R¹¹ denotes alkyl having 1 to 12 C atoms,
Sp^{a}, Sp^{c}, Sp^{d} each, independently of one another, denote a spacer group or a single bond, and
Sp^{b} denotes a tri- or tetravalent group.

6. The liquid-crystalline medium according to claim 1, wherein said self-alignment additive for vertical alignment is selected from the compounds of formulae II-A to II-D, 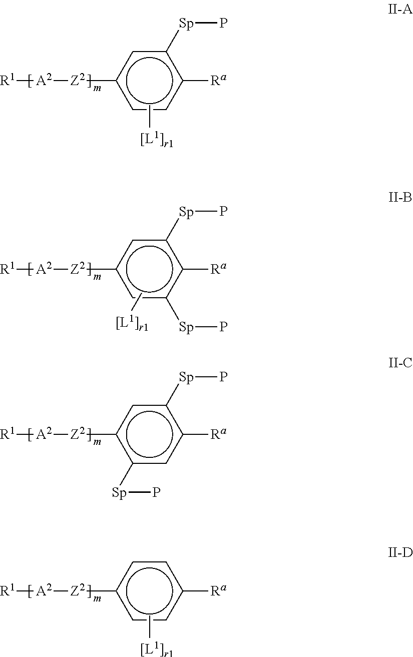
in which
R¹ denotes H, halogen, straight-chain, branched or cyclic alkyl having 1 to 25 C atoms, in which, in addition, one or more non-adjacent CH₂ groups may each be replaced by —O—, —S—, —CO—, —CO—O—, —O—CO—, or —O—CO—O— in such a way that O and/or S atoms are not linked directly to one another and in which, in addition, one or more H atoms may each be replaced by F or Cl, or a group -Sp-P,
R^{a} denotes a polar anchor group-residing in a terminal position of the calamitic mesogenic group MES which comprises at least one carbon atom and at least one group selected from —OH, —SH, —COOH, —CHO or primary or secondary amine function and which optionally comprises one or two polymerizable groups P,
A² each, independently of one another, denote an aromatic, heteroaromatic, alicyclic or heterocyclic group, which may also contain fused rings, and which may also be mono- or polysubstituted by a group L or -Sp-P,
Z² in each case, independently of one another, denotes a single bond, —O—, —S—, —CO—, —CO—O—, —OCO—, —O—CO—O—, —OCH₂—, —CH₂O—, —SCH₂—, —CH₂S—, —CF₂O—, —OCF₂—, —CF₂S—, —SCF₂—, —(CH₂)ₙ₁—, —CF₂CH₂—, —CH₂CF₂—, —(CF₂)ₙ₁—, —CH═CH—, —CF═CF—, —C≡C—, —CH═CH—COO—, —OCO—CH═CH—, —(CR⁰R⁰⁰)ₙ₁—, —CH(-Sp-P)—, —CH₂CH(-Sp-P)—, or —CH(-Sp-P)CH(-Sp-P)—,
P denotes a polymerizable group,
Sp denotes a spacer group or a single bond,
L¹ is F or alkyl,
m 0, 1, 2 or 3,
and
r1 is 0, 1, 2, 3, or 4.

7. Liquid-crystal medium according to claim 1, characterised in that it comprises one or more compounds of the formula III 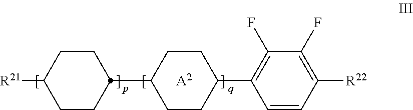
in which
R²¹ denotes an unsubstituted alkyl radical having 1 to 7 C atoms, an unsubstituted alkoxy radical having 1 to 6 C atoms or an unsubstituted alkenyl radical having 2 to 7 C atoms,
R²² denotes an unsubstituted alkyl radical having 1 to 7 C atoms or an unsubstituted alkoxy radical having 1 to 6 C atoms, 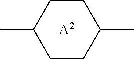
denotes 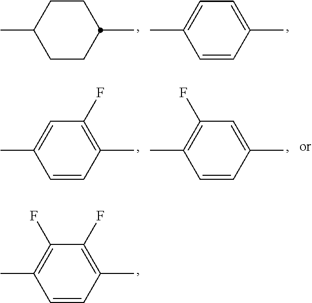
p and q each, independently of one another, denote 0, 1 or 2 and
(p+q) denotes 1, 2 or 3.

8. Liquid-crystalline medium according to claim 1, characterised in that it additionally comprises one or more compounds of the formula V, 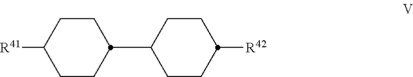
in which
R⁴¹ denotes an unsubstituted alkyl radical having 1 to 7 C atoms or an unsubstituted alkenyl radical having 2 to 7 C atoms, and
R⁴² denotes an unsubstituted alkyl radical having 1 to 7 C atoms, an unsubstituted alkoxy radical having 1 to 6 C atoms, or an unsubstituted alkenyl radical having 2 to 7 C atoms.

9. Liquid-crystalline medium according to claim 1, characterised in that the total concentration of the compounds of the formula I in the entire medium is 0.001% by weight or more to 2% by weight or less.

10. Liquid-crystalline medium according to claim 1, characterised in that in formula I
R^{F} denotes a group selected from the formulae 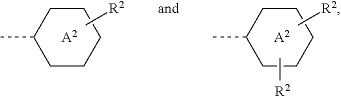
and
n denotes 0, 1 or 2.

11. Liquid-crystalline medium according to claim 1, wherein the one or more compounds of formula I is selected from the group of the compounds of the formulae IA to IF:

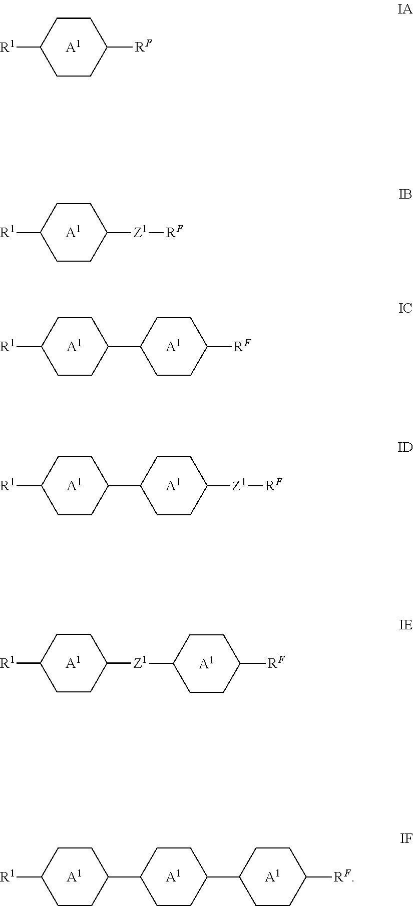

12. Liquid-crystalline medium according to claim 1, characterised in that it comprises a proportion of polymerizable or polymerized compounds.

13. An electro-optical display comprising a liquid-crystal medium according to claim 1.

14. Process for the preparation of a liquid-crystalline medium according to claim 1, characterised in that one or more compounds each of the formula I and of formula II are mixed with one or more liquid-crystalline compounds, and further compounds and additives are optionally added.

15. Electro-optical display containing a liquid-crystal medium according to claim 12.

16. Process for the filling of an electro-optical display with a liquid-crystal medium, characterised in that the medium comprises one or more polyfluorinated additives of the formula I and a self-alignment additive for vertical alignment according to claim 1.
